(19) United States
(12) Patent Application Publication
(10) Pub. No.: US 2005/0187387 A1
(43) Pub. Date: Aug. 25, 2005

(54) Antagonists of melanin concentrating hormone effects on the melanin concentrating hormone receptor

(76) Inventors: John K. Lynch, Kenosha, WI (US); Christine A. Collins, Skokie, IL (US); Jennifer C. Freeman, Grayslake, IL (US); Ju Gao, Gurnee, IL (US); Rajesh R. Iyengar, Lindenhurst, IL (US); Andrew Stephen Judd, Grayslake, IL (US); Philip R. Kym, Grayslake, IL (US); Mathew M. Mulhern, Hainesville, IL (US); Hing L. Sham, Vernon Hills, IL (US); Andrew J. Souers, Evanston, IL (US); Gang Zhao, Northbrook, IL (US)

Correspondence Address: ROBERT DEBERARDINE;ABBOTT LABORATORIES, 100 ABBOTT PARK ROAD, DEPT. 377/AP6A, ABBOTT PARK, IL, 60064-6008, US

(21) Appl. No.: 10/787,694

(22) Filed: Feb. 25, 2004

(51) Int. Cl. B32B 27/02

(52) U.S. Cl. 544/63

(57) ABSTRACT

The present invention is directed to compounds of formula (I), 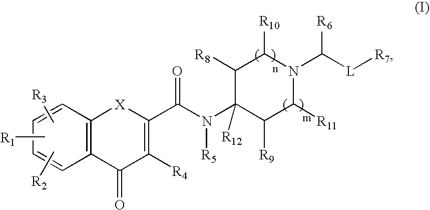 which antagonize of the effects of melanin-concentrating hormone (MCH) through the melanin concentrating hormone receptor which is useful for the prevention or treatment of eating disorders, weight gain, obesity, abnormalities in reproduction and sexual behavior, thyroid hormone secretion, diuresis and water/electrolyte homeostasis, sensory processing, memory, sleeping, arousal, anxiety, depression, seizures, neurodegeneration and psychiatric disorders.

### TECHNICAL FIELD

The present invention relates to the antagonism of the effects of melanin-concentrating hormone (MCH) through the melanin concentrating hormone receptor which is useful for the prevention or treatment of eating disorders, weight gain, obesity, abnormalities in reproduction and sexual behavior, thyroid hormone secretion, diuresis and water/electrolyte homeostasis, sensory processing, memory, sleeping, arousal, anxiety, depression, seizures, neurodegeneration and psychiatric disorders.

### BACKGROUND OF THE INVENTION

Obesity is a major cause and contributor to health problems such as type II diabetes, coronary heart disease, increased incidence of certain forms of cancer, and respiratory complications. It is a disease that is increasing at an alarming rate due to increased availability of high-fat diets, genetic susceptibility, and a more sedentary way of life in modern society. Obesity may be defined as weight gain resulting from a mismatch of energy intake and energy expenditure. Food intake and energy metabolism are regulated, in part, by the interaction of neuropeptides and their receptors. Recently, the role that the hormone leptin plays in controlling appetite has been elucidated.

Leptin is a peptide hormone produced by fat cells, regulating both food intake and and metabolism by acting on leptin receptors in the hypothalamus. Increased fat stores leads to increased secretion of leptin, resulting in a signal to the hypothalamus to decrease food intake, whereas decreases in adiposity result in lower leptin levels and a stimulation of food intake. Melanin-concentrating hormone (MCH) has been identified as an orexigenic peptide that counterbalances the activity of leptin.

MCH is a cyclic 19 amino acid neuropeptide expressed in the zona incerta and lateral hypothalamus in response to both energy restriction and leptin deficiency. MCH is known to stimulate feeding when injected into the lateral ventricle of rats and the mRNA for MCH is upregulated in the hypothalamus of genetically obese mice (ob/ob) and in fasted control animals. Mice lacking MCH are hypophagic and lean with increased metabolic rate, whereas animals over-expressing MCH gain excess weight on both standard and high fat diets. MCH is thought to have effects on other nervous system functions as well (Nahon J L., The melanin-concentrating hormone: from the peptide to the gene. Crit Rev Neurobiol 8:221-262, 1994). An orphan G-protein coupled receptor (GPCR) was recently identified as a receptor for MCH.

Although there exists pharmacologic therapies used to treat obesity, none of the current therapies achieve the U.S. Food and Drug Administration criteria for benefit measured by a 5% difference in mean weight loss, as weight loss efficacy is diminished by reduction of patient adherence to pharmacological therapy due to side effects of the drugs. Some of the side effects associated with current therapies include increased heart rate and blood pressure, and uncontrolled excretion of fat in stools. Thus, there exists a medical need for agents capable of preventing or treating eating disorders, weight gain and obesity, that at the same time, have improved efficacy and safety.

Therefore, current investigation of novel MCH antagonists which may lead to an orally active new and better treatment of eating disorders, weight gain and obesity would be of great importance to current society.

### SUMMARY OF THE INVENTION

The present invention is directed to compounds of formula (I), 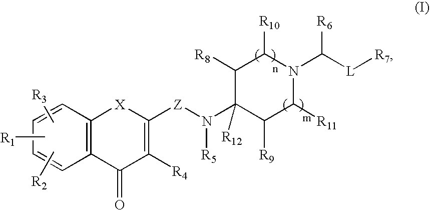
or a therapeutically suitable salt or prodrug thereof, wherein
L is a member selected from the group consisting of a bond, alkyl, alkenyl, alkynyl, —CH₂—O—, —S(O)₂—NH—, —C(O)—NH—, —NH—C(O)—, —NH—S(O)₂—, —C(O)—, —S(O)— and —S(O)₂—;
X is a member selected from the group consisting of —O— and —N(R₁₃)—;
Z is a member selected from the group consisting of —CH₂—, —C(N—R_{c})—, —C(O)— and —C(S)—;
m is 1 or 2;
n is 0, 1, or 2;
R₁, R₂ and R₃ are each independently a member selected from the group consisting of hydrogen, halogen, alkenyl, alkoxy, alkyl, alkyl-C(O)—, alkyl-C(O)—NH—, alkyl-NH—C(O)—, alkyl-S(O)₂—NH—, alkyl-NH—S(O)₂—, alkyl-S(O)₂—, alkyl-S(O)—, alkyl-S—, alkynyl, cyano, haloalkyl, haloalkoxy, haloalkyl-S—, RₐR_{b}N—, and R₁ and R₂ taken together with any intervening atoms form a heterocycle;
R₄ is a member selected from the group consisting of hydrogen, alkyl, alkyl-C(O)—NH—, alkyl-S(O)₂—NH—, aryl and halogen;
R₅ is a member selected from the group consisting of hydrogen and alkyl;
R₆ is a member selected from the group consisting of hydrogen, alkyl, aryl, cycloalkyl and heterocycle;
R₇ is a member selected from the group consisting of aryl, arylalkyl, heterocycle and heterocyclealkyl;
R₈ is a member selected from the group consisting of hydrogen, alkyl and alkoxy;
R₉ is a member selected from the group consisting of hydrogen and alkyl;
R₁₀ and R₁₁ are each independently selected from the group consisting of hydrogen, alkyl, alkoxylalkyl, and R₁₀ and R₁₁ taken together with any intervening atoms form a 5, 6, or 7-membered ring;
R₁₂ is a member selected from the group consisting of hydrogen and alkyl;
R₁₃ is a member selected from the group consisting of hydrogen, alkyl, aryl, cycloalkyl and heterocycle;
Rₐ and R_{b} are each individually a member selected from the group consisting of hydrogen, alkoxycarbonyl, alkyl, alkylcarbonyl, alkyl-NHC(O)—, alkyl-S(O)₂— and Rₐ and R_{b} taken together with the nitrogen to which they are attacked form a heterocycle; and
R_{c} is a member selected from the group consisting of hydrogen and alkyl;
provided that at least one of R₁, R₂ or R₃ are not hydrogen.

Another embodiment of the present invention encompasses the use of the compounds of the present invention for the treatment of obesity comprising administration of said compounds to a patient in need of such treatment.

A further embodiment of the present invention encompasses the use of the compounds of the present invention for the treatment of disorders that are mediated by MCH through the MCH receptor such as abnormalities in reproduction and sexual behavior, thyroid hormone secretion, diuresis and water/electrolyte homeostasis, sensory processing, memory, sleeping and arousal, anxiety and depression, seizure and in treatment of neurodegeneration or psychiatric disorders comprising administering a therapeutically effective amount of a compound of formula (I) to a patient in need thereof.

According to another embodiment, the present invention is directed to a pharmaceutical composition comprising a therapeutically effective amount of a compound of formula (I) in combination with a pharmaceutically suitable carrier.

### DETAILED DESCRIPTION OF THE INVENTION

The principal embodiment of the present invention is directed toward compounds of formula (I) and their use in the treatment of disorders mediated by MCH comprising administration of a therapeutically effective amount of a compound of formula (I) to one in need of such treatment.

Therefore, the principal embodiment of the present invention is directed to compounds of formula (I), 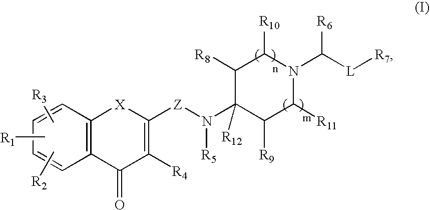
or a therapeutically suitable salt or prodrug thereof, wherein L is a member selected from the group consisting of a bond, alkyl, alkenyl, alkynyl, —CH₂—O—, —S(O)₂—NH—, —C(O)—NH—, —NH—C(O)—, —NH—S(O)₂—, —C(O)—, —S(O)— and —S(O)₂—; X is a member selected from the group consisting of —O—and —N(R₁₃)—; Z is a member selected from the group consisting of —CH₂—, —C(N—R_{c})—, —C(O)— and —C(S)—; m is 1 or 2; n is 0, 1, or 2; R₁, R₂ and R₃ are each independently a member selected from the group consisting of hydrogen, halogen, alkenyl, alkoxy, alkyl, alkyl-C(O)—, alkyl-C(O)—NH—, alkyl-NH—C(O)—, alkyl-S(O)₂—NH—, alkyl-NH—S(O)₂—, alkyl-S(O)₂—, alkyl-S(O)—, alkyl-S—, alkynyl, cyano, haloalkyl, haloalkoxy, haloalkyl-S—, RₐR_{b}N—, and R₁ and R₂ taken together with any intervening atoms form a heterocycle; R₄ is a member selected from the group consisting of hydrogen, alkyl, alkyl-C(O)—NH—, alkyl-S(O)₂—NH—, aryl and halogen; R₅ is a member selected from the group consisting of hydrogen and alkyl; R₆ is a member selected from the group consisting of hydrogen, alkyl, aryl, cycloalkyl and heterocycle; R₇ is a member selected from the group consisting of aryl, arylalkyl, heterocycle and heterocyclealkyl; R₈ is a member selected from the group consisting of hydrogen, alkyl and alkoxy; R₉ is a member selected from the group consisting of hydrogen and alkyl; R₁₀ and R₁₁ each are independently selected from the group consisting of hydrogen, alkyl, and alkoxylalkyl, or R₁₀ and R₁₁ taken together with any intervening atoms form a 5, 6, or 7-membered ring; R₁₂ is a member selected from the group consisting of hydrogen and alkyl; R₁₃ is a member selected from the group consisting of hydrogen, alkyl, aryl, cycloalkyl and heterocycle; Rₐ and R_{b} are each individually a member selected from the group consisting of hydrogen, alkoxycarbonyl, alkyl, alkylcarbonyl, alkylNHC(O)—, alkylS(O)₂— and Rₐ and R_{b} taken together with the nitrogen to which they are attacked form a heterocycle; and R_{c} is a member selected from the group consisting of hydrogen and alkyl; with the provision that at least one of R₁, R₂ or R₃ must be other then hydrogen.

Another embodiment of the present invention is directed toward a compound of formula (II), wherein 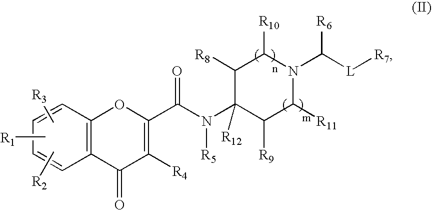
or a therapeutically suitable salt or prodrug thereof, wherein L is a member selected from the group consisting of a bond, alkyl, alkenyl, alkynyl, —CH₂—O—, —S(O)₂—NH—, —C(O)—NH—, —NH—C(O)—, —NH—S(O)₂—, —C(O)—, —S(O)— and —S(O)₂—; m is 1 or 2; n is 0, 1, or 2; R₁, R₂ and R₃ are each independently a member selected from the group consisting of hydrogen, halogen, alkenyl, alkoxy, alkyl, alkyl-C(O)—, alkyl-C(O)—NH—, alkyl-NH—C(O)—, alkyl-S(O)₂—NH—, alkyl-NH—S(O)₂—, alkyl-S(O)₂—, alkyl-S(O)—, alkyl-S—, alkynyl, cyano, haloalkyl, haloalkoxy, haloalkyl-S—, RₐR_{b}N—, and R₁ and R₂ taken together with any intervening atoms form a heterocycle; R₄ is a member selected from the group consisting of hydrogen, alkyl, alkyl-C(O)—NH—, alkyl-S(O)₂—NH—, aryl and halogen; R₅ is a member selected from the group consisting of hydrogen and alkyl; R₆ is a member selected from the group consisting of hydrogen, alkyl, aryl, cycloalkyl and heterocycle; R₇ is a member selected from the group consisting of aryl, arylalkyl, heterocycle and heterocyclealkyl; R₈ is a member selected from the group consisting of hydrogen, alkyl and alkoxy; R₉ is a member selected from the group consisting of hydrogen and alkyl; R₁₀ and R₁₁ are each independently selected from the group consisting of hydrogen, alkyl, and alkoxylalkyl, or R₁₀ and R₁₁ taken together with any intervening atoms form a 5, 6, or 7-membered ring; R₁₂ is a member selected from the group consisting of hydrogen and alkyl; and Rₐ and R_{b} are each individually a member selected from the group consisting of hydrogen, alkoxycarbonyl, alkyl, alkylcarbonyl, alkylNHC(O)—, alkylS(O)₂— and Rₐ and R_{b} taken together with the nitrogen to which they are attacked form a heterocycle; provided that at least one of R₁, R₂ or R₃ are not hydrogen.

Another embodiment of the present invention is directed toward a compound of formula (IIa), 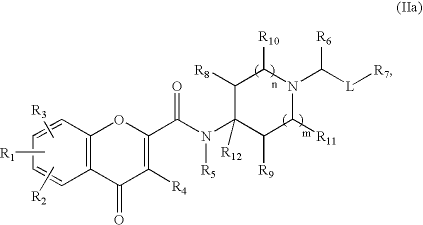
or a therapeutically suitable salt or prodrug thereof, wherein L is a member selected from the group consisting of a bond, alkyl, alkenyl, alkynyl, —CH₂—O—, —S(O)₂—NH—, —C(O)—NH—, —NH—C(O)—, —NH—S(O)₂—, —C(O)—, —S(O)— and —S(O)₂—; m is 1; n is 1; R₁, R₂ and R₃ are each independently a member selected from the group consisting of hydrogen, halogen, alkoxy, alkyl, alkyl-C(O)—, alkyl-C(O)—NH—, alkyl-NH—C(O)—, alkyl-S(O)₂—NH—, alkyl-NH—S(O)₂—, alkyl-S(O)₂—, alkyl-S(O)—, alkyl-S—, alkynyl, cyano, haloalkyl, haloalkoxy, haloalkyl-S—, RₐR_{b}N—, and R₁ and R₂ taken together with any intervening atoms form a heterocycle; R₄ is a member selected from the group consisting of hydrogen, alkyl, alkyl-C(O)—NH—, alkyl-S(O)₂—NH—, aryl and halogen; R₅ is a member selected from the group consisting of hydrogen and alkyl; R₆ is a member selected from the group consisting of hydrogen and alkyl; R₇ is a member selected from the group consisting of aryl, arylalkyl, heterocycle and heterocyclealkyl; R₈ is a member selected from the group consisting of hydrogen, alkyl and alkoxy; R₉ is a member selected from the group consisting of hydrogen and alkyl; R₁₀ and R₁₁ are each ndependently selected from the group consisting of hydrogen, alkyl, and alkoxylalkyl, or R₁₀ and R₁₁ taken together with any intervening atoms form a 5, 6, or 7-membered ring; R₁₂ is hydrogen; and Rₐ and R_{b} are each individually a member selected from the group consisting of hydrogen, alkoxycarbonyl, alkyl, alkylcarbonyl, alkylNHC(O)—, alkylS(O)₂—, and Rₐ and R_{b} taken together with the nitrogen to which they are attacked form a heterocycle; provided that at least one of R₁, R₂ or R₃ are not hydrogen.

A further embodiment of the present invention is directed toward a compound of formula (IIb), 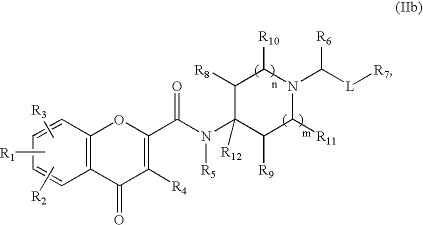
or a therapeutically suitable salt or prodrug thereof, wherein L is a bond; m is 1; n is 1; R₁, R₂ and R₃ are each independently a member selected from the group consisting of hydrogen, halogen, alkoxy, alkyl, cyano, haloalkyl, haloalkoxy and RₐR_{b}N—; R₄ is a member selected from the group consisting of hydrogen, alkyl, alkyl-C(O)—NH—, alkyl-S(O)₂—NH—, aryl and halogen; R₆ is a member selected from the group consisting of hydrogen and alkyl; R₇ is a member selected from the group consisting of aryl and heterocycle; R₈ is hydrogen; R₉ is hydrogen; R₁₀ and R₁₁ are hydrogen; R₁₂ is hydrogen; and Rₐ and R_{b} are each individually a member selected from the group consisting of hydrogen, alkoxycarbonyl, alkyl, alkylcarbonyl, alkyl-NHC(O)—, alkyl-S(O)₂—, and Rₐ and R_{b} taken together with the nitrogen to which they are attacked form a heterocycle; provided that at least one of R₁, R₂ or R₃ are not hydrogen.

Accordingly, another embodiment of the present invention is directed toward a compound of formula (III), 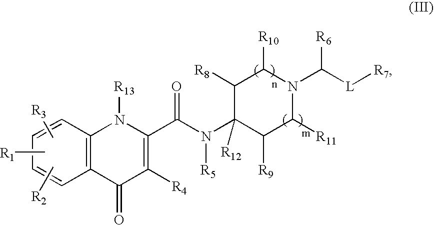
or a therapeutically suitable salt or prodrug thereof, wherein L is a member selected from the group consisting of a bond, alkyl, alkenyl, alkynyl, —CH₂—O—, —S(O)₂—NH—, —C(O)—NH—, —NH—C(O)—, —NH—S(O)₂—, —C(O)—, —S(O)— and —S(O)₂—; m is 1 or 2; n is 0, 1, or 2; R₁, R₂ and R₃ are each independently a member selected from the group consisting of hydrogen, halogen, alkenyl, alkoxy, alkyl, alkyl-C(O)—, alkyl-C(O)—NH—, alkyl-NH—C(O)—, alkyl-S(O)₂—NH—, alkyl-NH—S(O)₂—, alkyl-S(O)₂—, alkyl-S(O)—, alkyl-S—, alkynyl, cyano, haloalkyl, haloalkoxy, haloalkyl-S—, RₐR_{b}N—, and R₁ and R₂ taken together with any intervening atoms form a heterocycle; R₄ is a member selected from the group consisting of hydrogen, alkyl, alkyl-C(O)—NH—, alkyl-S(O)₂—NH—, aryl and halogen; R₅ is a member selected from the group consisting of hydrogen and alkyl; R₆ is a member selected from the group consisting of hydrogen, alkyl, aryl, cycloalkyl and heterocycle; R₇ is a member selected from the group consisting of aryl, arylalkyl, heterocycle and heterocyclealkyl; R₈ is a member selected from the group consisting of hydrogen, alkyl and alkoxy; R₉ is a member selected from the group consisting of hydrogen and alkyl; R₁₀ and R₁₁ are each independently selected from the group consisting of hydrogen, alkyl, and alkoxylalkyl, or R₁₀ and R₁₁ taken together with any intervening atoms form a 5, 6, or 7-membered ring; R₁₂ is a member selected from the group consisting of hydrogen and alkyl; R₁₃ is a member selected from the group consisting of hydrogen, alkyl, aryl, cycloalkyl and heterocycle; and Rₐ and R_{b} are each individually a member selected from the group consisting of hydrogen, alkoxycarbonyl, alkyl, alkylcarbonyl, alkyl-NHC(O)—, alkyl-S(O)₂—, and Rₐ and R_{b} taken together with the nitrogen to which they are attacked form a heterocycle; provided that at least one of R₁, R₂ or R₃ are not hydrogen.

Another embodiment of the present invention is directed toward a compound of formula (IlIa), 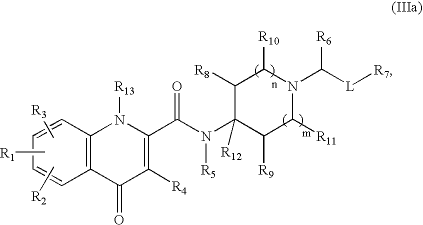
or a therapeutically suitable salt or prodrug thereof, wherein L is a member selected from the group consisting of a bond, alkyl, alkenyl, alkynyl, —CH₂—O—, —S(O)₂—NH—, —C(O)—NH—, —NH—C(O)—, —NH—S(O)₂—, —C(O)—, —S(O)— and —S(O)₂—; m is 1; n is 1; R₁, R₂ and R₃ are each independently a member selected from the group consisting of hydrogen, halogen, alkoxy, alkyl, alkyl-C(O)—, alkyl-C(O)—NH—, alkyl-NH—C(O)—, alkyl-S(O)₂—NH—, alkyl-NH—S(O)₂—, alkyl-S(O)₂—, alkyl-S(O)—, alkyl-S—, alkynyl, cyano, haloalkyl, haloalkoxy, haloalkyl-S—, RₐR_{b}N—, and R₁ and R₂ taken together with any intervening atoms form a heterocycle; R₄ is a member selected from the group consisting of hydrogen, alkyl, alkyl-C(O)—NH—, alkyl-S(O)₂—NH—, aryl and halogen; R₅ is a member selected from the group consisting of hydrogen and alkyl; R₆ is a member selected from the group consisting of hydrogen and alkyl; R₇ is a member selected from the group consisting of aryl, arylalkyl, heterocycle and heterocyclealkyl; R₈ is a member selected from the group consisting of hydrogen, alkyl and alkoxy; R₉ is a member selected from the group consisting of hydrogen and alkyl; R₁₀ and R₁₁ are each independently selected from the group consisting of hydrogen, alkyl, and alkoxylalkyl, or R₁₀ and R₁₁ taken together with any intervening atoms form a 5, 6, or 7-membered ring; R₁₂ is hydrogen; and Rₐ and R_{b} are each individually a member selected from the group consisting of hydrogen, alkoxycarbonyl, alkyl, alkylcarbonyl, alkyl-NHC(O)—, alkyl-S(O)₂—, and Rₐ and R_{b} taken together with the nitrogen to which they are attacked form a heterocycle; provided that at least one of R₁, R₂ or R₃ are not hydrogen.

A further embodiment of the present invention is directed toward a compound of formula (IIIb), 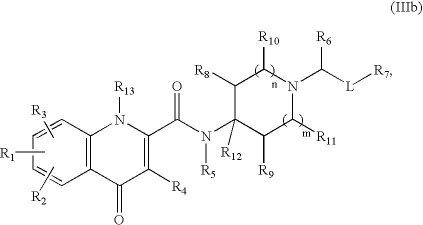
or a therapeutically suitable salt or prodrug thereof, wherein L is a bond; m is 1; n is 1; R₁, R₂ and R₃ are each independently a member selected from the group consisting of hydrogen, halogen, alkoxy, alkyl, cyano, haloalkyl, haloalkoxy and RₐR_{b}N—; R₄ is a member selected from the group consisting of hydrogen, alkyl, alkyl-C(O)—NH—, alkyl-S(O)₂—NH—, aryl and halogen; R₅ is hydrogen; R₆ is a member selected from the group consisting of hydrogen and alkyl; R₇ is a member selected from the group consisting of aryl and heterocycle; R₈ is hydrogen; R₉ is hydrogen; R₁₀ and R₁₁ are hydrogen; R₁₂ is hydrogen; and Rₐ and R_{b} are each individually a member selected from the group consisting of hydrogen, alkyl, and Rₐ and R_{b} taken together with the nitrogen to which they are attacked form a heterocycle; provided that at least one of R₁, R₂ or R₃ are not hydrogen.

In another embodiment of the present invention is directed to the compounds of formula (I, II, IIa, IIb, III, IIIa, and IIIb), wherein R₇ is aryl or arylalkyl wherein the aryl and the aryl of arylalkyl is further substituted with a group consisting of alkenyl, alkenyloxy, alkoxy, alkoxycarbonyl, alkyl, alkylcarbonyl, alkylcarbonyloxy, alkynyl, aryloxy, arylalkenyl, carboxy, carboxyalkyl, cyano, cyanoalkyl, formyl, halogen, haloalkyl, haloalkoxy, heterocycle, heterocyclealkyl, heterocyclealkyl-N(R_{g})—, heterocycle-N(R_{g})-alkyl-, heterocycle-N(R_{g})-alkoxy-, heterocyclealkoxy, hydroxy, hydroxyalkylene, nitro, RₑR_{f}N—, RₑR_{f}N-alkyl-, RₑR_{f}N-alkoxy-, RₑR_{f}N-alkyl-N(R_{g})—, RₑR_{f}N-alkyl-N(R_{g})—C(O)—, RₑR_{f}NC(O)—, RₑR_{f}C(O)N—, RₑR_{f}NS(O)₂—, RₑS(O)₂N—, RₑS(O)₂N-alkyl-, RₑS(O)₂N-alkoxy-, RₑS(O)₂-alkyl-, RₑS(O)₂-alkoxy-, phenyl, and a heterocyclic ring, wherein R_{g}, Rₑ, and R_{f} are defined herein.

According to one embodiment of the present invention, there is provided a method of treating disorders by inhibiting the effects of melanin concentrating hormone (MCH) through the melanin concentrating hormone receptor, comprising administrering a therapeutically effective amount of a compound of formula (I).

According to one embodiment of the present invention, there is provided a method of treating disorders by inhibiting the effects of melanin concentrating hormone (MCH) through the melanin concentrating hormone receptor, comprising administrering a therapeutically effective amount of a compound of formula (II, IIa, or IIb).

According to one embodiment of the present invention, there is provided a method of treating disorders by inhibiting the effects of melanin concentrating hormone (MCH) through the melanin concentrating hormone receptor, comprising administrering a therapeutically effective amount of a compound of formula (III, IIIa, or IIIb).

According to one embodiment of the present invention, there is provided a method of treating obesity by inhibiting the effects of melanin concentrating hormone (MCH) through the melanin concentrating hormone receptor, comprising administrering a therapeutically effective amount of a compound of formula (I).

According to one embodiment of the present invention, there is provided a method of treating obesity by inhibiting the effects of melanin concentrating hormone (MCH) through the melanin concentrating hormone receptor, comprising administrering a therapeutically effective amount of a compound of formula (II, IIa, or IIb).

According to one embodiment of the present invention, there is provided a method of treating obesity by inhibiting the effects of melanin concentrating hormone (MCH) through the melanin concentrating hormone receptor, comprising administrering a therapeutically effective amount of a compound of formula (III, IIIa, or IIIb).

According to one embodiment of the present invention, there is provided a method of treating abnormalities in reproduction and sexual behavior, thyroid hormone secretion, diuresis and water/electrolyte homeostasis, sensory processing, memory, sleeping and arousal, anxiety and depression, seizure and in treatment of neurodegeneration or psychiatric disorders by inhibiting the effects of melanin concentrating hormone (MCH) through the melanin concentrating hormone receptor, comprising administrering a therapeutically effective amount of a compound of formula (I).

According to one embodiment of the present invention, there is provided a method of treating abnormalities in reproduction and sexual behavior, thyroid hormone secretion, diuresis and water/electrolyte homeostasis, sensory processing, memory, sleeping and arousal, anxiety and depression, seizure and in treatment of neurodegeneration or psychiatric disorders by inhibiting the effects of melanin concentrating hormone (MCH) through the melanin concentrating hormone receptor, comprising administrering a therapeutically effective amount of a compound of formula (II, IIa, or IIb).

According to one embodiment of the present invention, there is provided a method of treating abnormalities in reproduction and sexual behavior, thyroid hormone secretion, diuresis and water/electrolyte homeostasis, sensory processing, memory, sleeping and arousal, anxiety and depression, seizure and in treatment of neurodegeneration or psychiatric disorders by inhibiting the effects of melanin concentrating hormone (MCH) through the melanin concentrating hormone receptor, comprising administrering a therapeutically effective amount of a compound of formula (III, IIIa, or IIIb).

According to one embodiment of the present invention, there is provided a pharmaceutical composition comprising a therapeutically effective amount of a compound of formula (I) in combination with a pharmaceutically suitable carrier.

According to one embodiment of the present invention, there is provided a pharmaceutical composition comprising a therapeutically effective amount of a compound of formula (II, IIa, or IIb) in combination with a pharmaceutically suitable carrier.

According to one embodiment of the present invention, there is provided a pharmaceutical composition comprising a therapeutically effective amount of a compound of formula (III, IIIa, or IIIb) in combination with a pharmaceutically suitable carrier.

According to one embodiment of the present invention, there is provided a method of treating disorders mediated by MCH through the MCH receptor comprising administering a therapeutically effective amount of a compound of formula (I, II, IIa, IIb, III, IIIa, or IIIb).

According to another embodiment of the present invention, there is provided a method for treating obesity comprising administering a therapeutically effective amount of a compound of formula (I, II, IIa, IIb, III, IIIa, or IIIb).

According to still another embodiment, the present invention is directed to a pharmaceutical composition comprising a therapeutically effective amount of a compound of formula (I, II, IIa, IIb, III, IIIa, or IIIb) in combination with a pharmaceutically suitable carrier.

### DEFINITIONS

As used throughout this specification and the appended claims, the following terms have the following meanings:

The term “alkenyl,” as used herein, refers to a straight or branched chain hydrocarbon containing from 2 to 10 carbons and containing at least one carbon-carbon double bond formed by the removal of two hydrogens. Representative examples of alkenyl include, but are not limited to, ethenyl, 2-propenyl, 2-methyl-2-propenyl, 3-butenyl, 4-pentenyl, 5-hexenyl, 2-heptenyl, 2-methyl-1-heptenyl, and 3-decenyl.

The term “alkoxy,” as used herein, refers to an alkyl group, as defined herein, appended to the parent molecular moiety through an oxygen atom. Representative examples of alkoxy include, but are not limited to, methoxy, ethoxy, propoxy, 2-propoxy, butoxy, tert-butoxy, pentyloxy, and hexyloxy.

The term “alkoxylalkyl,” as used herein, refers to an alkoxy group, as defined herein, appended to the parent molecular moiety through an alkyl group, as defined herein.

The term “alkyl,” as used herein, refers to a straight or branched chain hydrocarbon containing from 1 to 10 carbon atoms. Representative examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, and n-decyl.

The term “alkylcarbonyl,” as used herein, refers to an alkyl group, as defined herein, appended to the parent molecular moiety through a carbonyl group, as defined herein. Representative examples of alkylcarbonyl include, but are not limited to, acetyl, 1-oxopropyl, 2,2-dimethyl-1-oxopropyl, 1-oxobutyl, and 1-oxopentyl.

The term “alkyl-C(O)—,” as used herein, refers to an alkyl group, as defined herein, appended to the parent molecular moiety through a C(O)-group, as defined herein.

The term “alkyl-C(O)—NH—,” as used herein, refers to a alkyl-C(O) group, as defined herein, appended to the parent molecular moiety through a —NH-group, as defined herein.

The term “alkyl-NH—,” as used herein, refers to a alkyl group, as defined herein, appended to the parent molecular moiety through an —NH-group, as defined herein.

The term “alkyl-NH—C(O)—,” as used herein, refers to a alkyl-NH-group, as defined herein, appended to the parent molecular moiety through a —C(O)-group, as defined herein.

The term “alkyl-NH—S(O)₂—,” as used herein, refers to a alkyl-NH-group, as defined herein, appended to the parent molecular moiety through a —S(O)₂-group, as defined herein.

The term “alkyl-S—,” as used herein, refers to a alkyl group, as defined herein, appended to the parent molecular moiety through a —S-group, as defined herein.

The term “alkyl-S(O)₂—,” as used herein, refers to an alkyl group, as defined herein, appended to the parent molecular moiety through a —S(O)₂-group, as defined herein.

The term “alkyl-S(O)₂—NH—,” as used herein, refers to a alkyl-S(O)₂-group, as defined herein, appended to the parent molecular moiety through a —NH-group, as defined herein.

The term “alkylene,” denotes a divalent group derived from a straight or branched chain hydrocarbon of from 1 to 10 carbon atoms. Representative examples of alkylene include, but are not limited to, —CH₂—, —CH₂CH₂, —CH₂CH₂CH₂—, —CH₂CH₂CH₂CH₂—, and —CH₂CH(CH₃)CH₂—.

The term “alkynyl,” as used herein, refers to a straight or branched chain hydrocarbon group containing from 2 to 10 carbon atoms and containing at least one carbon-carbon triple bond. Representative examples of alkynyl include, but are not limited, to acetylenyl, 1-propynyl, 2-propynyl, 3-butynyl, 2-pentynyl, and 1-butynyl.

The term “alkylsulfonyl,” as used herein, refers to an alkyl group, as defined herein, appended to the parent molecular moiety through a sulfonyl group, as defined herein. Representative examples of alkylsulfonyl include, but are not limited to, methylsulfonyl and ethylsulfonyl.

The term “aryl,” as used herein, refers to a monocyclic-ring system, or a bicyclic- or a tricyclic-fused ring system wherein one or more of the fused rings are aromatic. Representative examples of aryl include, but are not limited to, anthracenyl, azulenyl, fluorenyl, indanyl, indenyl, naphthyl, phenyl, and tetrahydronaphthyl.

The aryl groups of this invention may be substituted with 0, 1, 2, or 3 substituents which are each independently members selected from the group consisting of alkenyl, alkenyloxy, alkoxy, alkoxycarbonyl, alkyl, alkylcarbonyl, alkylcarbonyloxy, alkynyl, aryloxy, arylalkenyl, carboxy, carboxyalkyl, cyano, cyanoalkyl, formyl, halogen, haloalkyl, haloalkoxy, heterocycle, heterocyclealkyl, heterocyclealkyl-N(R_{g})—, heterocycle-N(R_{g})-alkyl-, heterocycle-N(R_{g})-alkoxy-, heterocyclealkoxy, hydroxy, hydroxyalkylene, nitro, RₑR_{f}N—, RₑR_{f}N-alkyl-, RₑR_{f}N-alkoxy-, RₑR_{f}N-alkyl-N(R_{g})—, RₑR_{f}N-alkyl-N(R_{g})—C(O)—, RₑR_{f}NC(O)—, RₑR_{f}C(O)N—, RₑR_{f}NS(O)₂—, RₑS(O)₂N—, RₑS(O)₂N-alkyl-, RₑS(O)₂N-alkoxy-, RₑS(O)₂-alkyl-, RₑS(O)₂-alkoxy-, phenyl, and heterocyclic ring, wherein aryl of said aryloxy, said phenyl and said heterocyclic ring may each be substituted with 0, 1, 2, or 3 substitutents selected from the group consisting of alkenyl, alkoxy, alkoxycarbonyl, alkyl, alkylcarbonyl, carboxy, carboxyalkyl, cyano, cyanoalkyl, halogen, haloalkyl, hydroxy, hydroxyalkyl and nitro, wherein Rₑ and R_{f} are each individually a member selected from the group consisting of hydrogen, alkyl, heterocycle and heterocyclealkyl.

The term “arylalkyl,” as used herein, refers to an aryl group, as defined herein, appended to the parent molecular moiety through an alkyl group, as defined herein. Representative examples of arylalkyl include, but are not limited to, benzyl, 2-phenylethyl, 3-phenylpropyl, and 2-naphth-2-ylethyl.

The term “arylalkenyl” as used herein, refers to an aryl group, as defined herein, appended to the parent molecular moiety through an alkenyl group, as defined herein. Representative examples of arylalkenyl include, but are not limited to, prop-1-enylbenzene, 1-(prop-1-enyl)naphthalene and the like.

The term “arylcarbonyl,” as used herein, refers to an aryl group, as defined herein, appended to the parent molecular moiety through a carbonyl group, as defined herein. Representative examples of arylcarbonyl include, but are not limited to, benzoyl and naphthoyl.

The term “arylcarbonylalkyl” as used herein, refers to an arylcarbonyl group, as defined herein, appended to the parent molecular moiety through a carbonyl group, as defined herein. Representative examples of arylcarbonylalkyl include, but are not limited to, propiophenone, 1-(1-naphthyl)propane-1-one and the like.

The term “aryloxy,” as used herein, refers to an aryl group, as defined herein, appended to the parent molecular moiety through an oxygen atom. Representative examples of aryloxy include, but are not limited to, phenoxy, naphthyloxy, 3-bromophenoxy, 4chlorophenoxy, 4-methylphenoxy, and 3,5-dimethoxyphenoxy.

The term “aryloxyalkyl,” as used herein, refers to an aryloxy group, as defined herein, appended to the parent molecular moiety through an alkyl group, as defined herein. Representative examples of aryloxyalkyl include, but are not limited to, 2-phenoxyethyl, 3-naphth-2-yloxypropyl and 3-bromophenoxymethyl.

The term “arylsulfonyl” as used herein, refers to an aryl group, as defined herein, appended to the parent molecular moiety through a sulfonyl group, as defined herein. Representative examples of arylsulfonyl include but are not limited to (ethylsulfonyl)benzene, 1-(ethylsulfonyl)naphthalene and the like.

The term “aryl-C(O)—,” as used herein, refers to a aryl group, as defined herein, appended to the parent molecular moiety through an —C(O)-group, as defined herein.

The term “aryl-C(O)—NH—,” as used herein, refers to a aryl-C(O)-group, as defined herein, appended to the parent molecular moiety through a —NH-group, as defined herein.

The term “aryl-C═N—O—,” as used herein, refers to a aryl group, as defined herein, appended to the parent molecular moiety through a —C═N—O-group, as defined herein.

The term “aryl-NH—,” as used herein, refers to a aryl group, as defined herein, appended to the parent molecular moiety through a —NH-group, as defined herein.

The term “aryl-NH—C(O)—,” as used herein, refers to a aryl-NH-group, as defined herein, appended to the parent molecular moiety through an —C(O)-group, as defined herein.

The term “aryl-NH—S(O)₂—,” as used herein, refers to a aryl-NH-group, as defined herein, appended to the parent molecular moiety through a —S(O)₂-group, as defined herein.

The term “aryloxy,” as used herein, refers to an aryl group, as defined herein, appended to the parent molecular moiety through an oxy group, as defined herein.

The term “aryl-S—,” as used herein, refers to a aryl group, as defined herein, appended to the parent molecular moiety through an —S-group, as defined herein.

The term “aryl-S-alkyl-C(O)—,” as used herein, refers to a aryl-S-alkyl group, as defined herein, appended to the parent molecular moiety through a —C(O)-group, as defined herein.

The term “aryl-S(O)₂—,” as used herein, refers to a aryl group, as defined herein, appended to the parent molecular moiety through a —S(O)₂-group, as defined herein.

The term “aryl-S(O)₂—NH—,” as used herein, refers to a aryl-S(O)₂-group, as defined herein, appended to the parent molecular moiety through a —NH-group, as defined herein.

The term “arylalkyl-C(O)—,” as used herein, refers to a arylalkyl group, as defined herein, appended to the parent molecular moiety through a —C(O)-group, as defined herein.

The term “arylalkyl-C(O)—NH—,” as used herein, refers to a arylalkyl-C(O)-group, as defined herein, appended to the parent molecular moiety through a —NH-group, as defined herein.

The term “arylalkyl-NH—,” as used herein, refers to a arylalkyl group, as defined herein, appended to the parent molecular moiety through a —NH-group, as defined herein.

The term “arylalkyl-NH—C(O)—,” as used herein, refers to a arylalkyl-NH-group, as defined herein, appended to the parent molecular moiety through a —C(O)-group, as defined herein.

The term “arylalkyl-NH—S(O)₂—,” as used herein, refers to a arylalkyl-NH-group, as defined herein, appended to the parent molecular moiety through a —S(O)₂-group, as defined herein.

The term “arylalkoxy,” as used herein, refers to an aryl group, as defined herein, appended to the parent molecular moiety through a alkoxy group, as defined herein.

The term “arylalkyl-S—,” as used herein, refers to a arylalkyl group, as defined herein, appended to the parent molecular moiety through a —S-group, as defined herein.

The term “arylalkyl-S(O)—,” as used herein, refers to a arylalkyl group, as defined herein, appended to the parent molecular moiety through an —S(O)₂-group, as defined herein.

The term “arylalkyl-S(O)—NH—,” as used herein, refers to an arylalkyl-S(O)₂—NH-group, as defined herein, appended to the parent molecular moiety through a —NH-group, as defined herein.

The term “biarylalkyl” as used herein, refers to two aryl groups, as defined herein, appended to the parent molecular moiety through an alkyl group, as defined herein. Representative examples of biarylalkyl include but are not limited to (1-phenylbutyl)benzene and the like.

The term “carbonyl,” as used herein, refers to a —C(O)-group.

The term “carbonylalkyl,” as used herein, refers to a carbonyl group, as defined herein, appended to the parent molecular moiety through an alkyl group, as defined herein.

The term “cyano,” as used herein, refers to a —CN group.

The term “cycloalkyl,” as used herein, refers to a monocyclic, bicyclic, or tricyclic ring system. Monocyclic ring systems are exemplified by a saturated cyclic hydrocarbon group containing from 3 to 8 carbon atoms. Examples of monocyclic ring systems include cyclopropyl, cyclobutyl, cyclopentyl, cyclohexyl, cycloheptyl, and cyclooctyl. Bicyclic ring systems are exemplified by a bridged monocyclic ring system in which two non-adjacent carbon atoms of the monocyclic ring are linked by an alkylene bridge of between one and three additional carbon atoms. Representative examples of bicyclic ring systems include, but are not limited to, bicyclo(3.1.1)heptane, bicyclo(2.2.1)heptane, bicyclo(2.2.2)octane, bicyclo(3.2.2)nonane, bicyclo(3.3.1)nonane, and bicyclo(4.2.1)nonane. Tricyclic ring systems are exemplified by a bicyclic ring system in which two non-adjacent carbon atoms of the bicyclic ring are linked by a bond or an alkylene bridge of between one and three carbon atoms. Representative examples of tricyclic-ring systems include, but are not limited to, tricyclo(3.3.1.0^{3,7})nonane and tricyclo(3.3.1.1^{3,7})decane (adamantane).

The cycloalkyl groups of this invention may be substituted with 0, 1, 2, or 3 substituents independently a member selected from alkenyl, alkoxy, alkoxycarbonyl, alkyl, alkylcarbonyl, alkylcarbonyloxy, alkynyl, aryl, aryloxy, arylalkenyl, carboxy, carboxyalkyl, cyano, cyanoalkyl, formyl, halogen, haloalkyl, heterocycle, hydroxy, hydroxyalkyl, nitro and RₑR_{f}N—, wherein Rₑ and R_{f} are defined herein.

The term “cycloalkyl-C(O)—,” as used herein, refers to a cycloalkyl group, as defined herein, appended to the parent molecular moiety through a —C(O)-group, as defined herein.

The term “cycloalkyl-C(O)—NH—,” as used herein, refers to a cycloalkyl-C(O)-group, as defined herein, appended to the parent molecular moiety through a —NH-group, as defined herein.

The term “cycloalkyl-NH—,” as used herein, refers to a cycloalkyl group, as defined herein, appended to the parent molecular moiety through a —NH—,group, as defined herein.

The term “cycloalkyl-NH—C(O)—,” as used herein, refers to a cycloalkyl-NH-group, as defined herein, appended to the parent molecular moiety through a —C(O)-group, as defined herein.

The term “cycloalkyl-NH—S(O)₂—,” as used herein, refers to a cycloalkyl-NH-group, as defined herein, appended to the parent molecular moiety through a —S(O)₂-group, as defined herein.

The term “cycloalkoxy,” as used herein, refers to a cycloalkyl group, as defined herein, appended to the parent molecular moiety through an oxy group, as defined herein.

The term “cycloalkyl-S—,” as used herein, refers to a cycloalkyl group, as defined herein, appended to the parent molecular moiety through an —S-group, as defined herein.

The term “cycloalkyl-S(O)₂—,” as used herein, refers to a cycloalkyl group, as defined herein, appended to the parent molecular moiety through a —S(O)₂-group, as defined herein.

The term “cycloalkyl-S(O)₂—NH—,” as used herein, refers to a cycloalkyl-S(O)₂-group, as defined herein, appended to the parent molecular moiety through a —NH-group, as defined herein.

The term “cycloalkenylalkyl,” as used herein, refers to a cycloalkenyl group, as defined herein, appended to the parent molecular moiety through an alkyl group, as defined herein.

The term “cycloalkenyl-C(O)—,” as used herein, refers to a cycloalkenyl group, as defined herein, appended to the parent molecular moiety through a —C(O)-group, as defined herein.

The term “cycloalkenyl-C(O)—NH—,” as used herein, refers to a cycloalkenyl—C(O)-group, as defined herein, appended to the parent molecular moiety through a —NH-group, as defined herein.

The term “cycloalkenyl-NH—,” as used herein, refers to a cycloalkenyl group, as defined herein, appended to the parent molecular moiety through a —NH-group, as defined herein.

The term “cycloalkenyl-NH—C(O)—,” as used herein, refers to a cycloalkenyl-NH-group, as defined herein, appended to the parent molecular moiety through a —C(O)-group, as defined herein.

The term “cycloalkenyl-NH—S(O)₂—,” as used herein, refers to a cycloalkenyl-NH-group, as defined herein, appended to the parent molecular moiety through a —S(O)₂-group, as defined herein.

The term “cycloalkenyloxy,” as used herein, refers to a cycloalkenyl group, as defined herein, appended to the parent molecular moiety through an oxy group, as defined herein.

The term “cycloalkenyl-S—,” as used herein, refers to a cycloalkenyl group, as defined herein, appended to the parent molecular moiety through an —S-group, as defined herein.

The term “cycloalkenyl-S(O)₂—,” as used herein, refers to a cycloalkenyl group, as defined herein, appended to the parent molecular moiety through a —S(O)₂-group, as defined herein.

The term “cycloalkenyl-S(O)₂—NH—,” as used herein, refers to a cycloalkenyl-S(O)₂-group, as defined herein, appended to the parent molecular moiety through a —NH-group, as defined herein.

The term “halo” or “halogen,” as used herein, refers to —Cl, —Br, —I or —F.

The term “haloalkoxy,” as used herein, refers to at least one halogen, as defined herein, appended to the parent molecular moiety through an alkoxy group, as defined herein. Representative examples of haloalkoxy include, but are not limited to, chloromethoxy, 2-fluoroethoxy, trifluoromethoxy, and pentafluoroethoxy.

The term “haloalkyl,” as used herein, refers to at least one halogen, as defined herein, appended to the parent molecular moiety through an alkyl group, as defined herein. Representative examples of haloalkyl include, but are not limited to, chloromethyl, 2-fluoroethyl, trifluoromethyl, pentafluoroethyl, and 2-chloro-3-fluoropentyl.

The term “heterocycle” or “heterocyclic ring,” as used herein, refers to a monocyclic, bicyclic, or tricyclic ring system. Monocyclic ring systems are exemplified by any 3- or 4-membered ring containing a heteroatom independently a member selected from oxygen, nitrogen and sulfur; or a 5-, 6- or 7-membered ring containing one, two or three heteroatoms wherein the heteroatoms are independently a member selected from nitrogen, oxygen and sulfur. The 5-membered ring has from 0-2 double bonds and the 6- and 7-membered ring have from 0-3 double bonds. Representative examples of monocyclic ring systems include, but are not limited to, azetidinyl, azepanyl, aziridinyl, 5-(2,1-benzisothiazole), 6-(2,1-benzisothiazole), 5-(2,1-benzisoxazole), 6-(2,1-benzisoxazole), diazepinyl, 1,3-dioxolanyl, dioxanyl, dithianyl, furyl, imidazolyl, imidazolinyl, imidazolidinyl, 6-imidazo[1,2-α]pyridine, 7-imidazo[1,2-α]pyridine, isothiazolyl, isothiazolinyl, isothiazolidinyl, 2-isothiazolidine 1,1-dioxide, isoxazolyl, isoxazolinyl, isoxazolidinyl, morpholinyl, oxadiazolyl, oxadiazolinyl, oxadiazolidinyl, oxazolyl, oxazolinyl, oxazolidinyl, piperazinyl, piperidinyl, pyranyl, pyrazinyl, pyrazolyl, pyrazolinyl, pyrazolidinyl, pyridinyl, pyrimidinyl, pyridazinyl, 2-pyridazin-3(2h)-one, pyrrolyl, pyrrolinyl, pyrrolidinyl, tetrahydrofuranyl, tetrahydrothienyl, tetrazinyl, tetrazolyl, thiadiazolyl, thiadiazolinyl, thiadiazolidinyl, thiazolyl, thiazolinyl, thiazolidinyl, thienyl, thiomorpholinyl, 1,1-dioxidothiomorpholinyl (thiomorpholine sulfone), thiopyranyl, triazinyl, triazolyl, and trithianyl. Bicyclic ring systems are exemplified by any of the above monocyclic ring systems fused to an aryl group as defined herein, a cycloalkyl group as defined herein, or another monocyclic ring system. Representative examples of bicyclic ring systems include but are not limited to, for example, benzimidazolyl, benzodioxinyl, benzothiazolyl, benzothienyl, benzotriazolyl, benzoxazolyl, benzofuranyl, benzopyranyl, benzothiopyranyl, cinnolinyl, indazolyl, indolyl, 2,3-dihydroindolyl, indolizinyl, naphthyridinyl, isobenzofuranyl, isobenzothienyl, isoindolyl, isoquinolinyl, phthalazinyl, 4H-pyrido(1,2-α)pyrimidin-4-one, pyranopyridinyl, quinolinyl, quinolizinyl, quinoxalinyl, quinazolinyl, tetrahydroisoquinolinyl, tetrahydroquinolinyl, and thiopyranopyridinyl. Tricyclic rings systems are exemplified by any of the above bicyclic ring systems fused to an aryl group as defined herein, a cycloalkyl group as defined herein, or a monocyclic ring system. Representative examples of tricyclic ring systems include, but are not limited to, acridinyl, carbazolyl, carbolinyl, dibenzo(b,d)furanyl, dibenzo(b,d)thienyl, naphtho(2,3-b)furan, naphtho(2,3-b)thienyl, phenazinyl, phenothiazinyl, phenoxazinyl, thianthrenyl, thioxanthenyl and xanthenyl.

The heterocycles of this invention may be substituted with 0, 1, 2,or 3 alkenyl, alkenyloxy, alkoxy, alkoxycarbonyl, alkyl, alkylcarbonyl, alkylcarbonyloxy, alkynyl, aryloxy, arylalkenyl, carboxy, carboxyalkyl, cyano, cyanoalkyl, formyl, halogen, haloalkyl, haloalkoxy, heterocycle, heterocyclealkyl, heterocyclealkyl-N(R_{g})—, heterocycle-N(R_{g})-alkyl-, heterocycle-N(R_{g})-alkoxy-, heterocyclealkoxy, hydroxy, hydroxyalkylene, nitro, RₑR_{f}N—, RₑR_{f}N-alkyl-, RₑR_{f}N-alkoxy-, RₑR_{f}N-alkyl-N(R_{g})—, RₑR_{f}N-alkyl-N(R_{g})—C(O)—, RₑR_{f}NC(O)—, RₑR_{f}C(O)N—, RₑR_{f}NS(O)₂—, RₑS(O)₂N—, RₑS(O)₂N-alkyl-, RₑS(O)₂N-alkoxy-, RₑS(O)₂-alkyl-, RₑS(O)₂-alkoxy-, phenyl, and heterocyclic ring, wherein aryl of said aryloxy, said phenyl and said heterocyclic ring may each be substituted with 0, 1, 2, or 3 substitutents selected from the group consisting of alkenyl, alkoxy, alkoxycarbonyl, alkyl, alkylcarbonyl, carboxy, carboxyalkyl, cyano, cyanoalkyl, halogen, haloalkyl, hydroxy, hydroxyalkyl and nitro, wherein Rₑ and R_{f} are each individually a member selected from the group consisting of hydrogen, alkyl, heterocycle and heterocyclealkyl.

The term “heterocycle-alkyl,” as used herein, refers to a heterocycle, as defined herein, appended to the parent molecular moiety through an alkyl group, as defined herein. Representative examples of heterocycle-alkyl include, but are not limited to, pyridin-3-ylmethyl and 2-pyrimidin-2-ylpropyl.

The term “heterocycle-C(O)—,” as used herein, refers to a heterocycle group, as defined herein, appended to the parent molecular moiety through a —C(O)-group, as defined herein.

The term “heterocycle-C(O)NH—,” as used herein, refers to a heterocycle-C(O)-group, as defined herein, appended to the parent molecular moiety through a —NH-group, as defined herein.

The term “heterocycle-NH—,” as used herein, refers to a heterocycle group, as defined herein, appended to the parent molecular moiety through a —NH-group, as defined herein.

The term “heterocyclealkyl-NH-aryl-,” as used herein, refers to a heterocyclealkyl-NH—, as defined herein, appended to the parent molecular moiety through an aryl group, as defined herein.

The term “heterocycle-NH—C(O)—,” as used herein, refers to a heterocycle-NH-group, as defined herein, appended to the parent molecular moiety through a —C(O)-group, as defined herein.

The term “heterocyclealkyl-NH—C(O)-aryl,” as used herein, refers to a heterocycle-NH—C(O)-group, as defined herein, appended to the parent molecular moiety through an aryl group, as defined herein.

The term “heterocycle-NH—S(O)₂—,” as used herein, refers to a heterocycle-NH-group, as defined herein, appended to the parent molecular moiety through a —S(O)₂-group, as defined herein.

The term “heterocycle-O—,” as used herein, refers to a heterocycle group, as defined herein, appended to the parent molecular moiety through an —O-group, as defined herein.

The term “heterocycle-S—,” as used herein, refers to a heterocycle group, as defined herein, appended to the parent molecular moiety through an —S-group, as defined herein.

The term “heterocycle-S(O)₂—,” as used herein, refers to a heterocycle group, as defined herein, appended to the parent molecular moiety through a —S(O)₂-group, as defined herein.

The term “heterocycle-S(O)₂—NH—,” as used herein, refers to a heterocycle-S(O)₂-group, as defined herein, appended to the parent molecular moiety through an —NH-group, as defined herein.

The term “heterocycle-alkyl-C(O)—,” as used herein, refers to a heterocycle-alkyl group, as defined herein, appended to the parent molecular moiety through an —C(O)-group, as defined herein.

The term “heterocycle-alkyl-C(O)—NH—,” as used herein, refers to a heterocycle-alkyl-C(O)-group, as defined herein, appended to the parent molecular moiety through a —NH-group, as defined herein.

The term “heterocycle-alkyl-NH—,” as used herein, refers to a heterocycle-alkyl group, as defined herein, appended to the parent molecular moiety through a —NH-group, as defined herein.

The term “heterocycle-alkyl-NH—C(O)—,” as used herein, refers to a heterocycle-alkyl-NH-group, as defined herein, appended to the parent molecular moiety through a —C(O)-group, as defined herein.

The term “heterocycle-alkyl-NH—S(O)₂—,” as used herein, refers to a heterocycle-alkyl-NH-group, as defined herein, appended to the parent molecular moiety through a —S(O)₂-group, as defined herein.

The term “heterocycle-alkyl-O—,” as used herein, refers to a heterocycle-alkyl group, as defined herein, appended to the parent molecular moiety through a —O-group, as defined herein.

The term “heterocycle-alkyl-S—,” as used herein, refers to a heterocycle-alkyl group, as defined herein, appended to the parent molecular moiety through a —S-group, as defined herein.

The term “heterocycle-alkyl-S(O)₂—,” as used herein, refers to a heterocycle-alkyl group, as defined herein, appended to the parent molecular moiety through a —S(O)₂-group, as defined herein.

The term “heterocycle-alkyl-S(O)₂—NH—,” as used herein, refers to a heterocycle-alkyl-S(O)₂-group, as defined herein, appended to the parent molecular moiety through a —NH-group, as defined herein.

The term “hydroxy,” as used herein, refers to an —OH group.

The term “hydroxyalkylene,” as used herein, refers to a hydroxy group, as defined herein, appended to the parent molecular moiety through an alkylene group, as defined herein. Representative examples of hydroxyalkylene include, but are not limited to, hydroxybutyl, hydroxypentyl and hydroxyhexyl.

The term “—NR_{b}-alkyl,” as used herein, refers to a —NR_{b}-group, as defined herein, appended to the parent molecular moiety through an alkyl group, as defined herein.

The term “RₐR_{b}N—,” as used herein, refers to Rₐ and R_{b}, as defined herein, appended to the parent molecular moiety through a nitrogen atom.

The term “oxo,” as used herein, refers to a ═O moiety.

The term “sulfonyl,” as used herein, refers to a —SO₂-group.

The present compounds may exist as therapeutically suitable salts. The term “therapeutically suitable salt,” refers to salts or zwitterions of the compounds which are water or oil-soluble or dispersible, suitable for treatment of disorders without undue toxicity, irritation, and allergic response, commensurate with a reasonable benefit/risk ratio, and effective for their intended use. The salts may be prepared during the final isolation and purification of the compounds or separately by reacting an amino group of the compounds with a suitable acid. Representative salts include acetate, adipate, alginate, citrate, aspartate, benzoate, benzenesulfonate, bisulfate, butyrate, camphorate, camphorsulfonate, digluconate, glycerophosphate, hemisulfate, heptanoate, hexanoate, formate, isothionate, fumarate, lactate, maleate, methanesulfonate, naphthylenesulfonate, nicotinate, oxalate, pamoate, pectinate, persulfate, 3-phenylpropionate, picrate, oxalate, maleate, pivalate, propionate, succinate, tartrate, trichloroacetic, trifluoroacetic, glutamate, para-toluenesulfonate, undecanoate, hydrochloric, hydrobromic, sulfuric, phosphoric, and the like. The amino groups of the compounds may also be quaternized with alkyl chlorides, bromides, and iodides such as methyl, ethyl, propyl, isopropyl, butyl, lauryl, myristyl, stearyl, and the like.

Basic addition salts may be prepared during the final isolation and purification of the present compounds by reaction of a carboxyl group with a suitable base such as the hydroxide, carbonate, or bicarbonate of a metal cation such as lithium, sodium, potassium, calcium, magnesium, or aluminum, or an organic primary, secondary, or tertiary amine. Quaternary amine salts derived from methylamine, dimethylamine, trimethylamine, triethylamine, diethylamine, ethylamine, tributlyamine, pyridine, N,N-dimethylaniline, N-methylpiperidine, N-methylmorpholine, dicyclohexylamine, procaine, dibenzylamine, N,N-dibenzylphenethylamine, 1-ephenamine, and N,N′-dibenzylethylenediamine, ethylenediamine, ethanolamine, diethanolamine, piperidine, piperazine, and the like, are contemplated as being within the scope of the present invention.

The present compounds may also exist as therapeutically suitable esters and prodrugs. The term “therapeutically suitable esters and prodrug,” refers to those esters and prodrugs or zwitterions which are suitable for use in contact with the tissues of patients without undue toxicity, irritation, and allergic response, are commensurate with a reasonable benefit/risk ratio, and are effective for their intended use. The term “prodrug,” refers to compounds which are rapidly transformed in vivo to the parent compounds of formula (I-II) for example, by hydrolysis in blood. The term “therapeutically suitable ester,” refers to compounds which are rapidly transformed in vivo to the parent compounds of formula (I-II) for example, by hydrolysis in blood. The term “therapeutically suitable ester,” refers to alkoxycarbonyl groups appended to the parent molecule on an available carbon atom. More specifically, a “therapeutically suitable ester,” may exist on one or more available aryl, cycloalkyl and heterocycle group as defined herein.

Asymmetric centers may exist in the present compounds. Individual stereoisomers of the compounds are prepared by synthesis from chiral starting materials or by preparation of racemic mixtures and separation by conversion to a mixture of diastereomers followed by separation or recrystallization, chromatographic techniques, or direct separation of the enantiomers on chiral chromatographic columns. Starting materials of particular stereochemistry are either commercially available or are made by the methods described herein below and resolved by techniques well known in the art.

Geometric isomers may exist in the present compounds. The invention contemplates the various geometric isomers and mixtures thereof resulting from the disposal of substituents around a carbon-carbon double bond, a cycloalkyl group, or a heterocycloalkyl group. Substituents around a carbon-carbon double bond are designated as being of Z or E configuration and substituents around a cycloalkyl or heterocycloalkyl are designated as being of cis or trans configuration.

Therapeutic compositions of the present compounds comprise an effective amount of the same formulated with one or more therapeutically suitable excipients. The term “therapeutically suitable excipient,” as used herein, represents a nontoxic, solid, semi-solid or liquid filler, diluent, encapsulating material, or formulation auxiliary of any type. Examples of therapeutically suitable excipients include sugars; cellulose and derivatives thereof; oils; glycols; solutions; buffering, coloring, releasing, coating, sweetening, flavoring, and perfuming agents; and the like. These therapeutic compositions may be administered parenterally, intracisternally, orally, rectally, or intraperitoneally.

Liquid dosage forms for oral administration of the present compounds comprise formulations of the same as emulsions, microemulsions, solutions, suspensions, syrups, and elixirs. In addition to the compounds, the liquid dosage forms may contain diluents and/or solubilizing or emulsifying agents. Besides inert diluents, the oral compositions may include wetting, emulsifying, sweetening, flavoring, and perfuming agents.

Injectable preparations of the present compounds comprise sterile, injectable, aqueous and oleaginous solutions, suspensions or emulsions, any of which may be optionally formulated with parenterally suitable diluents, dispersing, wetting, or suspending agents. These injectable preparations may be sterilized by filtration through a bacterial-retaining filter or formulated with sterilizing agents that dissolve or disperse in the injectable media.

Antagonism of the effects of MCH through the MCH receptor by the compounds of the present invention may be delayed by using a liquid suspension of crystalline or amorphous material with poor water solubility. The rate of absorption of the compounds depends upon their rate of dissolution that, in turn, depends on their crystallinity. Delayed absorption of a parenterally administered compound may be accomplished by dissolving or suspending the compound in oil. Injectable depot forms of the compounds may also be prepared by microencapsulating the same in biodegradable polymers. Depending upon the ratio of compound to polymer and the nature of the polymer employed, the rate of release may be controlled. Depot injectable formulations are also prepared by entrapping the compounds in liposomes or microemulsions that are compatible with body tissues.

Solid dosage forms for oral administration of the present compounds include capsules, tablets, pills, powders, and granules. In such forms, the compound is mixed with at least one inert, therapeutically suitable excipient such as a carrier, filler, extender, disintegrating agent, solution-retarding agent, wetting agent, absorbent, or lubricant. With capsules, tablets, and pills, the excipient may also contain buffering agents. Suppositories for rectal administration may be prepared by mixing the compounds with a suitable non-irritating excipient that is solid at ordinary temperature but fluid in the rectum.

The present compounds may be microencapsulated with one or more of the excipients discussed previously. The solid dosage forms of tablets, dragees, capsules, pills, and granules may be prepared with coatings and shells such as enteric and release-controlling. In these forms, the compounds may be mixed with at least one inert diluent and may optionally comprise tableting lubricants and aids. Capsules may also optionally contain opacifying agents that delay release of the compounds in a desired part of the intestinal tract.

Transdermal patches have the added advantage of providing controlled delivery of the present compounds to the body. Such dosage forms may be prepared by dissolving or dispensing the compounds in a suitable medium. Absorption enhancers may also be used to increase the flux of the compounds across the skin, and the rate of absorption may be controlled by providing a rate controlling membrane or by dispersing the compounds in a polymer matrix or gel.

Disorders caused or exacerbated by MCH are treated or prevented in a patient by administering to the patient a therapeutically effective amount of compound of the present invention in such an amount and for such time as is necessary to achieve the desired result. The term “therapeutically effective amount,” refers to a sufficient amount of a compound to effectively emeliorate disorders mediated by MCH, by antagonizing the effect of MCH through the MCH receptor at a reasonable benefit/risk ratio applicable to any medical treatment. The specific therapeutically effective dose level for any particular patient will depend upon a variety of factors including the disorder being treated and the severity of the disorder; the activity of the compound employed; the specific composition employed; the age, body weight general health, sex, and diet of the patient; the time of administration, route of administration, rate of excretion; the duration of the treatment; and drugs used in combination or coincidental therapy.

The total daily dose of the present compounds in single or divided doses may be in amounts, for example, from 0.01 to 50 mg/kg body weight or more usually from 0.1 to 25 mg/kg body weight. In general, treatment regimens comprise administration to a patient in need of such treatment from about 10 mg to about 1000 mg of the compounds per day in single or multiple doses.

### Determination of Biological Activity

Assay for Release of Intracellular Calcium:

Activation of the melanin concentrating hormone receptor (MCHR) by MCH induces the release of Ca⁺⁺ from intracellular stores. This intracellular calcium release is measured using a fluorometric imaging plate reader (FLIPR™, Molecular Devices Corp.) in conjunction with the Ca⁺⁺-sensitive dye Fluo-4. Release of Ca⁺⁺ from intracellular stores causes an increase in fluorescence of the dye that is proportional to Ca⁺⁺ concentration. In particular, the assay is carried out as follows: The cells are cultured in MEM/10% fetal bovine serum/50 μg/mL gentamicin/200 μg/ml Zeocin. The cells are plated at 100,000 cells/well in poly-D-lysine coated, 96 FLIPR™ assay plates (BD Biosciences, Bedford, Mass.). After two days, cells are loaded with the Calcium Assay Reagent for one hour at 37° C. Test compounds are prepared at 60 μM in 6% dimethyl sulfoxide. The cell plate is placed in the FLIPR™ and 50 μl/well of test compound is delivered. The calcium signal is followed for 3 minutes to assay for potential agonist activity by the test compounds. Then, 50 μl/well of 6 μM human MCH (in Dulbecco's phosphate-buffered saline (PBS) containing 0.1% bovine serum albumin (BSA)) is added and the ligand-induced calcium signal is followed for an additional 3 minutes. Antagonist activity, as determined by the test compound's ability to inhibit MCH-induced Ca⁺⁺ flux, is calculated as percent inhibition as described by the the formula % inhibition=[1−((fTC−−fB)/(fMCH−fB))]×100, whereby fTC=MCH-induced fluorescence in the presence of test compound; fMCH=MCH-induced fluorescence in the absence of test compound; and fB=baseline fluorescence.

MCH (100 nM) usually elicits a response of 9,000-11,000 relative fluorescence units (RFU) with a baseline of approximately 200 RFU. Calcium Assay Reagent fluorescence is measured at 488 nm, with an exposure of 0.40 sec. and F-stop=2.0 and the laser set at 0.20-0.40 W constant light output. It should be noted that both antagonists and inverse agonists would be expected to produce similar results in this assay. Both types of agent have been found to be useful therapeutically for inhibition of signaling by various GPCR's.

The compounds of the present invention inhibit MCH induced fluorescence at a dose of 10 μM. In a preferred range, compounds of the present invention inhibit MCH induced fluorescence in a range of 75-100% inhibition of MCH at a dose of 10 μM. In a more preferred range, compounds of the present invention inhibit MCH induced fluorescence in a range of 90-100% inhibition of MCH at a dose of 10 μM.

As antagonists of MCH action upon the MCH receptor, therefore, the compounds of the present invention are useful in treating disorders that are mediated by MCH through the MCH receptor. Disorders that are mediated by MCH through the MCH receptor are obesity, abnormalities in reproduction and sexual behavior, thyroid hormone secretion diuresis and water/electrolyte homeostasis, sensory processing, memory, sleeping and arousal, anxiety and depression, seizure and in treatment of neurodegeneration or psychiatric disorders. Therefore the compounds of the present invention are useful in treating obesity, abnormalities in reproduction and sexual behavior, thyroid hormone secretion, diuresis and water/electrolyte homeostasis, sensory processing, memory, sleeping and arousal, anxiety and depression, seizure and in treatment of neurodegeneration or psychiatric disorders.

Therapeutic agents acting through MCH receptor may also be useful in treatment of abnormalities in reproduction and sexual behavior (Murray, J. F.; Mercer J. G., Adan R. A., Datta J. J., Aldairy C, Moar K M, Baker B I, Stock M J, Wilson, C. A.; The effect of leptin on luteinizing hormone release is exerted in the zona incerta and mediated by melanin-concentrating hormone. J Neuroendocrinol 12:1133-1139, 2000.; Gonzalez, M. I., Baker, B. I., Wilson, C. A.; Stimulatory effect of melanin-concentrating hormone on luteinising hormone release. Neuroendocrinology 66:254-262, 1997.; Murray, J. F., Adan, R. A., Walker, R., Baker, B. I., Thody, A. J., Nijenhuis, W. A., Yukitake, J., Wilson, C. A.; Melanin-concentrating hormone, melanocortin receptors and regulation of luteinizing hormone release. J Neuroendocrinol 12:217-223, 2000.; Nahon, J. L.; The melanin-concentrating hormone: from the peptide to the gene. Crit Rev Neurobiol 8:221-262, 1994.)

Therapeutic agents acting through MCH receptor may also be useful in treatment of thyroid hormone secretion (Kennedy, A. R., Todd, J. F., Stanley, S. A., Abbott, C. R., Small, C. J., Ghatei, M. A., Bloom, S. R.; Melanin-concentrating hormone (MCH) suppresses thyroid stimulating hormone (TSH) release, in vivo and in vitro, via the hypothalamus and the pituitary. (Endocrinology 142:3265-3268. 2001).

Therapeutic agents acting through MCH receptor may also be useful in treatment of diuresis and water/electrolyte homeostasis (Hervieu, G., Volant, K., Grishina, O., Descroix-Vagne, M., Nahon, J. L.; Similarities in cellular expression and functions of melanin-concentrating hormone and atrial natriuretic factor in the rat digestive tract. Endocrinology 137:561-571, 1996.; and Parkes, D. G.; Diuretic and natriuretic actions of melanin concentrating hormone in conscious sheep. (J Neuroendocrinol 8:57-63, 1996).

Therapeutic agents acting through MCH receptor may also be useful in treatment of sensory processing (Miller, C. L., Hruby, V. J., Matsunaga, T. O., Bickford, P. C.; Alpha-MSH and MCH are functional antagonists in a CNS auditory gating paradigm. Peptides 14:431-440, 1993.; Kokkotou, E. G., Tritos, N. A., Mastaitis, J. W., Slieker, L., Maratos-Flier, E.; Melanin-concentrating hormone receptor is a target of leptin action in the mouse brain. (Endocrinology 142:680-686, 2001).

Therapeutic agents acting through MCH receptor may also be useful in treatment of memory (Monzon, M. E., De Barioglio, S. R.; Response to novelty after i.c.v. injection of melanin-concentrating hormone (MCH) in rats. (Physiol Behav 67:813-817, 1999).Therapeutic agents acting through MCH receptor may also be useful in treatment of sleeping and arousal (Bittencourt, J. C., Presse, F., Arias, C., Peto, C., Vaughan, J., Nahon, J. L., Vale, W., Sawchenko, P. E.; The melanin-concentrating hormone system of the rat brain: an immuno- and hybridization histochemical characterization. J Comp Neurol 319:218-245, 1992.; Nahon, J. L.; The melanin-concentrating hormone: from the peptide to the gene. (Crit Rev Neurobiol 8:221-262, 1994).

Therapeutic agents acting through MCH receptor may also be useful in treatment of anxiety and depression. (See, Monzon, M. E., Varas, M. M., De Barioglio, S. R.). (See also, Anxiogenesis induced by nitric oxide synthase inhibition and anxiolytic effect of melanin-concentrating hormone (MCH) in rat brain, Peptides 22:1043-1047, 2001). (See also, Monzon, M. E., De Barioglio. S. R; Response to novelty after i.c.v. injection of melanin-concentrating hormone (MCH) in rats, Physiol Behav 67:813-817, 1999). (See also, Borowsky, B., Durkin, M. M., Ogozalek, K., Marzabadi, M. R., DeLeon, J., Lagu, B., Heurich, R., Lichtblau, H., Shaposhnik, Z., Daniewska, I., Blackburn, T. P., Branchek, T. A., Gerald, C., Vaysse, P. J., Forray, C., Antidepressant, anxiolytic and anorectic effects of a melanin-concentrating hormone-1 receptor antagonist., Nat. Med. 8:825-830, 2002).

Therapeutic agents acting through MCH receptor may also be useful in treatment of seizure. (See, Knigge, K. M., Wagner, J. E., Melanin-concentrating hormone (MCH) involvement in pentylenetetrazole (PTZ)-induced seizure in rat and guinea pig, Peptides 18:1095-1097, 1997) and in the treatment of neurodegeneration or psychiatric disorders (See, Nahon, J. L., The melanin-concentrating hormone: From the peptide to the gene, Crit Rev Neurobiol 8:221-262, 1994).

Synthetic Methods

Abbreviations which have been used in the descriptions of the scheme and the examples that follow are: dba for dibenzylideneacetone; DMSO for dimethylsulfoxide; NMP for N-methylpyrrolidinone; DMF for N,N-dimethylformamide; DCC for 1,3-dicyclohexylcarbodiimide, DIC for 2-dimethylaminoisopropyl chloride hydrochloride, HATU for O-(7-azabenzotriazol-1-yl)-N, N, N′, N′-tetramethyluronium hexafluorophosphate, HBTU for O-benzotriazole-1-yl)-N, N, N′, N′-tetramethyluronium hexafluorophosphate, TFA for trifluoroacetic acid; THF for tetrahydrofuran; EDCI for 1-(3-dimethylaminopropyl)-3-ethylcarbodiimide hydrochloride; HOAt for 1-hydroxy-7-azabenzotriazoleand h OBt for 1-hydroxybenzotriazole hydrate.

The compounds and processes of the present invention will be better understood in connection with the following synthetic schemes and experimentals that together illustrate the methods by which the compounds of the invention may be prepared. The groups R_{b} R₂, R₃, R₄, R₅, R₆, R₇, R₈, R₉, R₁₀, R₁₁, R₁₂, X and L are as defined above unless otherwise noted below.

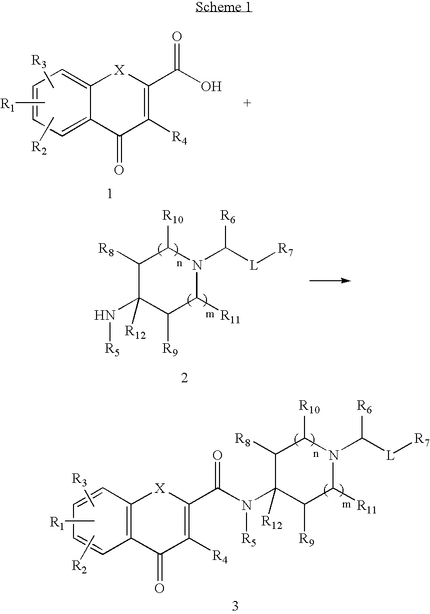

As shown in Scheme 1, compounds of formula 1 when treated with compounds of formula 2 and reagents that will couple amines to carboxylic acids such as EDCI, DCC, DIC, HATU, HBTU, an auxiliary nucleophile such as but not limited to HOBt and HOAt and a base such as but not limited to diisopropylethylamine, triethylamine, N-methylmorpholine in solvents such as but not limited to N,N-dimethylformamide and methylene chloride will provide the compound of formula 3 which are representative of the compounds of the present invention. Alternativly, compounds of formula 1 may be treated with oxalyl chloride in dichloromethane in the presence of a catalytic amount DMF followed by treatment with compounds of formula 2 in the presence of a base such as N-methylmorpholine in dichlormethane to provide compounds of formula 3.

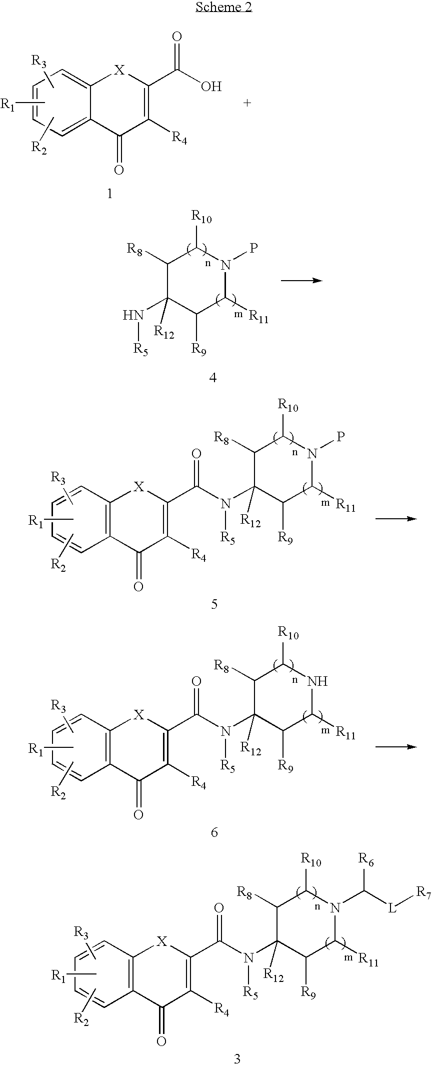

As shown in Scheme 2, compounds of formula 1 may be treated with compounds of formula 4 using the conditions outlined in Scheme 1 to provide compounds of formula 5. The symbol P of compound of formula 4 and 5 is a nitrogen protecting group such as but not limited to acetyl, tert-butyloxy carbonyl or benzyloxycarbonyl, or as described in Greene, T. W. and Wuts, G. M. “Protective groups in Organic Synthesis”, 3rd ed. John Wiley & Sons, 1999. The method of use of such protecting group and conditions decribing the removal of the group are also described in the abovementioned reference or may be known to one skilled in the art. Compounds of formula 5 may be deprotected using conditions described in the reference or as known to one skilled in the art to provide compounds of formula 6. Compounds of formula 6 may treated according to conditions as described in Scheme 3 or 4 to provide compounds of formula 3.

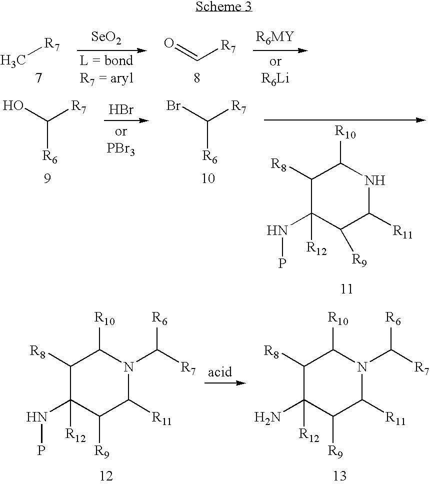

As shown in Scheme 3, compounds of formula 7 wherein R₇ is aryl, when treated with an oxidizing reagent such as but not limited to selenium dioxide will provide compounds of formula 8. Compounds of formula 8 when treated with organometallic reagents of formula R₆MgY or R₆Li, wherein Y is chloro or bromo and R₆ is defined within the scope of this invention, in solvents such as but not limited to THF will provide compounds of formula 9. Compounds of formula 9 when treated with hydrobromic acid or phosphorous tribromide will provide compounds of formula 10. Compounds of formula 10 when treated with an amine of formula 11 and a base such as but not limited to potassium carbonate in DMF or triethylamine under heated conditions in solvents such as THF will provide compounds of formula 12. The nitrogen protecting group (P), of the compound of formula 12 which may consist of a tert-butyloxycarbonyl, acetyl or benzyloxycarbonyl may be removed using conditions known to those skilled in the art or are described in the “Greene” reference listed above will provide compounds of formula 13. For example the deprotection of compounds of formula 12 which contain a tert-butyloxycarbonyl may be converted into a compound of formula 13 when treated with an acid such as trifluoroacetic acid in dichloromethane or hydrochloric acid in acetic acid. The compound of formula 13 may be coupled to the compound of formula 1 as described in Scheme 1 to provide compounds of formula 3 which are representative of the compounds of the present invention.

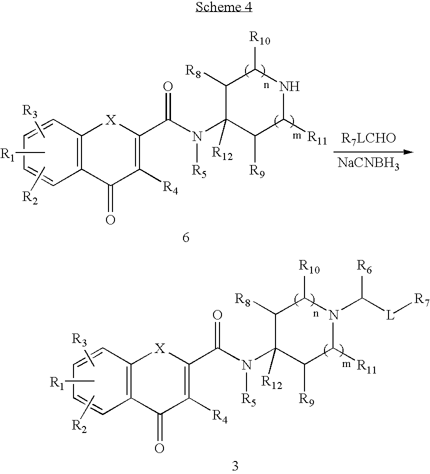

As shown in Scheme 4, compounds of formula 6 may also be treated with an aldehyde of formula R₇LCHO and a reducing agent such as but not limited to sodium cyanoborohydride in solvents such as but not limited to THF to provide compounds of formula 3. This reaction sequence enables one skilled in the art to generate compounds of the present invention without alkylation conditions as described in the previous Schemes.

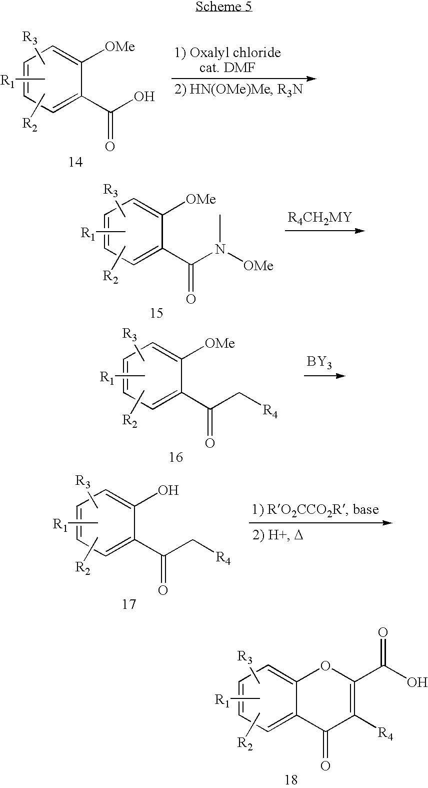

As shown in Scheme 5, compounds of formula 14 when treated with oxalyl chloride dichloromethane containing a catalytic amount of DMF followed by the addition of N-methyl O-methyl hydroxyl amine in the presence of a base such as but not limited to triethylamine will provide compounds of formula 15. Compounds of formula 15 when treated with reagents of formula R₄CH₂MgY wherein R₄ is defined above and Y is halogen will provide compounds of formula 16. Compounds of formula 16 when treated with reagents such as boron tribromide or aluminum trichloride in solvents such as but not limited to dichlromethane will provide compounds of formula 17. Compounds of formula 17 when treated with compounds of formula R′O₂CCO₂R′ and a base such as sodium methoxide in methanol followed by treatment with an acid such as hydrochloric acid or acetic acid and heat followed by hydrolysis will provide compounds of formula 18. Compounds of formula 18 may be subjected to the conditions described in Scheme 1 or Scheme 2 to provide compounds of the present invention.

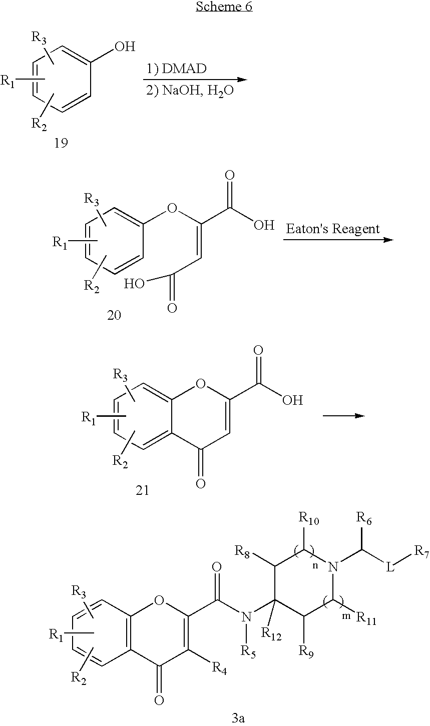

As shown in Scheme 6, compounds of formula 19 when treated dialkyl acetylenedicarboxylate under heated conditions followed by treatment with sodium hydroxide will provide compounds of formula 20. Compounds of formula 20 when treated with phosphorous pentoxide in methane sulfonic acid (Eaton's reagent) will provide compounds of formula 21. Compounds of formula 21 may be treated according to the conditions described in Scheme 1 or Scheme 2 to provide compounds of the formula 3a that are representative of compounds of the present invention which contain an oxygen in place of X.

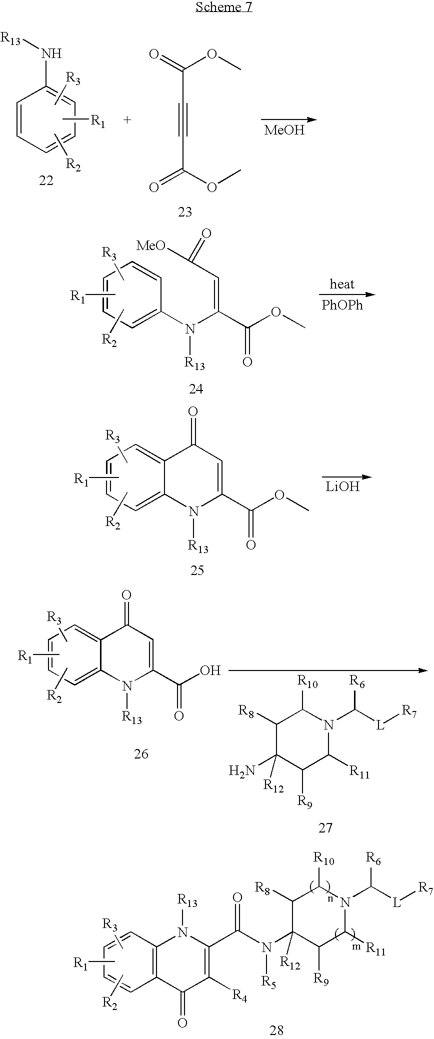

As shown in Scheme 7, compounds of formula 22 when treated with dimethyl acetylenedicarboxylate (compound of formula 23) in methanol will provide compounds of formula 24. Compounds of formula 24 when heated in solvents such as but not limited to phenyl ether will provide compounds of formula 25. Compounds of formula 25 when treated lithium hydroxide or sodium hydroxide in solvents such as but not limited to aqueous methanol or aqueous isopropanol will provide compounds of formula 26. Compounds of formula 26 when treated to conditions outlined in Scheme 1 or Scheme 2 will provide compounds of formula 28 which are representative of the compounds of the present invention.

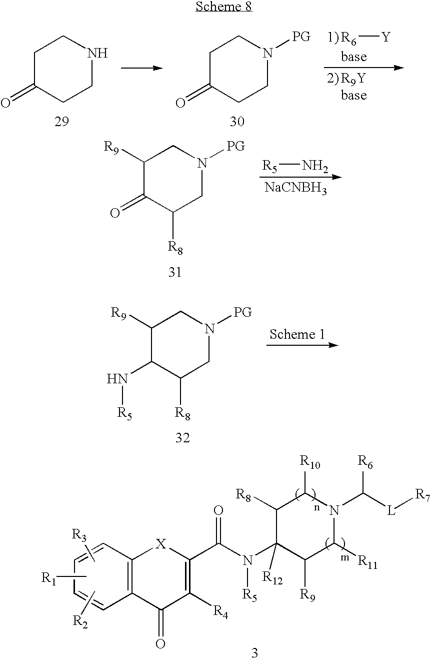

As shown in Scheme 8, compounds of formula 29 when first protected using a nitrogen protecting group as known to one skilled in the art or as descirbed in Greene, T. W. and Wuts, G. M. “Protective groups in Organic Synthesis”, 3rd ed. John Wiley & Sons, 1999 followed by sequential treatment with R₈Y and base such as but not limited to lithium diisopropylamine followed by R₉Y and base such as but not limited to lithium diisopropylamine, wherein R₈ and R₉ are defined within the scope of this invention will provide compounds of formula 31. Compounds of formula 31 when treated with an amine of formula R₅—NH₂ and a reduceing agent such as but not limited to sodium cyanoborohydride, sodium triacetoxyborohydride or Palladium on carbon and a hydrogen atmosphere in solvents such as but not limited to THF will provide compounds of formula 32. Compounds of formula 32 when subjected to the conditions outlined in Scheme 2 will provide compounds of formula 3 which are representative of the compounds of the present invention.

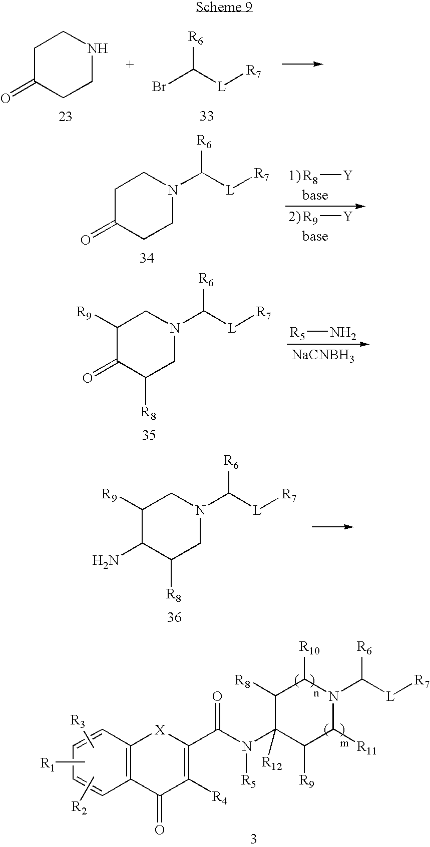

As shown in Scheme 9, compounds of formula 23 when treated with compounds of formula 33 and a base such as but not limited to triethylamine in solvents including THF will provide compounds of formula 34. Compounds of formula 34 when treated sequentially with R₈—Y and a base such as but not limited to lithium diisopropylamine followed by R₉—Y and a base such as but not limited to lithium diisopropylamine in solvents such as but not limited to THF, wherein R₈ and R₉ are defined with the scope of this invention and Y is a halogen will provide compounds of formula 35. Compounds of formula 35 when treated with reagents of formula R₅—NH₂ and a reducing agent such as but not limited to sodium cyanoborohydride will provide compounds of formula 36. Compounds of formula 36 when treated to conditions described in Scheme 1 will provide compounds of formula 3 which are representative of compounds of the present invention.

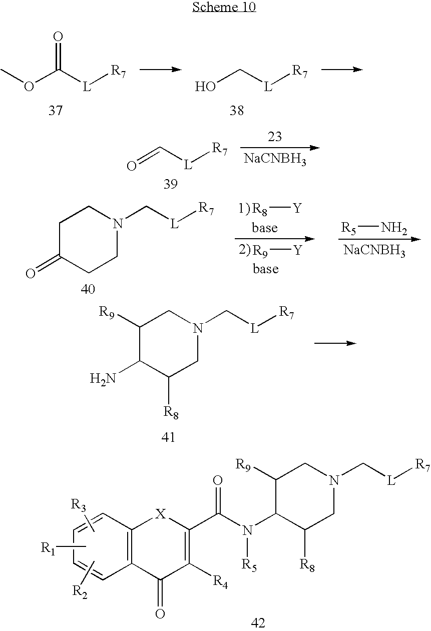

As shown in Scheme 10, compounds of formula 37 when subjected to reducing conditions such as but not limited to diisobutyl aluminum hydride will provide compounds of formula 38. Compounds of formula 38 when subjected to oxidative conditions as known to one skilled in the art or as described by the Swern reaction (oxalyl chloride in DMSO followed by the addition of triethylamine) will provide compounds of formula 39. Compounds of formula 39 when treated with compounds of formula 23 and a reducing agent such as but not limited to sodium cyanoborohydride will provide compounds of formula 40. Compounds of formula 40 when treated according to conditions outlined in Scheme 9 to introduce R₈ and R₉ followed by treatment with compounds of formula R₅—NH₂ and a reducing agent such as sodium cyanoborohydride or as described above will provide compounds of formula 41. Compounds of formula 41 when treated according to Scheme 1 will provide compounds of formula 42 which are representative of compounds of the present invention.

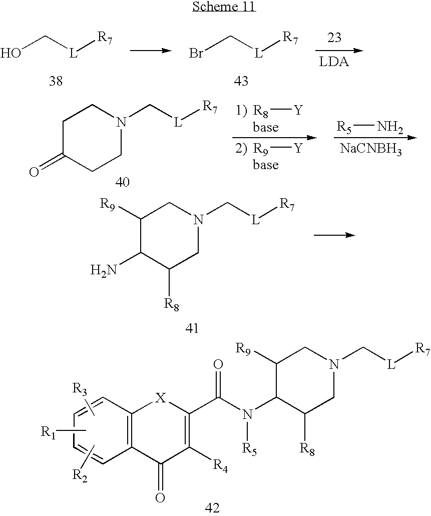

Alternatively, compounds of formula 38 may be treated with reagents such as hydrogen bromide or phosphorous tribromide to provide compounds of formula 43. Compounds of formula 43 when treated with compounds of formula 23 and a base such as but not limited to LDA will provide compounds of formula 40. Compounds of formula 40 may be subjected to the conditions outlined in Scheme 10 to introduce R₈ and R₉ followed by reductive amination to provide compounds of formula 41 which when treated according to conditions described in Scheme 1 will provide compounds of formula 42 which are representative of compounds of the present invention.

### EXPERIMENTALS

### Example 1

### N-[1-(1,3-benzodioxol-5-ylmethyl)piperidin-4-yl]-7-chloro-4-oxo-4H-chromene-2-carboxamide

### Example 1A

### 4-chloro-N,2-dimethoxy-N-methylbenzamide

To an oven-dried 250 mL round bottom flask containing 4-chloro-2-methoxybenzoic acid (5 g, 26.8 mmol), dichloromethane (95 mL), and DMF (0.25 mL) which was purged with nitrogen and cooled to 0° C. was added oxalyl chloride (13.4 mL, 26.8 mmol of a 2 M solution in dichloromethane). The mixture was stirred at 0° C. for 30 minutes and then allowed to warm to room temperature. After 1 hour at room temperature, the mixture was cooled to 0° C., and N,O-dimethylhydroxylamine hydrochloride (2.9 g, 29.5 mmol) was added followed by the addition of diisopropylethylamine (10.3 mL, 59.0 mmol). The mixture was allowed to warm to room temperature and stirred for 72 hours. The mixture was diluted with dichloromethane, washed with 1M aqueous HCl, 1M aqueous K₂CO₃, dried (Na₂SO₄), and concentrated to provide the title compound as a solid. ¹H NMR (300 MHz, DMSO-d₆) δ ppm 3.17 (s, 3 H), 3.47 (s, 3 H), 3.82 (m, 3 H), 7.04 (dd, J=8.14, 1.70 Hz, 1 H), 7.17 (d,J=1.70 Hz, 1 H), 7.25 (d, J=8.14 Hz, 1 H); MS (ESI) m/z 230 [M+H]⁺.

### Example 1B

### 1-(4-chloro-2-methoxyphenyl)ethanone

An oven-dried 100 mL round bottom flask containing Example 1A (1.25 g, 5.44 mmol) and dry THF (22 mL) was cooled to −78° C., and air was evacuated and replaced with nitrogen (3×). Methyl magnesium bromide (2.0 mL of a 3M solution in ethyl ether, 5.99 mmol) was added dropwise and after 30 minutes the cold bath was removed, and the reaction was allowed to warm to room temperature and stirred for 16 hours. To the mixture was diluted with 2M aqueous HCl followed by the addition of Ethyl acetate (50 mL). The separated organic layer was washed with distilled water (1×50 mL), washed with saturated aqueous NaHCO₃ (1×50 mL), washed with brine (1×50 mL), dried (MgSO₄), filtered, and concentrated to a residue that was purified by Flashmaster (20 gram cartridge, 0 to 100% Ethyl acetate in hexane over 35 minutes). ¹H NMR (300 MHz, DMSO-d₆) δ ppm 3.31 (s, 3 H), 3.92 (s, 3 H), 7.09 (dd,J=8.14, 1.70 Hz, 1 H), 7.27 (d, J=1.70 Hz, 1 H), 7.60 (d, J=8.14 Hz, 1 H); MS (APCI) m/z 185 [M+H]⁺.

### Example 1C

### 1-(4-chloro-2-hydroxyphenyl)ethanone

Boron tribromide (7.6 mL, 7.6 mmol of a 1M solution in dichloromethane) was added to Example 1B (0.7 g, 3.8 mmol) in dichloromethane (8 mL) at 0° C. The mixture was stirred cold for 1 hour, and was allowed to warm to room temperature for 0.5 hour. The solution was added carefully to 2N aqueous HCl (50 mL) and ice (50 g) and extracted with dichloromethane (2×50 mL). The combined organic layers were washed with saturated aqueous NaHCO₃ (2×50 mL), washed with brine (1×50 mL), dried (MgSO₄), filtered, and concentrated to a dark residue (485 mg) that was purified by Flashmaster (20 gram cartridge, 0 to 20% Ethyl acetate in hexane over 25 minutes.) The title compound was collected as a dark oil. ¹H NMR (300 MHz, DMSO-d₆) δ ppm 2.62 (s, 3 H), 7.03 (d,J=8.48 Hz, 1 H), 7.07 (d, J=2.37 Hz, 1 H), 7.89 (d, J=8.48 Hz, 1 H), 12.04 s, 1 H); MS (APCI) m/z 169 [M−H]⁺.

### Example 1D

### ethyl 7-chloro-4-oxo-4H-chromene-2-carboxylate

A mixture of Example 1C (469 mg, 2.75 mmol) and diethyl oxalate (1.90 mL, 13.8 mmol) was added to a stirred solution of sodium ethoxide (3.6 mL, 11.0 mmol of a 21% solution by weight in EtOH), and the mixture was warmed to 40° C. After 1 hour, the solution was cooled, filtered and the yellow solid was washed with ethyl ether. The organic layer was diluted with dichloromethane (50 mL), washed with 10% aqueous acetic acid and concentrated to a solid that was combined with glacial acetic acid (3 mL), hydrochloric acid (0.1 mL) and heated at 90° C. After 4 hours the dark solution was cooled, combined with distilled water (5 mL). The resulting white precipitate was collected by filtration and air-dried overnight. ¹H NMR (300 MHz, DMSO-d₆) δ ppm 1.35 (t, J=7.12 Hz, 3 H), 4.40 (q, J=7.12 Hz, 1 H), 6.98 (s, 1 H), 7.60 (dd, J=8.65, 1.86 Hz, 1 H), 8.00 (d, J=2.03 Hz, 1 H), 8.05 (d, J=8.48 Hz, 1 H); MS (APCI) m/z 253 [M+H]⁺.

### Example 1E

### 7-chloro-4-oxo-4H-chromene-2-carboxylic acid

6M Aqueous HCl (2 mL) was added to Example 1D in acetic acid (4 mL) and the mixture heated to 80° C. for 4.5 hours. The mixture was cooled to room temperature, diluted with distilled water (6 mL) and the resulting beige precipitate (204 mg, 89%) collected by filtration and dried under reduced pressure at 50° C. ¹H NMR (300 MHz, DMSO-d₆) δ ppm 6.92 (s, 1 H), 7.58 (dd, J=8.65, 1.86 Hz, 1 H), 7.95 (d, J=1.70 Hz, 1 H), 8.04 (d, J=8.48 Hz, 1 H); MS (APCI) m/z 225 [M+H]⁺, 224 [M−H]⁺, 178.9 [M−CO₂H]⁺.

### Example 1F

### tert-butyl 4-{[(7-chloro-4-oxo-4H-chromen-2-yl)carbonyl]amino}piperidine-1-carboxylate

Diisopropylethylamine (330 μL, 1.80 mmol) was added to a mixture of Example 1E (200 mg, 0.899 mmol), 4-amino-1-N-Boc-piperidine (190 mg, 0.944 mmol), 1-hydrobenzotriazole (152 mg, 1.12 mmol), 1-[3-(dimethylamino)propyl]-3-ethylcarbodiimide hydrochloride (215 mg, 1.12 mmol) in DMF (2.5 mL). The mixture was stirred for 16 hours, diluted with dichloromethane (40 mL), washed with 1N aqueous NaOH (2×40 mL), washed with 1N aqueous HCl (1×40 mL), washed with brine (1×40 mL), dried (MgSO₄), filtered, and concentrated to a dark solid. ¹H NMR (300 MHz, DMSO-d₆) δ ppm 1.40 (m, 9 H), 1.46 (m, 2 H), 1.78 (m, 2 H), 2.89 (m, 2 H), 3.99 (m, 3 H), 6.84 (s, 1 H), 7.59 (dd, J=8.82, 2.03 Hz, 1 H), 7.89 (d,J=1.70 Hz, 1 H), 8.05 (d, J=8.48 Hz, 1 H), 8.83 (d, J=8.14 Hz, 1 H); MS (APCI) m/z 351 [M-tBu]⁺, 307 [M-Boc]⁺, 405 [M−H]⁺.

### Example 1G

### 7-chloro-4-oxo-N-piperidin-4-yl-4H-chromene-2-carboxamide

Trifluoroacetic acid (2 mL) was added to a stirred solution of Example 1F (238 mg, 0.585 mmol) and dichloromethane (4 mL) at 0° C. After 1 hour, volatiles were removed and the resulting solid was diluted with 1N aqueous HCl (40 mL) and washed with ethyl ether (1×20 mL). The aqueous layer was combined with saturated aqueous K₂CO₃ until basic (pH=10), and extracted with Ethyl acetate (3×20 mL) and dichloromethane (2×20 mL). The combined organic layers were washed with brine (1×20 mL), dried (MgSO₄), filtered, and concentrated to provide the title compound. ¹H NMR (300 MHz, DMSO-d₆) δ ppm 1.83 (m, 2 H), 1.96 (m, 2 H), 3.00 (m, 2 H), 3.39 (m, 2 H), 4.09 (m, 1 H), 6.86 (s, 1 H), 7.59 (dd,J=8.81, 2.03 Hz, 1 H), 7.91 (d, J=2.03 Hz, 1 H), 8.04 (d, J=8.48 Hz, 1 H), 8.78 (s, 1 H), 9.06 (d,J=7.80 Hz, 1 H); MS (APCI) m/z 306.9 [M+H]⁺.

### Example 1

### N-[1-(1,3-benzodioxol-5-ylmethyl)piperidin-4-yl]-7-chloro-4-oxo-4H-chromene-2-carboxamide

Sodium triacetoxyborohydride (1.23 g, 5.82 mmol) was added to a slurry of Example 1G (1.19 g, 3.88 mmol), piperonal (583 mg, 3.88 mmol), sodium sulfate (1.10 g, 7.76 mmol), acetic acid (0.8 mL), and THF (40 mL) and the mixture stirred for 24 hours. Methanol (4 mL) was added to the mixture followed by the addition of dichloromethane (120 mL). The organic mixture was washed with 1N aqueous NaOH (3×100 mL), brine (1×100 mL), dried (MgSO₄), filtered, and concentrated to an residue that was purified by the Flashmaster (20 gram column, eluting 0 to 100% Ethyl acetate in hexane for 10 minutes, then 100% Ethyl acetate for 10 minutes). The title compound (345 mg, 20%) was collected as a white solid. ¹H NMR (300 MHz, DMSO-d₆) δ ppm 1.64 (m, 2 H), 1.78 (m, 2 H), 2.00 (m, 2 H), 2.83 (d, J=11.53 Hz, 2 H), 3.39 (s, 2 H), 3.78 (m, 1 H), 5.99 (s, 2 H), 6.75 (dd, J=7.97, 1.53 Hz, 1 H), 6.82 (s, 1 H), 6.85 (d, J=8.14 Hz, 2 H), 7.59 (dd, J=8.48, 2.03 Hz, 1 H), 7.91 (d, J=1.70 Hz, 1 H), 8.04 (d, J=8.82 Hz, 1 H), 8.81 (d, J=7.80 Hz, 1 H); MS (APCI) m/z 441 [M+H]⁺, 439 [M−H]⁺.

### Example 2

### N-[1-(1,3-benzodioxol-5-ylmethyl)piperidin-4-yl]-7-methoxy-4-oxo-4H-chromene-2-carboxamide

### Example 2A

### 7-methoxy-4-oxo-4H-chromene-2-carboxylic acid ethyl ester

To a solution of 7-hydroxy-4-oxo-4H-chromene-2-carboxylic acid ethyl ester (10 g, 42.7 mmol)in 90 mL of acetone under nitrogen was added K₂CO₃ (13 g, 93.8 mmol) followed by iodomethane (3.3 mL, 53.4 mmol) and the mixture heated to reflux for 19 hours. The mixture was allowed to cool to room temperature, 50 mL of ethyl acetate was added, the solid filtered off, rinsed with 1/1 ethyl acetate/acetone and air dried to provide the title compound. ¹H NMR (300 MHz, DMSO-D6) δ ppm 1.35 (t, J=7.12 Hz, 3 H) 3.93 (s, 3 H) 4.40 (q, J=7.12 Hz, 2 H) 6.90 (s, 1 H) 7.12 (dd, J=8.82, 2.37 Hz, 1 H) 7.24 (d, J=2.37 Hz, 1 H) 7.96 (d, J=8.82 Hz, 1 H) MS (ESI, MeOH/NH4OH) m/z 248 [M+].

### Example 2B

### 7-methoxy-4-oxo-4H-chromene-2-carboxylic acid

To a solution of Example 2A (7-methoxy-4-oxo-4H-chromene-2-carboxylic acid ethyl ester,10 g, 40 mmol) in 120 mL of THF and 40 ml of distilled water was added 3.4 g of lithium hydroxide hydrate and the mixture was stirred for 2 hours. The mixture was diluted by slow addition of 15 mL of 3M H₂SO₄ portionwise via pipet and the resulting solid was filtered off, washed with distilled water and air dried to provide the title compound. ¹H NMR (300 MHz, DMSO-D6) δ ppm 3.91 (s, 3 H) 6.84 (s, 1 H) 7.10 (dd, 1 H) 7.22 (d, 1 H) 7.95 (d, 1 H); MS (ESI, MeOH/NH4OH) m/z 220 [M+], 219 [M−].

### Example 2C

### 4-[(7-Methoxy-4-oxo-4H-chromene-2-carbonyl)-amino]-piperidine

To a solution of Example 2B (7-methoxy-4-oxo-4H-chromene-2-carboxylic acid, 7.5 g, 34 mmol) in 136 mL of dimethylformamide under an atmosphere of nitrogen was added 4-amino-1-BOC-piperidine (6.8 g, 34 mmol), hydroxybenzotriazole (4.6 g, 34 mmol), diisopropylethylamine (6.5 mL, 37.4 mmol), and then ethyldimthylaminocarbodiimide hydrochloride (6.8 g, 35.7 mmol). The mixture was stirred for 17 hours, diluted with ethyl acetate, washed sequentially with 25 ml portions of each 1M H₂SO4, 1M K2CO3, brine. The organic layer was dried (Na₂SO₄, filtered and concentrated under reduced pressure to provide 13 g of a brown residue. This residue dissolved in 90 mL dichloromethane, under an atmosphere of nitrogen was cooled to 0° C. followed by the addition of 45 mL of trifluoroacetic acid in three portions. The mixture was stirred for 15 minutes at 0° C. then allowed to warm to room temperature and stirred for 1.5 hours. The mixture was concentrated under reduced pressure to a brown oil which was dissolved in dichloromethane (300 mL) and washed with 1M K₂CO₃, aqueous extracted with dichloromethane/Methanol (95/5, 3×300 mL). The combined organic extracts were dried (Na₂SO₄), filtered and concentrated under reduced pressure to provide the title compound. ¹H NMR (300 MHz, DMSO-D6) δ ppm 1.51 (m, 2 H) 1.77 (m, 2 H) 2.55 (m, 2 H) 2.99 (m, 2 H) 3.83 (m, 1 H) 3.93 (s, 3 H) 6.76 (s, 1 H) 7.10 (dd, 3 H) 7.24 (d, 1 H) 7.95 (d, 1 H) 8.83 (d, 1 H); MS (ESI, MeOH/NH4OH) m/z 303 [M+H], 301 [M−H], 603 [2M−H].

### Example 2D

### N-[1-(1,3-benzodioxol-5-ylmethyl)piperidin-4-yl]-7-methoxy-4-oxo-4H-chromene-2-carboxamide

To a solution of Example 2C (7.5 d, 24.8 mmol) in 70 mL dichloromethane, 2 mL glacial acetic acid and 30 mL tetrahydrofuran was added piperonal (3.7 g, 24.8 mmol) followed by NaBH(OAc)₃ (10.6 g, 49.6 mmol). The mixture was stirred for 64 hours, diluted by slow addition of 1M K₂CO₃, diluted with 400 mL of dichloromethane, washed with additional 1M K₂CO₃. The combined aqueous extracts were backextracted with additional dichloromethane, and the combined organic extracts dried (Na₂SO₄), filtered and concentrated under reduced pressure to provide 11.1 g of orange foam. This foam was dissolved in a minimal amount of dichloromethane, placed on a 70 g Isolute silica gel column and eluted with 0 to 100% ethyl acetate in hexane (0 to 20 minutes), 100% ethyl acetate (20-35 minutes), 100% dichloromethane (35-40 minutes), 0 ramp to 5% methanol/dichloromethane (40-60 mintes), 5/95 methanol/dichloromethane (60-70 minutes) at 30 mL/minutes and 254 nM detection wavelength to provide the title compound. ¹H NMR (300 MHz, DMSO-D6) δ ppm 1.63 (m, 2 H) 1.80 (m, 2 H) 2.00 (m, 2 H) 2.85 (m, 2 H) 3.39 (bs, 2 H) 3.76 (m, 1 H) 3.93 (s, 3 H) 5.98 (s, 2 H) 6.73 (m, 2 H) 6.85 (m, 2 H) 7.10 (dd, 1 H) 7.24 (d, 1 H) 7.95 (d, 1 H) 8.83 (d, 1 H); MS (ESI, MeOH/NH4OH) m/z 437 [M+H], 459 [M+Na], 435[M−H].

### Example 3

### 7-methoxy-4-oxo-N-[1-(1-quinolin-6-ylethyl) piperidin-4-yl]-4H-chromene-2-carboxamide

### Example 3A

### Quinoline-6-carbaldehyde

A mixture of 6-methyl-quinoline (70.0 g, 0.489 mol) and pulverized selenium dioxide (56.4g, 0.513 mol) was stirred and heated to 150-155° C. for 24 hours after which the mixture was cooled to 55° C. followed by the addition of Ethyl acetate (125 mL). The mixture was stirred for 5-10 minutes after which the ethyl acetate solution was decanted and this procedure repeat 5 times. The combined ethyl acetate extracts were washed with 5% sodium bicarbonate solution (2×125 mL) and 15% sodium chloride solution (170 mL). Decolorizing carbon (25 g) was added and the mixture was filtered through celite that was washed with ethyl acetate (200 mL). The combined ethyl acetate solution was concentrated under reduced pressure to provide a residue which was re-crystallized from ethyl acetate and heptane to provide quinoline-6-carbaldehyde. ¹H NMR (400 MHz, CHLOROFORM-D) δ ppm 7.50 (dd, J=4.25, 8.37, 1 H), 8.18 (m, 2 H), 8.29 (dd, J=1.78, 8.37 Hz, 1 H), 8.33 (d, J=1.24, 1 H), 9.02 (dd, J=1.78, 4.25, 1 H), 10.17 (s, 1 H:) MS (DCI) 158 (M+H)⁺.

### Example 3B

### 1-Quinolin-6-yl-ethanol

To a stirred solution of quinoline-6-carbaldehyde (2.42 g, 15.4 mmol) in tetrahydrofuran (20 mL) at 2° C. was added a 3 M solution of methyl magnesium bromide in tetrahydrofuran (7.7 mL, 23.1 mmol) while maintaining an internal temperature of less than 12° C. The solution was stirred for 20 minutes after which saturated ammonium chloride (50 mL) was added followed by the addition of 15% ammonium chloride. The mixture was extracted with ethyl acetate (2×75 mL) and the combined ethyl acetate extracts were washed with 15% potassium carbonate, 7% sodium chloride, dried over sodium sulfate, filtered and concentrated to provide 1-quinolin-6-yl-ethanol. ¹H NMR (400 MHz, CHLOROFORM-D) δ ppm 1.58 (d, J=6.45 Hz, 3 H), 2.73 (s, 1 H) 5.09 (q, J=6.45 Hz, 1 H) 7.36 (dd, J=8.23, 4.25 Hz, 1 H) 7.70 (dd, J=8.78, 2.06 Hz, 1 H) 7.78 (d, J=1.92 Hz, 1 H) 8.04 (d, J=8.78 Hz, 1 H) 8.10 (dm, J=8.23 Hz, 1 H) 8.82 (dd, J=4.25, 1.78 Hz, 1 H); MS (ESI) 173 (M+H)⁺.

### Example 3C

### 6-(1-Bromo-ethyl)-quinoline hydrobromide salt

To 1-quinolin-6-yl-ethanol (2.00 g, 11.5 mmol) was added hydrogen bromide (25.3 mL of 30 wt. % solution in acetic acid, 127 mm) and the solution was heated to 50-60° C. for 5 hours. The mixture was cooled to ambient and purged with nitrogen. Toluene (30 mL) was added and the solution was concentrated under reduced pressure (repeat 2 ×). The solid obtained was dried under reduced pressure at 25° C. for 16 hours to provide 6-(1-bromo-ethyl)-quinoline hydrobromide salt. ¹H NMR (400 MHz, DMSO-D6) δ ppm 2.12 (d, J=6.86 Hz, 3 H), 5.78 (q, J=6.86 Hz, 1 H), 8.04 (dd, J=8.37, 5.08 Hz, 1 H), 8.24 (m, 2 H), 8.43 (s, 1 H), 9.06 (dd, J=8.30, 1.03 Hz, 1 H), 9.28 (dd, J=5.08, 1.51 Hz, 1 H); MS (ESI) 236 (M+H)⁺.

### Example 3

### 7-methoxy-4-oxo-N-[1-(1-quinolin-6-ylethyl) piperidin-4-yl]-4H-chromene-2-carboxamide

A solution of Example 2C (500 mg, 1.66 mmol) in 7 mL DMF was charged with quinoline bromide hydrobomide 3C (317 mg, 1.66 mmol) and K₂CO₃ (505 mg, 3.65 mmol). The mixture was stirred under nitrogen for 42 hours, diluted with dichloromethane, washed with distilled water, dried (Na₂SO₄), filtered and concentrated under reduced pressure to provide 1.17 g of a brown oil. Flash silica gel chromatography with dichloromethane and methanol as eluent provided the title compound. ¹H NMR (300 MHz, DMSO-D6) δ ppm 1.41 (d, 3 H) 1.67 (m, 2 H) 1.83 (m, 2 H) 2.07 (m, 2 H) 2.84 (m, 1 H) 3.02 (m, 1 H) 3.72 (m, 2 H) 3.91 (s, 3H) 6.74 (s, 1 H) 7.10 (dd, 1 H) 7.23 (d, 1 H) 7.51 (dd, 1 H) 7.79 (dd, 1 H) 7.86 (d, 1 H) 7.93 (d, 1 H) 7.99 (d, 1 H) 8.34 (m, 1 H) 8.80 (d, 1 H) 8.87 (dd, 1 H); MS (ESI, MeOH/NH4OH) m/z 458 [M+H], 480 [M+Na], 456 [M−H].

### Example 4

### 7-chloro-N-[1-(2,3-dihydro-1,4-benzodioxin-6-ylmethyl) piperidin-4-yl]-4-oxo-4H-chromene-2-carboxamide

Sodium triacetoxyborohydride (19 mg, 91.3 μmol) was added to a mixture of Example 1G (14 mg, 45.6 μmol), 1,4-benzodioxan-6-carbaldehyde (7.5 mg, 45.6 μmol), sodium sulfate (13 mg, 91 μmol), acetic acid (20 μL), and THF (1 mL). After 24 hours, methanol (0.2 mL) was added, and the mixture was diluted with Ethyl acetate (20 mL). The mixture was washed with 1N aqueous NaOH (1×20 mL), washed with brine (1×20 mL), dried (MgSO₄), filtered, and concentrated under reduced pressure. The residue was loaded on a 0.5 gram MP-TsOH cartridge, and the cartridge was washed with dichloromethane. Next, the cartridge was treated with 2M ammonia in methanol, and the filtrate was concentrated to a residue. Finally, the residue was loaded on a 1 gram sep pack (SiO₂), and elution with Ethyl acetate to provided the title compound as a solid. ¹H NMR (300 MHz, DMSO-d₆) δ ppm 1.65 (m, 2 H), 1.78 (m, 2 H), 2.00 (m, 2 H), 2.83 (m, 2 H), 3.36 (s, 2 H), 3.77 (m, 1 H), 4.22 (s, 4 H), 6.77 (m, 4 H), 7.59 (dd, J=8.65, 1.86 Hz, 1 H), 7.91 (d, J=2.03 Hz, 1 H), 8.04 (d, J=8.48 Hz, 1 H), 8.81 (d, J=7.80 Hz, 1 H);MS (APCI) m/z 457 [M+H]⁺, 453 [M−H]⁺.

### Example 6

### 7-methoxy-N-[1-(2-naphthylmethyl)piperidin-4-yl]-4-oxo-4H-chromene-2-carboxamide

A solution of Example 2C (30 mg, 0.1 mmol) in 1 mL of dichloromethane containing 2% acetic acid was charged with 2-napthaldehyde (15 mg, 0.1 mmol) followed by NaBH(OAc)₃ (42 mg, 0.2 mmol). The mixture was stirred for 18 hours followed by the addition of 250 uL 1M K₂CO₃, diluted with 2 mL dichloromethane, dried (Na₂SO₄), filtered through a plug of silica gel (1 g, SepPak), rinsed through with 95:5 dichloromethane:methanol and concentrated to provide the title compound. ¹H NMR (300 MHz, DMSO-D6) δ ppm 1.70 (m, 2 H) 1.81 (m, 2 H) 2.11 (m, 2 H) 2.89 (m, 2 H) 3.65 (s, 2 H) 3.79 (m, 1 H) 3.93 (s, 3 H) 6.76 (s, 1 H) 7.11 (dd, 1 H) 7.24 (d, 1 H) 7.50 (m, 3 H) 7.79 (m, 1 H) 7.91 (m, 4 H) 8.82 (d, 1 H); MS (ESI, MeOH/NH4OH) m/z 443 [M+H], 465 [M+Na], 441 [M−H], 477 [M+Cl].

### Example 7

### N-[1-(1,3-benzodioxol-5-ylmethyl)piperidin-4-yl]-6-fluoro-4-oxo-4H-chromene-2-carboxamide

### Example 7A

### 4-[(6-Fluoro-4-oxo-4H-chromene-2-carbonyl)-amino]piperidine-1-carboxylic acid tert-butyl ester

To a solution of 6-fluoro-4-oxo-4H-chromene-2-carboxylic acid (2.8 g, 12.5 mmol) and 4-amino-1-BOC-piperidine (2.5 g, 12.5 mmol) in 50 mL DMF was added hydroxybenzotriazole (1.7 g, 12.5 mmol) and ethyl(dimethylaminopropyl)carbodiimide hydrochloride (2.5 g, 13.1 mmol). The mixture was stirred under nitrogen for 22 hours, diluted with ethyl acetate, washed with 1M HCl, 1M K₂CO₃, brine, dried (Na₂SO₄), filtered and concentrated under reduced pressure to provide the title compound. ¹H NMR (300 MHz, DMSO-D6) δ ppm 1.42 (s, 9 H) 1.52 (m, 2 H) 1.81 (m, 2 H) 2.86 (m, 2 H) 3.99 (m, 3 H) 6.85 (s, 1 H) 7.83 (m, 3 H) 8.91 (d, 1 H); MS (ESI, MeOH/NH4OH) m/z 413 [M+Na], 389 [M−H], 425 [M+Cl].

### Example 7B

### 4-[(6-fluoro-4-oxo-4H-chromene-2-carbonyl)-amino]-piperidine

A solution of Example 7A (2.5 g, 6.4 mmol) in 18 mL of dichloromethane at 0° C. was treated with 9 mL of trifluoroacetic acid and the mixture stirred for 2 hours, concentrated to an orange oil which was diluted with 95/5 dichloromethane/Methanol, washed with 1M K₂CO₃. The combined aqueous extracted were back extracted with additional dichloromethane, and the combined organic extracts dried (Na₂SO₄), filtered, concentrated under reduced pressure to provide the title compound (1.4 g, 75%). ¹H NMR (300 MHz, DMSO-D6) δ ppm 1.56 (m, 2 H) 1.80 (m, 2 H) 2.63 (m, 2 H) 3.06 (m, 2 H) 3.87 (m, 1 H) 6.85 (s, 1 H) 7.87 (m, 3 H) 8.96 (m, 1 H); MS (ESI, MeOH/NH4OH) m/z 291 [M+H], 581 [2M+H], 603 [2M+H], 289 [M−H], 579 [2M−H].

### Example 7

### N-[1-(1,3-benzodioxol-5-ylmethyl)piperidin-4-yl]-6-fluoro-4-oxo-4H-chromene-2-carboxamide

To a solution of Example 7B (29 mg, 0.1 mmol) in 0.5 mL THF containing 2% acetic acid was added with piperonal (15 mg, 0.1 mmol), NaBH(OAc)₃ (42 mg, 0.2 mmol) and Na₂SO₄ (28 mg, 0.2 mmol). The mixture was stirred for 40 hours followed by the addition of 30 uL of 3M H₂SO₄, shaken for 5 minutes, then 750 uL of 1M K₂CO₃ was added, shaken 10 minutes, 2 mL 95/5 dichloromethane/Methanol was added followed by drying agent (Na₂SO₄), filtered through a plug of silica gel (2 g, SepPak), rinsed through with 95/5 dichloromethane/methanol and concentrated. Flash silica gel eluting with dichloromethane/Methanol to provide the title compound. ¹H NMR (300 MHz, DMSO-D6) δ ppm 1.64 (m, 2 H) 1.79 (m, 2 H) 1.99 (m, 2 H) 2.85 (m, 2 H) 3.39 (s, 2 H) 3.77 (m, 1 H) 5.97 (s, 1 H) 5.99 (s, 2 H) 6.75 (m, 2 H) 6.85 (m, 3 H) 7.74 (m, 1 H) 7.85 (m, 1 H) 8.88 (d, 1 H); MS (ESI, MeOH/NH4OH) m/z 425 [M+H], 423 [M−H], 459 [M+Cl].

### Example 8

### 7-chloro-N-{1-[(1-methyl-1H-indol-5-yl)methyl]piperidin-4-yl}-4-oxo-4H-chromene-2-carboxamide

Example 8 (1.2 mg, 6%) was made according to the procedure described in Example 4, substituting Example 17A, N-methylindole-5-carboxaldehyde (7.3 mg, 45.6 μmol), for 1,4-benzodioxan-6-carbaldehyde. ¹H NMR (300 MHz, DMSO-d₆) δ ppm 1.63 (m, 2 H), 1.77 (m, 2 H), 1.98 (m, 2 H), 2.86 (m, 2 H), 3.53 (s, 2 H), 3.76 (m, 1 H), 3.76 (s, 3 H), 6.36 (d,J=3.05 Hz, 1 H), 6.81 (m, 1 H), 7.11 (dd, J=8.48, 1.36 Hz, 1 H), 728 (d, J=3.05 Hz, 1 H), 7.36 (d, J=8.48 Hz, 1 H), 7.42 (s, 1 H), 7.58 (dd, J=8.82, 2.03 Hz, 1 H), 7.89 (d, J=1.70 Hz, 1 H), 8.03 (d, J=8.48 Hz, 1 H), 8.79 (d,J=7.80 Hz, 1 H); MS (APCI) m/z 450 [M−H]⁺.

### Example 9

### N-[1-(1,3-benzodioxol-5-ylmethyl)piperidin-4-yl]-6-chloro-7-methyl-4-oxo-4H-chromene-2-carboxamide

### Example 9A

### 1-(1,3-benzodioxol-5-ylmethyl)piperidin-4-amine

Acetic acid (2 mL) was added to a suspension of 4-Boc-aminopiperidine (5.0 g, 25.0 mmol), piperonal (3.75 g, 25.0 mmol), sodium sulfate (7.1 g, 50 mmol), and THF (100 mL). After 20 minutes sodium triacetoxyborohydride (10.6 g, 50.0 mmol) was added. After 16 hours, methanol (4 mL) was added and the mixture was stirred for 24 hours. The solution was diluted with dichloromethane (150 mL), washed with 1N aqueous NaOH (2×150 mL), washed with brine (1×100 mL), dried (MgSO₄), filtered, and concentrated under reduced pressure to provide a white solid (9.0 g) that was dissolved in dichloromethane (50 mL), cooled to 0° C., and combined with trifluoroacetic acid (25 mL). The mixture was stirred for 1 hour, concentrated under reduced preassure and the residue combined with 2M HCl in ethyl ether (30 mL) and ethyl ether (30 mL). The resulting white precipitate was collected by filtration and air-dried overnight to provide the title compound as the dihydrochloride salt. ¹H NMR (300 MHz, DMSO-d₆) δ ppm 1.94 (m, 2 H), 2.06 (m, 2 H), 2.95 (m, 2 H), 3.21 (m, 2 H), 3.40 (m, 1 H), 4.14 (d, J=5.42 Hz, 2 H), 6.07 (s, 2 H), 6.99 (m, 2 H), 7.24 (s, 1 H), 8.28 (s, 2 H); MS (APCI) m/z 235 [M+H]⁺.

### Example 9

### N-[1-(1,3-benzodioxol-5-ylmethyl)piperidin-4-yl]-6-chloro-7-methyl-4-oxo-4H-chromene-2-carboxamide

6-Chloro-7-methylchromone-2-carboxylic acid (63 mg, 0.263 mmol) and Example 9A (162 mg, 0.526 mmol) were subjected to the procedure outlined in Example 1F to provide a yellow residue (69 mg) that was recrystallized from hot acetonitrile to provide the title compound. ¹H NMR (300 MHz, DMSO-d₆) δ ppm 1.63 (m, 2 H), 1.76 (m, 2 H), 1.99 (m, 2 H), 2.82 (d, J=11.87 Hz, 2 H), 3.30 (s, 3 H), 3.38 (s, 2 H), 3.76 (m, J=7.80 Hz, 1 H), 5.98 (s, 2 H), 6.74 (m, 1 H), 6.81 (m, 2 H), 6.85 (s, 1 H), 7.79 (s, 1 H), 7.95 (s, 1 H), 8.85 (d, J=7.80 Hz, 1 H);MS (APCI) m/z 455 [M+H]⁺, 453 [M−H]⁺.

### Example 10

### N-[1-(1,3-benzodioxol-5-ylmethyl)piperidin-4-yl]-7-(difluoromethoxy)-4-oxo-4H-chromene-2-carboxamide

### Example 10A

### Ethyl 7-(difluoromethoxy)-4-oxo-4H-chromene-2-carboxylate

A solution of ethyl 7-hydroxy-4-oxo-4H-chromene-2-carboxylate (2.00 g, 4.27 mmol) in DMF (10 mL) at −78° C. was treated with liquid chlorodifluoromethane (10 mL) and K₂CO₃ (1.77 g, 12.82 mmol). The cold bath was removed, and the suspension was allowed to warm to ambient temperature and stir for 2 hours. The mixture was diluted with Ethyl acetate (100 mL) and water (100 mL), the layers were separated and the organic layer was washed with sat. NaHCO₃(50 mL), brine (50 mL), dried (Na₂SO₄), filtered and concentrated under reduced pressure. Purification by silica gel chromatography (20% Ethyl acetate/Hexanes) provided the title compound.)MS (DCI/NH₃) m/z 285 [M+H]⁺).

### Example 10B

### 7-(difluoromethoxy)-4-oxo-4H-chromene-2-carboxylic acid

To a solution of Example 10A (ethyl 7-(difluoromethoxy)-4-oxo-4H-chromene-2-carboxylate 0.5 g, 1.75 mmol) in 10 mL of THF and 3 mL of distilled water was added 0.155 g of lithium hydroxide hydrate and the resulting mixture was stirred for 0.5 hour. The mixture was diluted by slow addition of 1 mL of 1M H₂SO₄ and the resulting solid was filtered off, washed with distilled water and air dried to provide the title compound. MS (ESI, MeOH/NH4OH) m/z 256 [M⁺].

### Example 10

### N-[1-(1,3-benzodioxol-5-ylmethyl)piperidin-4-yl]-7-(difluoromethoxy)-4-oxo-4H-chromene-2-carboxamide

1-Benzo[1,3]dioxol-5-ylmethyl-piperidin-4-ylamine(Example 9A) and 7-(difluoromethoxy)-4-oxo-4H-chromene-2-carboxylic acid (Example 10) were processed according to the procedure described in Example 1F to provide the title compound. ¹H NMR (300 MHz, DMSO-D6) δ ppm 1.80 (m, 2 H), 2.07 (m, 2 H), 3.09 (m, 2 H), 3.43 (m, 2 H), 3.99 (m, 1 H), 4.22 (m, 2 H) 6.09 (s, 2 H) 6.85 (s, 1 H) 6.96 (m, 1H) 7.02 (dd, 1 H) 7.08 (d, 1 H) 7.35 (dd, 1 H) 7.50 (m, 1 H), 7.51 (t, 1 H), 8.10 (d, 1 H), 9.08 (d, 1 H); MS (ESI) m/z 473 [M+H]⁺.

### Example 11

### N-[1-(1,3-benzodioxol-5-ylmethyl)piperidin-4-yl]-7-chloro-3-methyl-4-oxo-4H-chromene-2-carboxamide

### Example 11a

### 1-(4-Chloro-2-hydroxy-phenyl)-propan-1-one

Ethyl magnesium bromide (1M solution in THF, 2.6 mL, 2.61 mmol) was added to a stirred solution of 4-chloro-2,N-dimethoxy-N-methyl-benzamide Example 1A (0.4 g, 1.74 mmol) in THF (4 mL) at 0° C. The mixture was allowed to warm up to 10° C. over 3 hours diluted by sequential drop wise addition of saturated aqueous NH₄Cl, 1N HCL and water. The mixture was extracted with ethyl acetate (3×25 mL) and the combined organic extracts washed with water, brine, dried (MgSO₄), filtered and concentrated under reduced pressure to clear oil.

Boron tribromide (1M solution in dichloromethane, 2.6 mmol, 2.6 mL) was added in portions to a 0° C. solution of the above oil (0.345 g, 1.74 mmol) in dichlormethane (5 mL) allowed to warm to ambient temperature over 15 hours and diluted with saturated aqueous. The mixture was extracted with dichloromethane (4×25 mL) and the organic extracts washed with saturated NaHCO₃, water, brine, dried (MgSO₄), filtered and concentrated under reduced pressure to provide an oil which crystallized on standing. ¹H NMR (300 MHz, DMSO-d₆) δ ppm 1.08 (t, J=7.12 Hz, 1 H), 3.08 (q,J=7.35 Hz, 1 H), 7.01 (dd, J=8.65, 2.20 Hz, 1 H), 7.06 (d, J=2.03 Hz, 1 H), 7.89 (d, J=8.48 Hz, 1 H), 12.03 (s, 1 H).

### Example 11b

### 7-Chloro-3-methyl-4-oxo-4H-chromene-2-carboxylic acid

Sodium ethoxide (21% solution in ethanol, 3 mL, 8.4 mmol) was added in portions to a solution of Example 11a (0.39 g, 2.1 mmol) in ethanol (2 mL) at ambient temperature followed by the addition of diethyl oxalate (1.4 mL, 10.5 mmol). The mixture was heated to reflux for 2 hours, at 50° C. for 12 hours and cooled to ambient temperature followed by the addition of 3N HCl. The mixture was extracted with ethyl acetate (3×40 mL), and the organic extracts dried (MgSO₄), filtered and concentrated to a thick paste. The paste was taken up in acetic acid (5 mL) and concentrated HCl (0.5 mL) and heated to reflux for 2 hours after which it was cooled to ambient temperature, diluted with water and extracted with ethyl acetate (3×30 mL). The combined organic extracts were washed with water, brine, dried (MgSO₄) and concentrated under reduced pressure to a black paste. The black paste and LiOH.H₂O (0.18 g, 4.2 mmol) were taken up in THF/H2O (3:1, 16 mL) and stirred at ambient temperature for 2 hours. The solvents were removed under reduced pressure, the residue diluted with water, acidified with 3N HCl (pH=2) and filtered. The filtrate was extracted with ethyl acetate (3×30 mL), the combined organic extracts were washed with water, brine, dried (MgSO₄), filtered and concentrated to provide the title compound. ¹H NMR (300 MHz, DMSO-d₆) δ ppm 2.22 (s, 3 H), 7.55 (dd, J=8.48, 2.03 Hz, 1 H), 7.88 (d, J=1.70 Hz, 1 H), 8.05 (d, J=8.48 Hz, 1 H).

### Example 11

### N-[1-(1,3-benzodioxol-5-ylmethyl)piperidin-4-yl]-7-chloro-3-methyl-4-oxo-4H-chromene-2-carboxamide

Oxalyl chloride (2M solution in dichloromethane, 0.1 mL, 0.19 mmol) was added drop wise to a solution of Example 11b (0.03 g, 0.12 mmol) in dichloromethane (2 mL) and DMF (0.1 mL) and the mixture was stirred at ambient temperature for 1 hour after which 1-benzo[1,3]dioxol-5-ylmethyl-piperidin-4-ylamine bis hydrochloride salt (0.038 g, 0.12 mmol) was added in a single portion to the mixture followed by the addition of Hunig's base (diisopropylethylamine) (0.065 mL, 0.37 mmol) and the resulting mixture stirred for 1 hour. The mixture was then diluted with water, extracted with ethyl acetate (4×25 mL), the combined organic extracts were washed with water, brine, dried (MgSO₄), filtered and concentrated under reduced pressure and purified on RP-HPLC to provide the title compound. ¹H NMR (500 MHz, DMSO-d₆) δ ppm 1.77 (m, 2 H), 2.07 (m, 5 H), 3.07 (s, 2 H), 3.99 (d, J=20.28 Hz, 1 H), 4.21 (s, 3 H), 6.08 (s, 2 H), 7.00 (m, 2 H), 7.08 (m, 1 H), 7.56 (dd, J=8.42, 1.87 Hz, 1 H), 7.88 (d, J=1.87 Hz, 1 H), 8.06 (d, J=8.42 Hz, 1 H), 9.04 (d, J=7.18 Hz, 1 H), 9.39 (s, 1 H); MS (ESI) m/e 567.3 (M−1+TFA)⁺.

### Example 12

### 7-chloro-4-oxo-N-[1-(1-quinolin-6-ylethyl)piperidin-4-yl]-4H-chromene-2-carboxamide

### Example 12A

### [1-(1-Quinolin-6-yl-ethyl)-piperidin-4-yl]-carbamic acid tert-butyl ester

To a mixture of 6-(1-bromo-ethyl)-quinoline hydrobromide salt (10.78 g, 34 mmol), 4-(N-Boc-amino)-piperidine (7.00 g, 35 mmol) and potassium carbonate (325 mesh, 14.08 g, 102 mmol) was added DMF (240 mL) and the mixture was stirred at ambient temperature for 17 hours. The mixture was diluted with water (750 mL) and extracted with ethyl acetate (2×250 mL). The combined ethyl acetate layers were washed with water (3×270 mL, 1×210 mL) and concentrated under reduced pressure. Ethyl acetate (60 mL) was added and the mixture concentrated to a solid (repeat 1 ×). The solid obtained was recrystallized from ethyl acetate (70 mL) to provide 8.71 g of [1-(1-quinolin-6-yl-ethyl)-piperidin-4-yl]-carbamic acid tert-butyl ester as a white solid. ¹H NMR (400 MHz, Chloroform-D²) δ ppm 1.43 (s, 9H; d, J=6.4 Hz, 3H, m, 2H), 1.83 (d, J=12.49 Hz, 1 H), 1.95 (d, J=12.35 Hz, 1 H), 2.10 (q,J=11.11 Hz, 2 H), 2.71 (d,J=12.76 Hz, 1 H), 2.99 (d, J=12.76 Hz, 1 H), 3.42 (bs, 1 H), 3.56 (q, J=6.40 Hz, 1 H), 4.41 (s, 1 H), 7.37 (dd, J=8.30, 4.19 Hz, 1 H), 7.66 (d, J=1.65 Hz, 1 H), 7.74 (dd, J=8.64, 1.92 Hz, 1 H), 8.04 (d,J=8.64 Hz, 1 H), 8.11 (dd, J=8.37, 1.37 Hz, 1 H), 8.86 (dd,J=4.19, 1.72 Hz, 1 H), MS (ESI) 356 (M+H)⁺.

### Example 12B

### 1-(1-quinolin-6-ylethyl)piperidin-4-amine

Trifluoroacetic acid (1 mL) was added to a mixture of Example 12A (180 mg, 0.506 mmol) and dichloromethane at 0° C. After 1 hour volatiles were removed under reduced pressure, and the resulting residue taken up in 2M ethereal HCl (1 mL). The white precipitate formed and was collected by filtration. ¹H NMR (300 MHz, DMSO-d₆) δ ppm 1.82 (d,J=6.44 Hz, 3 H) 2.00 (m, 2 H) 2.12 (s, 2 H) 2.89 (m, J=15.60 Hz, 2 H) 3.22 (m, 2 H) 3.53 (m, 1 H) 3.77 (m, 1 H) 4.71 (m, 1 H) 7.80 (dd, J=8.31, 4.58 Hz, 1 H) 8.26 (m, 3 H) 8.66 (d, J=8.14 Hz, 1 H) 9.12 (d,J=4.41 Hz, 1 H) 11.37 (s, 1 H); MS (APCI) m/z 256 [M+H]⁺.

### Example 12

### 7-chloro-4-oxo-N-[1-(1-quinolin-6-ylethyl)piperidin-4-yl]-4H-chromene-2-carboxamide

Example 1E (112 mg, 0.50 mmol) was combined with Example 12B (0.50 mmol) and processed according to the procedure of Example 9 to provide the title compound. ¹H NMR (300 MHz, DMSO-d₆) δ ppm 1.40 (d, J=6.78 Hz, 3 H), 1.62 (m, 2 H), 1.80 (m, 2 H), 2.06 (m, 2 H), 2.81 (m, 1 H), 2.99 (m, 1 H), 3.71 (m, J=6.44 Hz, 2 H), 6.80 (s, 1 H), 7.51 (dd,J=8.31, 4.24 Hz, 1 H), 7.58 (dd, J=8.48, 2.03 Hz, 1 H), 7.79 (dd, J=8.82, 2.03 Hz, 1 H), 7.85 (d,J=1.70 Hz, 1 H), 7.89 (d, J=1.70 Hz, 1 H), 7.98 (d, J=8.48 Hz, 1 H), 8.03 (d, J=8.48 Hz, 1 H), 8.33 (d, J=7.46 Hz, 1 H), 8.79 (d,J=8.14 Hz, 1 H), 8.85 (dd, J=4.07, 1.70 Hz, 1 H); MS (APCI) m/z 462 [M+H]⁺, 460 [M−H]⁺.

### Example 14

### N-[1-(1H-indol-5-ylmethyl)piperidin-4-yl]-7-methoxy-4-oxo-4H-chromene-2-carboxamide

A solution of Example 2C (30 mg, 0.1 mmol) in 1 mL of dichloromethane containing 2% acetic acid was charged with indole-5-carboxaldehyde (14 mg, 0.1 mmol) followed by NaBH(OAc)₃ (42 mg, 0.2 mmol). The mixture was stirred for 18 hours then diluted by the addition of 250 uL 1M K₂CO₃, diluted with 2 mL dichloromethane, dried (Na₂SO₄), filtered through a plug of silica gel (1 g, SepPak), rinsed through with 95:5 dichlormethane:methanol and concentrated to provide the title compound. ¹H NMR (300 MHz, DMSO-D6) δ ppm 1.65 (m, 2 H) 1.79 (m, 2 H) 2.03 (m, 2 H) 2.88 (m, 2 H) 3.53 (s, 2H) 3.77 (m, 1 H) 3.93 (s, 3 H) 6.74 (s, 1 H) 7.04 (d, 1 H) 7.11 (dd, 1 H) 7.23 (d, 1 H) 7.32 (m, 2 H) 7.45 (d, 1 H) 7.93 (m, 2 H) 8.81 (d, 1 H) 11.1 (s, 1H); MS (ESI, MeOH/NH4OH) m/z 432 [M+H], 454 [M+Na], 430 [M−H].

### Example 15

### N-[1-(2,3-dihydro-1,4-benzodioxin-6-ylmethyl)piperidin-4-yl]-7-methoxy-4-oxo-4H-chromene-2-carboxamide

A solution of Example 2C (60 mg, 0.2 mmol) in 1 mL of 95/4 dichloromethane/methanol containing 2% acetic acid was charged with 1,4-benzodioxan-6-carboxaldehyde (33 mg, 0.2 mmol) followed by NaBH(OAc)₃ (84 mg, 0.4 mmol) and Na₂SO₄ (56 mg. 0.4 mmol). The reaction was stirred for 22 hours then additional 1,4-benzodioxan-6-carboxaldehyde (33 mg, 0.2 mmol) and NaBH(OAc)3 (84 mg, 0.4 mmol) added. Stirred another 24 hours and then quenched by addition of 1M K₂CO₃, shaken for 30 minutes, diluted with 95/5 dichloromethane/methanol, the bottom organic layer pipeted onto a silica gel plug (2 g, SepPak), rinsed with 90/10 dichloromethane/methanol and concentrated. The resultant yellow residue was purified by flash silica gel chromatography using dichloromethane/methanol as eluent to provide the title compound. ¹H NMR (300 MHz, DMSO-D6) δ ppm 1.65 (m, 2 H) 1.77 (m, 2 H) 1.99 (m, 2 H) 2.81 (m, 2 H) 3.37 (m, 2 H) 3.76 (m, 1 H) 3.93 (s, 3 H) 4.22 (s, 4 H) 6.76 (m, 4 H) 7.11 (dd, J=8.81, 2.37 Hz, 1 H) 7.23 (d, J=2.37 Hz, 1 H) 7.94 (d, J=8.81 Hz, 1 H) 8.81 (d, J=8.14 Hz, 1 H); MS (ESI, MeOH/NH4OH) m/z 451 [M+H], 473 [M+Na], 449 [M−H].

### Example 16

### N-{1-[(2,2-difluoro-1,3-benzodioxol-5-yl)methyl]piperidin-4-yl}-7-methoxy-4-oxo-4H-chromene-2-carboxamide

A solution of Example 2C (30 mg, 0.1 mmmol) in 1 mL of dichloromethane containing 2% acetic acid was charged with 2,2-difluoro-1,3-benzodioxole-5-carboxaldehyde (18 mg, 0.1 mmol) followed by NaBH(OAc)₃ (42 mg, 0.2 mmol). The reaction was stirred for 18 hours then quenched by addition of 250 uL 1M K₂CO₃, diluted with 2 mL dichloromethane, dried (Na₂SO₄), filtered through a plug of silica gel (1 g, SepPak), rinsed through with 95:5 dichloromethane/methanol and concentrated to provide the title compound. ¹H NMR (300 MHz, DMSO-D6) δ ppm 1.68 (m, 2 H) 1.78 (m, 2 H) 2.06 (m, 2 H) 2.84 (m, 2 H) 3.51 (s, 2 H) 3.78 (m, 1 H) 3.93 (s, 3 H) 6.75 (s, 1 H) 7.13 (m, 2 H) 7.23 (d,J=2.37 Hz, 1 H) 7.34 (m, 2 H) 7.95 (d, 1 H) 8.82 (d, J=8.14 Hz, 1 H); MS (ESI, MeOH/NH4OH) m/z 473 [M+H], 495 [M+Na], 471 [M−H].

### Example 17

### 7-methoxy-N-{1-[(1-methyl-1H-indol-5-yl)methyl]piperidin-4-yl}-4-oxo-4H-chromene-2-carboxamide

### Example 17A

### 1-methyl-5-carboxaldehyde-indole

A solution of indole-5-carboaldehyde (2.2 g, 15.2 mmol) in 60 mL DMF at 0° C. was charged with NaH (60% dispersion on mineral oil, 760 mg, 19 mmol) portionwise. Initial gas evolved. The solution was stirred 30 minutes after which iodomethane (1 mL, 2.27 g, 16 mmd) was added via syringe. After 1 hour 15 minutes, quenched by slow addition of distilled water (gas evolution). After gas evolution ceased, 200 mL of distilled water added, beige precipitate filtered off and dried in a vacuum oven to provide the title compound. ¹H NMR (300 MHz, BENZENE-D₆) δ ppm 3.86 (s, 3 H) 6.67 (d, J=3.39 Hz, 1 H) 7.50 (d, J=3.05 Hz, 1 H) 7.61 (d, J=8.48 Hz, 1 H) 7.69 (m, 1 H) 8.18 (s, 1 H) 9.98 (s, 1 H); MS (ESI, MeOH/NH4OH) m/z 160 [M+H], 177 [M+NH4].

### Example 17B

### 7-methoxy-N-{1-[(1-methyl-1H-indol-5-yl)methyl]piperidin-4-yl}-4-oxo-4H-chromene-2-carboxamide

A solution of Example 2C (60 mg, 0.2 mmol) in 1 mL of 95/4 dichloromethane/methanol containing 2% acetic acid was charged with Example 17A (32 mg, 0.2 mmol) followed by NaBH(OAc)₃ (84 mg, 0.4 mmol) and Na2SO4 (56 mg. 0.4 mmol). The reaction was stirred for 22 hours then additional 1,4-benzodioxan-6-carboxaldehyde (33 mg, 0.2 mmol) and NaBH(OAc)₃ (84 mg, 0.4 mmol) added. Stirred another 24 hours and then quenched by addition of 1M K₂CO₃, shaken for 30 minutes, diluted with 95/5 dichloromethane/methanol, bottom organic layer pipeted onto a silica gel plug (2 g, SepPak), rinsed with 90/10 dichloromethane/methanol and concentrated. The resultant yellow residue was purified by flash silica gel chromatography using dichloromethane/methanol as eluent to provide the title compound. ¹H NMR (300 MHz, DMSO-D6) δ ppm 1.66 (m, 2 H) 1.77 (m, 2 H) 2.02 (m, 2 H) 2.87 (m, 2 H) 3.54 (s, 2 H) 3.77 (s, 3 H) 3.8 (m, 1H) 3.93 (s, 3 H) 6.37 (d, J=2.71 Hz, 1 H) 6.75 (s, 1 H) 7.11 (m, 2 H) 7.22 (d, 1H) 7.29 (d, J=3.05 Hz, 1 H) 7.37 (d, J=8.14 Hz, 1 H) 7.44 (s, 1 H) 7.94 (d, J=9.15 Hz, 1 H) 8.80 ) d, J=7.80 Hz, 1 H); MS (ESI, MeOH/NH4OH) m/z 446 [M+H], 468 [M+Na], 444 [M−H].

### Example 18

### N-[1-(1,3-benzodioxol-5-ylmethyl)piperidin-4-yl]-8-chloro-7-methoxy-4-oxo-4H-chromene-2-carboxamide

### Example 18A

### 8-chloro-7-methoxy-4-oxo-4H-chromene-2-carboxylic acid

To a stirred suspension of 7-methoxy-4-oxo-4H-chromene-2-carboxylic acid (0.10 g, 0.455 mmol) in acetic acid (1.5 ml) at room temperature was added N-chlorosuccinimide (63 mg. 0.477 mmol), and the reaction was heated to 85 C for 6 hours. The heating bath was removed, and upon reaching room temperature the reaction was diluted with H₂O (2 mL). The solid was filtered and air-dried to yield 8-chloro-7-methoxy-4-oxo-4H-chromene-2-carboxylic acid as a white solid. ¹H NMR (300 MHz, DMSO-d₆) δ ppm 4.04 (s, 3 H), 6.89 (s, 1 H), 7.42 (d, J=9.16 Hz, 1 H), and 8.01 (d, J=8.82 Hz, 1 H).

### Example 18

### N-[1-(1,3-benzodioxol-5-ylmethyl)piperidin-4-yl]-8-chloro-7-methoxy-4-oxo-4H-chromene-2-carboxamide

To a stirred solution of 8-chloro-7-methoxy-4-oxo-4H-chromene-2-carboxylic acid (20 mg, 0.078 mmol), 1-benzo[1,3]dioxol-5-ylmethyl-piperidin-4-ylamine bis-hydrochloride salt (23 mg, 0.075 mmol), NMM (0.041 mL, 0.38 mmol), and HOBt (13 mg, 0.094 mmol) in DMF (1 mL) was added EDCI (18 mg, 0.094 mmol). The reaction was heated to 55 C for 12 hours, and concentrated under reduced pressure. Purification of the residue by RP-HPLC gave 8-chloro-7-methoxy-4-oxo-4H-chromene-2-carboxylic acid 1-(benzo[1,3]dioxol-5-ylmethyl-piperidin-4-yl)-amide as a solid. ¹H NMR (300 MHz, DMSO-d₆) δ ppm 1.81 (s, 2 H), 2.08 (m, J=8.82 Hz, 2 H), 2.73 (m, 2 H), 3.09 (m, 2 H), 3.95 (m, 1 H), 4.04 (m, 3 H), 4.21 (d, J=4.75 Hz, 2 H), 6.09 (s, 2 H), 6.87 (m, 1 H), 7.02 (m, 3 H), 7.43 (d, J=9.00 Hz, 1 H), 8.02 (d, J=9.00 Hz, 1 H), and 8.80 (d, J=7.46 Hz, 1 H). MS (ESI) m/z 471 [M+H]⁺.

### Example 19

### N-[1-(3-fluoro-4-methoxybenzyl)piperidin-4-yl]-7-methoxy-4-oxo-4H-chromene-2-carboxamide

A solution of Example 2C (60 mg, 0.2 mmol) in 1 mL of 95/4 dichloromethane/methanol containing 2% acetic acid was charged with 3-fluoro-4-methoxybenzaldehyde (31 mg, 0.2 mmol) followed by NaBH(OAc)₃ (84 mg, 0.4 mmol) and Na₂SO₄ (56 mg. 0.4 mmol). The reaction was stirred for 22 hours then additional 1,4-benzodioxan-6-carboxaldehyde (33 mg, 0.2 mmol) and NaBH(OAc)3 (84 mg, 0.4 mmol) added. The mixture was stirred 24 hours and then diluted by addition of 1M K₂CO₃, shaken for 30 minutes, diluted with 95/5 dichloromethane/methanol, bottom organic layer pipeted onto a silica gel plug (2 g, SepPak), rinsed with 90/10 dichloromethane/methanol and concentrated. The resultant yellow residue was purified by flash silica gel chromatography using dichloromethane/methanol as eluent to provide the title compound. ¹H NMR (300 MHz, DMSO-D6) δ ppm 1.65 (m, 2 H) 1.78 (m, 2 H) 2.02 (m, 2 H) 2.83 (m, 2 H) 3.42 (s, 2 H) 3.76 (m, 1 H) 3.82 (s, 3 H) 3.93 (s, 3 H) 6.75 (s, 1 H) 7.11 (m, 4 H) 7.23 (d, J=2.37 Hz, 1 H) 7.94 (d, J=8.81 Hz, 1 H) 8.81 (d, J=8.14 Hz, 1 H); MS (ESI, MeOH/NH4OH) m/z 441 [M+H], 463 [M+Na], 439 [M−H].

### Example 20

### N-[1-(4-chlorobenzyl)piperidin-4-yl]-7-methoxy-4-oxo-4H-chromene-2-carboxamide

A solution of Example 2C (60 mg, 0.2 mmol) in 1 mL of 95/5 dichloromethane/methanol containing 2% acetic acid was charged with 4-chlorobenzaldehyde (28 mg, 0.2 mmol) followed by NaBH(OAc)₃ (84 mg, 0.4 mmol) and Na₂SO₄ (56 mg. 0.4 mmol). The mixture was stirred for 22 hours then additional 1,4-benzodioxan-6-carboxaldehyde (33 mg, 0.2 mmol) and NaBH(OAc)₃ (84 mg, 0.4 mmol) added. The mixture was stirred for 24 hours and then diluted by addition of 1M K₂CO₃, shaken for 30 minutes, diluted with 95/5 dichloromethane/methanol, bottom organic layer pipeted onto a silica gel plug (2 g, SepPak), rinsed with 90/10 dichloromethane/methanol and concentrated. The resultant yellow residue was purified by flash silica gel chromatography using dichloromethane/methanol as eluent to provide the title compound. ¹H NMR (300 MHz, DMSO-D6) δ ppm 1.67 (m, 2 H) 1.80 (m, 2 H) 2.05 (m, 2 H) 2.83 (m, 2 H) 3.48 (s, 2 H) 3.79 (m, 1 H) 3.93 (s, 3 H) 6.75 (s, 1 H) 7.11 (dd, J=8.81, 2.37 Hz, 1 H) 7.23 (d, J=2.37 Hz, 1 H) 7.36 (m, 4 H) 7.94 (d, J=8.81 Hz, 1 H) 8.81 (d, J=7.80 Hz, 1 H); MS (ESI, MeOH/NH4OH) m/z 427 [M+H], 449 [M+Na], 425 [M−H].

### Example 21

### N-[1-(3-bromobenzyl)piperidin-4-yl]-7-methoxy-4-oxo-4H-chromene-2-carboxamide

To a solution of Example 2C (30 mg, 0.1 mmol) in 1 mL of dichlcromethane containing 2% acetic acid was added with 3-bromobenzaldehyde (18 mg, 0.1 mmol) followed by NaBH(OAc)₃ (42 mg, 0.2 mmol) and the mixture was stirred for 18 hours. 250 uL of 1 MK₂CO₃ was added and the mixture was diluted with 2 mL dichloromethane which was dried (Na₂SO₄), filtered through a plug of silica gel (1 g, SepPak), rinsed through with 95:5 dichloromethane:methanol and concentrated to provide the title compound. ¹H NMR (300 MHz, DMSO-D6) δ ppm 1.65 (m, 2 H) 1.79 (m, 2 H) 2.07 (m, 2 H) 2.81 (m, 2 H) 3.50 (s, 2 H), 3.8 (m, 1 H), 3.93 (s, 3 H) 6.75 (s, 1 H) 7.11 (dd, J=8.81, 2.37 Hz, 1 H) 7.23 (d, J=2.37 Hz, 1 H) 7.30 (m, 2 H) 7.44 (m, 1 H) 7.52 (m, 1 H) 7.95 (d,J=8.82 Hz, 1 H) 8.82 (d, 1 H); MS (ESI, MeOH/NH4OH) m/z 473 [M+H], 495 [M+Na].

### Example 22

### 6-fluoro-N-{1-[(1-methyl-1H-indol-5-yl)methyl]piperidin-4-yl}-4-oxo-4H-chromene-2-carboxamide

To a solution of Example 7B (29 mg, 0.1 mmol) in 0.5 mL THF containing 2% acetic acid was added Example 17A (16 mg, 0.1 mmol), NaBH(OAc)₃ (42 mg, 0.2 mmol) and Na₂SO₄ (28 mg, 0.2 mmol). After 40 hours, the mixture was quenched by addition of 30 uL of 3M H₂SO₄, shaken for 5 minutes, then 750 uL of 1M K₂CO₃ was added, shaken 10 minutes, 2 mL 95/5 dichloromethane/methanol was added followed by drying agent (Na₂SO₄), filtered through a plug of silica gel (2 g, SepPak), rinsed through with 95/5 dichloromethane/methanol and concentrated under reduced pressure. Flash silica gel eluting with dichloromethane/methanol provided the title compound. ¹H NMR (300 MHz, DMSO-D6) δ ppm 1.66 (m, 2 H) 1.77 (m, 2 H) 2.00 (m, 2 H) 2.89 (m, 2 H) 3.54 (s, 2 H) 3.77 (m, 4 H) 6.37 (d, J=3.05 Hz, 1 H) 6.83 (s, 1 H) 7.11 (dd, J=8.48, 1.70 Hz, 1 H) 7.29 (d, J=3.05 Hz, 1 H) 7.41 (m, 2 H) 7.72 (m, 1 H) 7.84 (m, 2 H) 8.87 (d, J=7.80 Hz, 1 H); MS (ESI, MeOH/NH4OH) m/z 434 [M+H], 432 [M−H].

### Example 23

### 7-chloro-N-[1-(3-fluoro-4-methoxybenzyl)piperidin-4-yl]-4-oxo-4H-chromene-2-carboxamide

Example 23 (5.4 mg, 27%) was made according to the procedure described in Example 4, substituting 3-fluoro-4-methoxybenzaldehyde (7.0 mg, 45.6 μmol) for 1,4-benzodioxan-6-carbaldehyde. ¹H NMR (300 MHz, DMSO-d₆) δ ppm 1.65 (m, 2 H), 1.79 (m, 2 H), 2.03 (m, 2 H), 2.82 (m, 2 H), 3.42 (s, 2 H), 3.78 (m, 1 H), 3.82 (s, 3 H), 6.82 (s, 1 H), 7.11 (m, 3 H), 7.59 (dd, J=8.82, 2.03 Hz, 1 H), 7.90 (d, J=2.03 Hz, 1 H), 8.04 (d, J=8.48 Hz, 1 H), 8.81 (d, J=7.80 Hz, 1 H); MS (APCI) m/z 445 [M+H]⁺, 443 [M−H]⁺.

### Example 24

### N-{1-[(2,2-difluoro-1,3-benzodioxol-5-yl)methyl]piperidin-4-yl}-7-(difluoromethoxy)-4-oxo-4H-chromene-2-carboxamide

Example 24 was prepared according to the procedure described in Example 10, substituting 1-[(2,2-difluoro-1,3-benzodioxol-5-yl)methyl]piperidin-4-ylamine for 1-benzo[1,3]dioxol-5-ylmethyl-piperidin-4-ylamine. ¹H NMR (300 MHz, DMSO-D6) δ ppm 1.84 (m, 2 H), 2.08 (m, 2 H), 3.09 (m, 2 H), 3.48 (m, 2 H), 3.99 (m, 1 H), 4.33 (m, 2 H), 6.85 (s, 1 H) 7.35 (m, 2 H), 7.51 (m, 2 H) 7.54 (t, 1 H), 7.57 (m, 1 H), 8.10 (d, 1 H), 9.07 (d, 1 H); MS (ESI) m/z 509 [M+H]⁺.

### Example 25

N-[1-(2-fluoro-4-methoxybenzyl)piperidin-4-yl]-7-methoxy-4-oxo-4H-chromene-2-carboxamide

To a solution of Example 2C (30 mg, 0.1 mmol) in 1 mL of dichloromethane containing 2% acetic acid was added with 2-fluoro-4-methoxybenzaldehyde (15 mg, 0.1 mmol) followed by NaBH(OAc)₃ (42 mg, 0.2 mmol). The mixture was stirred for 18 hours then quenched by addition of 250 uL 1M K₂CO₃, diluted with 2 mL dichloromethane, dried (Na₂SO₄), filtered through a plug of silica gel (1 g, SepPak), rinsed through with 95:5 dichloromethane:methanol and concentrated to provide the title compound. ¹H NMR (300 MHz, DMSO-D6) δ ppm 1.64 (m, 2 H) 1.77 (m, 2 H) 2.01 (m, 2 H) 2.84 (m, 2 H) 3.46 (s, 2 H) 3.75 (m, 4 H) 3.93 (s, 3 H) 6.78 (m, 3 H) 7.10 (dd, J=8.98, 2.54 Hz, 1 H) 7.26 (m, 2 H) 7.94 (d, J=8.81 Hz, 1 H) 8.81 (d,J=7.80 Hz, 1 H); MS (ESI, MeOH/NH4OH) m/z 441 [M+H], 463 [M+Na], 439 [M−H].

### Example 26

### 7-chloro-4-oxo-N-[1-(quinolin-6-ylmethyl)piperidin-4-yl]-4H-chromene-2-carboxamide

Example 26 (6.1 mg, 30%) was made analogous to Example 4, substituting 6-quinoline carboxaldehyde (7.0 mg, 45.6 μmol) for 1,4benzodioxan-6-carbaldehyde. ¹H NMR (300 MHz, DMSO-d₆) δ ppm 1.71 (m, 2 H), 1.82 (m, 2 H), 2.12 (m, 2 H), 2.88 (m, 2 H), 3.68 (s, 2 H), 3.82 (m, 1 H), 6.82 (s, 1 H), 7.51 (dd, J=8.31, 4.24 Hz, 1 H), 7.58 (dd, J=8.48, 2.03 Hz, 1 H), 7.74 (dd, J=8.65, 1.86 Hz, 1 H), 7.85 (s, 1 H), 7.89 (d, J=1.70 Hz, 1 H), 7.98 (d,J=8.81 Hz, 1 H), 8.03 (d, J=8.48 Hz, 1 H), 8.33 (d, J=8.14 Hz, 1 H), 8.82 (d, J=7.80 Hz, 1 H), 8.86 (dd,J=4.07, 1.70 Hz, 1 H); MS (APCI) m/z 448 [M+H]⁺.

### Example 27

### N-[1-(4-acetylbenzyl)piperidin-4-yl]-7-methoxy-4-oxo-4H-chromene-2-carboxamide

To a solution of Example 2C (60 mg, 0.2 mmol) in 1 mL of 95/4 dichloromethane/methanol containing 2% acetic acid was added 4-acetylbenzaldehyde (30 mg, 0.2 mmol) followed by NaBH(OAc)₃ (84 mg, 0.4 mmol) and Na₂SO₄ (56 mg. 0.4 mmol). The mixture was stirred for 22 hours followed by the addition of 1,4-benzodioxan-6-carboxaldehyde (33 mg, 0.2 mmol) and NaBH(OAc)₃ (84 mg, 0.4 mmol). The mixture was stirred another 24 hours and then quenched by addition of 1M K₂CO₃, shaken for 30 minutes, diluted with 95/5 dichloromethane/methanol. The bottom organic layer was pipeted onto a silica gel plug (2 g, SepPak), rinsed with 90/10 dichloromethane/methanol and concentrated under reduced pressure. The resultant yellow residue was purified by flash silica gel chromatography using dichloromethane/methanol as eluent to provide the title compound. ¹H NMR (300 MHz, DMSO-D6) δ ppm 1.67 (m, 2 H) 1.79 (m, 2 H) 2.08 (m, 2 H) 2.54 (s, 3 H) 2.84 (m, 2 H) 3.57 (s, 2 H) 3.78 (m, 1 H) 3.92 (s, 3 H) 6.76 (s, 1 H) 7.11 (dd, J=8.81, 2.37 Hz, 1 H) 7.23 (d,J=2.37 Hz, 1 H) 7.46 (m, 2 H) 7.93 (m, 3 H) 8.82 (d,J=7.80 Hz, 1 H); MS (ESI, MeOH/NH4OH) m/z 435 [M+H], 457 [M+Na], 439 [M−H].

### Example 28

### 7-methoxy-4-oxo-N-[1-(quinolin-6-ylmethyl)piperidin-4-yl]-4H-chromene-2-carboxamide

To a solution of Example 2C (161 mg, 0.53 mmol) in 1 mL of dichloromethane and 1 mL THF containing 2% acetic acid was added quinoline-6-carboxaldehyde (Example 3A) (84 mg, 0.53 mmol) followed by NaBH(OAc)₃ (223 mg, 1.06 mmol). The mixture was stirred for 65 hours then quenched by slow addition of 1M K₂CO₃, diluted with dichloromethane, washed with additional 1M K₂CO₃, dried (Na₂SO₄), and concentrated to provide 235 mg of an orange foam. Flash silica gel chromatography with hexane/ethyl acetate followed by dichloromethane/methanol to provide the title compound. ¹H NMR (300 MHz, DMSO-D6) δ ppm 1.68 (m, 2 H) 1.81 (m, 2 H) 2.11 (m, 2 H) 2.89 (m, 2 H) 3.69 (s, 2 H) 3.82 (m, 1 H) 3.93 (s, 3 H) 6.76 (s, 1 H) 7.10 (dd, J=8.98, 2.54 Hz, 1 H) 7.23 (d, J=2.37 Hz, 1 H) 7.52 (dd, J=8.31, 4.24 Hz, 1 H) 7.75 (dd, J=8.48, 1.70 Hz, 1 H) 7.86 (s, 1 H) 7.95 (d, J=8.82 Hz, 1 H) 7.99 (d, J=8.81 Hz, 1 H) 8.33 (d,J=7.46 Hz, 1 H) 8.81 (d, J=7.80 Hz, 1 H) 8.87 (dd, J=4.24, 1.53 Hz, 1 H); MS (ESI, MeOH/NH4OH) m/z 444 [M+H], 466 [M+Na], 442 [M−H].

### Example 29

### N-[1-(1,3-benzodioxol-5-ylmethyl)piperidin-4-yl]-6-chloro-4-oxo-4H-chromene-2-carboxamide

### Example 29A

### tert-butyl 4-{[(6-chloro-4-oxo-4H-chromen-2-yl)carbonyl]amino}piperidine-1-carboxylate

To a solution of 6-chlor-4-oxo-4H-chromene-2-carboxylic acid (2.8 g, 12.5 mmol) and 4-amino-1-BOC-piperidine (2.5 g, 12.5 mmol) in 50 mL DMF was added hydroxybenzotriazole (1.7 g, 12.5 mmol) and ethyl(dimethylaminopropyl)carbodiimide hydrochloride (2.5 g, 13.1 mmol). The rmixture was stirred under nitrogen for 22 hours, diluted with ethyl acetate, washed with 1M HCl, 1M K₂CO₃, brine, dried (Na₂SO₄), filtered and concentrated to provide the title compound. ¹H NMR (300 MHz, DMSO-D6) δ ppm 1.42 (s, 9 H) 1.50 (m, 2 H) 1.80 (m, 2 H) 2.81 (m, 2 H) 3.97 (m, 3 H) 6.87 (s, 1 H) 7.80 (d, J=8.82 Hz, 1 H) 7.95 (m, 2 H) 8.91 (d, J=8.14 Hz, 1 H); MS (ESI, MeOH/NH4OH) m/z 429 [M+Na], 405 [M−H].

### Example 29B

### 6-chloro-4-oxo-N-piperidin-4-yl-4H-chromene-2-carboxamide

To a solution of Example 29A (2.5 g, 6.1 mmol) in 16 mL of dichloromethane at 0° C. was added trifluoroacetic acid (8 mL). The mixture was allowed to slowly warm to room temperature, stirred for 2 hours, then concentrated to yellow oil. The oil was diluted in 95/5 dichloromethane/methanol, washed with 1M K₂CO₃, aqueous extracted with additional dichloromethane, organic extracts dried (Na₂SO₄) and concentrated to provide the title compound. ¹H NMR (300 MHz, DMSO-D6) δ ppm 1.50 (m, 2 H) 1.76 (m, 2 H) 3.00 (m, 2 H) 3.85 (m, 3 ) 6.86 (s, 1 H) 7.83 (d, J=8.82 Hz, 1 H) 7.93 (d, J=2.71 Hz, 1 H) 7.97 (m, 1 H) 8.91 (d, J=8.14 Hz, 1 H); MS (ESI, MeOH/NH4OH) m/z 307 [M+H], 305 [M−H].

### Example 29C

### N-[1-(1,3-benzodioxol-5-ylmethyl)piperidin-4-yl]-6-chloro-4-oxo-4H-chromene-2-carboxamide

To a solution of Example 29B (31 mg, 0.1 mmol) in 0.5 mL THF containing 2% aceticacid was added piperonal (15 mg, 0.1 mmol), NaBH(OAc)₃ (42 mg, 0.2 mmol) and Na₂SO₄ (28 mg, 0.2 mmol). After 40 hours, the mixture was quenched by addition of 30 uL of 3M H₂SO₄, shaken for 5 minutes, then 750 uL of 1M K₂CO₃ was added, shaken 10 minutes, 2 mL 95/5 dichloromethane/methanol was added followed by drying agent (Na₂SO₄), filtered through a plug of silica gel (2 g, SepPak), rinsed through with 95/5 dichloromethane/methanol and concentration to provide the title compound. ¹H NMR (300 MHz, DMSO-D6) δ ppm 1.65 (m, 2 H) 1.77 (m, 2 H) 1.99 (m, 2 H) 2.83 (m, 2 H) 3.39 (s, 2 H) 3.78 (m, 1 H) 5.97 (s, 1 H) 5.99 (s, 2 H), 6.80 (m, 1 H), 6.90 (m, 2 H), 7.82 (d, J=8.81 Hz, 1 H) 7.97 (m, 2 H) 8.89 (d, J=8.14 Hz, 1 H); MS (ESI, MeOH/NH4OH) m/z 441 [M+H], 439 [M−H].

### Example 30

### 7-(difluoromethoxy)-4-oxo-N-[1-(1-quinolin-6-ylethyl) piperidin-4-yl]-4H-chromene-2-carboxamide

Example 30 was prepared according to the procedure described in Example 10, substituting Example 12B for 1-benzo[1,3]dioxol-5-ylmethyl-piperidin-4-ylamine. ¹H NMR (300 MHz, DMSO-d₆) δ ppm 1.79 (d, 3 H), 1.91 (m, 2 H), 2.07 (m, 4 H), 3.04 (m, 1 H) 3.34 (m, 2 H), 4.76 (m, 1 H), 6.83 (s, 1 H) 7.35 (dd, 1 H), 7.51 (t, 1 H), 7.65 (dd, 1 H), 7.93 (dd, 1 H), 8.10 (d, 1 H), 8.15 (m, 3 H), 8.45 (m, 1 H), 9.00 (dd, 1 H), 9.04 (d, 1 H).

### Example 31

### N-[1-(4-bromobenzyl)piperidin-4-yl]-7-methoxy-4-oxo-4H-chromene-2-carboxamide

To a solution of Example 2C (30 mg, 0.1 mmol) in 1 mL of dichloromethane containing 2% acetic acid was added 4-bromobenzaldehyde (18 mg, 0.1 mmol) followed by NaBH(OAc)₃ (42 mg, 0.2 mmol). The mixture was stirred for 18 hours then quenched by addition of 250 uL 1MK₂CO₃, diluted with 2 mL dichloromethane, dried (Na₂SO₄), filtered through a plug of silica gel (1 g, SepPak), rinsed through with 95:5 dichloromethane/methanol and concentrated to provide the title compound. ¹H NMR (300 MHz, DMSO-D6) δ ppm 1.65 (m, 2 H) 1.78 (m, 2 H) 2.02 (m, 2 H) 2.81 (m, 2 H) 3.45 (s, 2 H) 3.76 (m, 1 H) 3.92 (s, 3 H) 6.74 (s, 1 H) 7.09 (dd, 1 H) 7.24 (m, 3 H) 7.50 (m, 2 H) 7.93 (d, 1 H) 8.78 (d,J=8.06 Hz, 1 H); MS (ESI, MeOH/NH4OH) m/z 471 [M+H], 469 [M−H].

### Example 32

### N-[1-(1,3-benzodioxol-5-ylmethyl)piperidin-4-yl]-7-chloro-6-fluoro-4-oxo-1,4-dihydroquinoline-2-carboxamide

A 10 mL culture tube with screw cap was charged with 7-chloro-6-fluoro-4-oxo-1,4-dihydro-quinoline-2-carboxylic acid (40.0 mg, 0.166 mmol), 1-Benzo[1,3]dioxol-5-ylmethyl-piperidin-4-ylamine(42.9 mg, 0.183 mmol), EDCI (35.0 mg, 0.183 mmol), HOBT (24.7 mg, 0.183 mmol), NMM (42.6 mg, 0.398 mmol) and 2 mL of DMF, and the reaction vessel placed on a shaker for 14 hours. After this time, the DMF was removed in vacuo and the residue was dissolved in 1.5 mL of a 1:1 mixture of DMSO/MeOH and purified by preparative reverse-phase HPLC and converted to the free base product. ¹H NMR (400 MHz, DMSO-d₆) δ ppm 1.59-1.66 (m, 2H), 1.80 (d, J=9.99, 2H), 2.04 (t, 2H), 2.82 (d, J=11.85, 2H), 3.40 (s, 2H), 3.75-3.83 (m, 1H), 5.99 (s, 2H), 6.76 (d, J=9.35, 1H), 6.84-6.86 (m, 2H), 6.93 (br s, 1H), 7.89 (d, J=9.38, 1H), 8.18 (d, J=6.55, 1H), 8.76 (s, 1H), 11.94 (br s, 1H); MS (ESI) m/e 458.0 (M+H)⁺.

### Example 33

### 7-chloro-6-fluoro-N-[1-(2-fluoro-4-methoxybenzyl)piperidin-4-yl]-4-oxo-1,4-dihydroquinoline-2-carboxamide

The title compound was prepared according to the procedure for Example 32 substituting 1-(2-Fluoro-4-methoxy-benzyl)-piperidin-4-ylamine for 1-benzo[1,3]dioxol-5-ylmethyl-piperidin-4-ylamine. ¹H NMR (500 MHz, DMSO-d₆) δ ppm 1.59-1.66 (m, 2H), 1.80 (d, J=12.17, 2H), 2.07 (t, 2H), 2.82 (d, J=11.86, 2H), 3.46 (s, 2H), 3.76-3.80 (m, 4H), 6.76-6.80 (m, 2H), 6.90 (br s, 1H), 7.28 (t, J=6.55, 1H), 7.89 (d, J=9.67, 1H), 8.18 (d, J=6.55, 1H), 8.75 (s, 1H), 11.88 (br s, 1H); MS (ESI) m/e 462.0 (M+H)⁺.

### Example 34

### N-[1-(1,3-benzodioxol-5-ylmethyl)piperidin-4-yl]-7-methoxy-4-oxo-1,4-dihydroquinoline-2-carboxamide

### Example 34A

### methyl 7-methoxy-4-oxo-1,4-dihydroquinoline-2-carboxylate

A 250 mL round bottom flask with a stir bar was charged with 2.00 g of m-anisidine (16.2 mmol) and 58.0 mL of methanol. To the mixture was added 2.31 g but-2-ynedioic acid dimethyl ester (16.3 mmol). The mixture allowed to stir at room temperature for 3 hours until the starting material was consumed by TLC (85/15 hexanes/Ethyl acetate). The solvent was then evaporated under reduced pressure to provide 4.30 g of orange oil that consisted of a mixture of E and Z isomers. From this material, 3.00 g (11.3 mmol) was added to a 250 mL round bottom flask followed by 25 mL of diphenyl ether. The mixture was slowly heated to 220° C. in an oil bath. After 2 hours, the mixture was allowed to cool to room temperature, and was then submerged in an ice bath for 20 minutes. The precipitate (solid diphenyl ether) was separated via suction filtration, and the filtrate was loaded on a biotage column and eluted with 10-60% ethyl acetate/hexanes to provide 0.520 g of the title compound. NMR (300 MHz, DMSO-D6) δ ppm 3.85 (s, 3 H), 3.96 (s, 3 H), 6.56 (s, 1 H), 6.97 (m, 1 H), 7.41 (d,J=2.37 Hz, 1 H), 7.98 (d, J=9.15 Hz, 1 H), 11.84 (br. s, 1 H); MS (DCI/NH₃) m/z 234 [M+H]⁺.

### Example 34B

### 7-methoxy-4-oxo-1,4-dihydroquinoline-2-carboxylic acid

To a 4-dram vial charged with 1.46 mL of THF was added 73.0 mg of Example 34A (0.313 mmol) in portions. Full dissolution was achieved with gentle heating (heat gun), and then 0.500 mL of deionized H₂O was added followed by 26.0 mg LiOH*H₂O (0.620 mmol). The reaction mixture was allowed to shake at room temperature for 2 hours. After this time, 3 equiv of HCl (aqueous, 1N) was added and the product acid precipitated as a white solid. The precipitate was collected by suction filtration and washed with water. Drying in a vacuum oven provideed the title product as white solid. ¹H NMR (300 MHz, DMSO-D6) δ ppm 3.84 (s, 3 H), 6.55 (s, 1 H), 6.96 (dd, J=8.81, 2.37 Hz, 1 H), 7.43 (d,J=2.71 Hz, 1 H), 7.97 (d, J=8.81 Hz, 1 H), 11.73 (br s, 1 H); MS (DCI/NH₃) m/z 220 [M+H]⁺.

### Example 34

### N-[1-(1,3-benzodioxol-5-ylmethyl)piperidin-4-yl]-7-methoxy-4-oxo-1,4-dihydroquinoline-2-carboxamide

A 10 mL culture tube with a screw cap was charged with Example 34B (36.0 mg, 0.140 mmol), 1-Benzo[1,3]dioxol-5-ylmethyl-piperidin-4-ylamine (38.0 mg, 0.160 mmol), EDCI (30.0 mg, 0.160 mmol), HOBT (22.0 mg, 0.106 mmol), NMM (34.0 mg, 0.320 mmol) and 2 mL of DMF, and the reaction vessel was placed on a shaker for 6 hours. After this time, the DMF was removed under reduced pressure and the residue was dissolved in 1.5 mL of a 1:1 mixture of DMSO/methanol and purified by preparative reverse-phase HPLC. ¹H NMR (300 MHz, DMSO-d₆) δ ppm 1.75-2.10 (m, 4H), 3.05-3.43 (m, 4H), 3.85 (s, 3H), 4.03 (m, 1H), 4.20 (d, J=4.68, 2H), 6.08 (s, 2H), 6.77 (s, 1H), 6.97-7.02 (m, 3H), 7.08 (d, J=1.25, 1H), 7.43 (d, J=2.49, 1H), 7.98 (m, 1H), 8.74 (d, J=5.93, 0.2H), 8.92 (d, J=7.49, 0.8H), 9.48 (s, 1H); MS (DCI/NH₃) m/z 436 [M+H]⁺.

### Example 35

### N-[1-(1,3-benzodioxol-5-ylmethyl)piperidin-4-yl]-7-chloro-4-oxo-1,4-dihydroquinoline-2-carboxamide

### Example 35A

### 2-(3-Chloro-phenylamino)-but-2-enedioic acid dimethyl ester

The title compound was prepared according to the procedure for Example 32A substituting 3-chloro-phenylamine for 3-chloro-4-fluoro-phenylamine. ¹H NMR (300 MHz, DMSO-d₆) δ ppm major isomer: 3.66 (s, 3 H), 3.69 (s, 2 H), 5.42 (s, 1 H), 6.83 (m, 1 H), 7.09 (m, 2 H), 7.29 (t,J=7.97 Hz, 1 H), 9.55 (s, 1 H); minor isomer (partial list): 3.54 (s, 0.44 H), 3.79 (s, 0.41 H), 5.24 (s, 0.14 H), 7.15 (m, 0.35 H), 7.39 (t,J=7.97 Hz, 0.14 H), 9.50 (s, 0.17 H).

### Example 35B

### 7-Chloro-4-oxo-1,4-dihydro-quinoline-2-carboxylic acid methyl ester

The title compound was prepared according to the procedure for Example 32B substituting 3-chloro-phenylamine for 3-chloro-4-fluoro-phenylamine. ¹H NMR (300 MHz, DMSO-d₆) δ ppm 3.96 (s, 3 H), 6.65 (s, 1 H), 7.40 (d, J=8.48 Hz, 1 H), 8.00 (d, J=1.70 Hz, 1 H), 8.07 (d, J=8.48 Hz, 1 H), 12.13 (s, 1 H).

### Example 35C

### 7-Chloro-4-oxo-1,4-dihydro-quinoline-2-carboxylic acid

The title compound was prepared according to the procedure for Example 32C substituting 3-chloro-phenylamine for 3-chloro-4-fluoro-phenylamine. ¹H NMR (300 MHz, DMSO-d₆) δ ppm 6.63 (s, 1 H), 7.38 (dd, J=8.82, 2.03 Hz, 1 H), 8.01 (d, J=2.03 Hz, 1 H), 8.07 (d, J=8.82 Hz, 1 H), 12.02 (s, 1 H).

### Example 35

### N-[1-(1,3-benzodioxol-5-ylmethyl)piperidin-4-yl]-7-chloro-4-oxo-1,4-dihydroquinoline-2-carboxamide

The title compound was prepared according to the procedure for Example 32 substituting 7-chloro-4-oxo-1,4-dihydro-quinoline-2-carboxylic acid for 7-chloro-6-fluoro-4-oxo-1,4-dihydro-quinoline-2-carboxylic acid. ¹H NMR (300 MHz, DMSO-d₆) δ ppm 1.80 (m 2H), 2.07 (m, 2H), 3.11 (m, 2 H), 3.40 (m, 2 H), 4.03 (m, 1H), 4.20 (m, 2 H), 6.09 (s, 2 H), 6.86 (br s, 1H), 6.99 (m, 2 H), 7.07 (d, J=1.36 Hz, 1 H), 7.40 (m, 1 H), 8.03 (d,J=1.70 Hz, 1 H), 8.08 (m, 1 H), 9.00 (d, J=7.46 Hz, 1 H), 9.38 (br s, 1 H); MS (ESI) m/e 439.9 (M+H)⁺.

### Example 36

### N-[1-(2-fluoro-4-methoxybenzyl)piperidin-4-yl]-4-oxo-7-(trifluoromethoxy)-1,4-dihydroquinoline-2-carboxamide

### Example 36A

### methyl 4-oxo-7-(trifluoromethoxy)-1,4-dihydroquinoline-2-carboxylate

A 250 mL round bottom flask was charged with 3-Trifluoromethoxy-phenylamine (6.20 g, 35.0 mmol), but-2-ynedioic acid dimethyl ester (5.00 g, 35.0 mmol) and 125 mL of methanol. The mixture was stirred at room temperature overnight after which the methanol was removed under reduced pressure, and the residue was purified by flash chromatography (ethyl acetate/hexane, 1/1) to provide 9.00 g (28.2 mmol) of a pale yellow oil. This material was dissolved in 60 mL of diphenyl ether and then heated to 220° C. for 4 hours and cooled to room temperature. A 1/1 mixture of ethyl acetate and hexane (100 mL) was added to the mixture, and the resulting solid, a mixture of regioisomers, was collected by filtration. The solid was then separated by recrystallization in methanol to provide the title compound. ¹H NMR (300 MHz, DMSO-d₆) δ ppm 3.96 (s, 3H), 6.69 (s, 1H), 7.33 (dd, 1H, J₁=9.16, J₂=1.83), 7.93 (m, 1H), 8.18 (d, 1H, J=9.16); MS (DCI/NH₃) m/z 288 [M+H]⁺.

### Example 36B

### 4-oxo-7-(trifluoromethoxy)-1,4-dihydroquinoline-2-carboxylic acid

Example 36A (1.20 g, 4.20 mmol) and LiOH.H₂O (0.530 g, 12.6 mmol) was suspended in a 3:3:1 THF/ethanol/H₂O solution (35 mL). The mixture was stirred at room temperature for 0.5 hours, acidified with 10% HCl to pH=2, and one third of the solvent was removed under reduced pressure. The solid was collected by filtration, rinsed with water, and dried in vacuum oven to provide the title product. ¹H NMR (300 MHz, DMSO-d₆) δ ppm 6.65 (s, 1H), 7.31 (m, 1H), 7.95 (m, 1H), 8.18 (d, 1H, J=8.81), 12.08 (m, 1H); MS (DCI/NH₃) m/z 274 [M+H]⁺.

### Example 36

### N-[1-(2-fluoro-4-methoxybenzyl)piperidin-4-yl]-4-oxo-7-(trifluoromethoxy)-1,4-dihydroquinoline-2-carboxamide

A 10 mL culture tube with screw cap was charged with Example 36C (38.0 mg, 0.140 mmol), 1-(2-Fluoro-4-methoxy-benzyl)-piperidin-4-ylamine (40.0 mg, 0.160 mmol), EDCI (30.0 mg, 0.160 mmol), HOBT (22.0 mg, 0.160 mmol), NMM (34.0 mg, 0.320 mmol) and 2 mL of DMF, and the reaction vessel was placed on a shaker for 6 hours. After this time, the DMF was removed under reduced pressure and the residue was dissolved in 1.5 mL of a 1:1 mixture of DMSO/MeOH and purified by preparative reverse-phase HPLC. ¹H NMR (300 MHz, DMSO-d₆) δ ppm 1.70-2.10 (m, 4H), 2.60-3.50 (m, 4H), 4.05 (m, 1H), 4.20 (d, 2H, J=4.75), 6.09 (s, 2H), 6.95-7.10(m, 4H), 7.85 (m, 1H), 7.96 (m, 1H), 8.19 (d, 1H), J=8.82), 9.01 (d, 1H, J=7.12), 9.30 (s, 1H); MS (DCI/NH₃) m/z 490 [M+H]⁺.

### Example 37

### N-[1-(1,3-benzodioxol-5-ylmethyl)piperidin-4-yl]-4-oxo-7-(trifluoromethoxy)-1,4-dihydroquinoline-2-carboxamide

The title compound was prepared according to the procedure for Example 36 substituting 1-benzo[1,3]dioxol-5-ylmethyl-piperidin-4-ylamine for 1-(2-fluoro-4-methoxy-benzyl)-piperidin-4-ylamine. ¹H NMR (300 MHz, DMSO-d₆) δ ppm 1.74-2.10 (m, 4H), 3.10-3.60 (m, 5H), 3.82 (s, 3H), 4.28 (d, 2H, J=3.73), 6.90-7.02(m, 3H), 7.35 (m, 1H), 7.50 (t, 1H, J=8.48), 7.96 (m, 1H), 8.19 (d, 1H, J=8.48), 8.99 (m, 1H), 9.44 (m, 1H); MS (DCI/NH₃) m/z 494 [M+H]⁺.

### Example 38

### N-[1-(2-fluoro-4-methoxybenzyl)piperidin-4-yl]-7-methoxy-4-oxo-1,4-dihydroquinoline-2-carboxamide

The title compound was prepared according to the procedure for Example 34 substituting 1-(2-Fluoro-4-methoxy-benzyl)-piperidin-4-ylamine for 1-benzo[1,3]dioxol-5-ylmethyl-piperidin-4-ylamine. ¹H NMR (300 MHz, DMSO-d₆) δ ppm 1.74-2.10 (m, 4H), 3.15-3.47 (m, 4H), 3.82 (s, 3H), 3.85 (s, 3H), 4.07 (m, 1H), 4.27 (m, 2H), 6.77 (m, 1H), 6.91-6.99(m, 3H), 7.42 (d, 1H, J=2.18), 7.50 (t, 1H, J=8.74), 7.97 (d, 1H, J=9.04), 8.76 (d, 0.2H, J=5.93), 8.91 (d, 0.8H, J=7.49), 9.57 (s, 1H); MS (DCI/NH₃) m/z 440 [M+H]⁺.

### Example 39

### 7-methoxy-N-[1-(4-methoxybenzyl)piperidin-4-yl]-4-oxo-4H-chromene-2-carboxamide

To a 5 mL microwave reaction vessel which contained 85.61 mg (3.0 eq.) of MP-CNBH₃ resin (subst. 2.55 mMoles/g) and a micro-Teflon-coated stir bar, was added 4-methoxybenzaldehyde (0.0132 mmol) dissolved in dichloromethane/methanol (1:1/v:v). The core (Example 2C, 20 mg, 0.066 mmol) dissolved in dichloromethane/methanol (1:1/v:v) was then added to the reaction mixture, followed by an addition of acetic acid (3 eq.) in dichloromethane/methanol (1:1/v:v). The microwave reaction vessel was capped; and was then heated with stirring at 100 degrees Celcius for 600 seconds on an Emrys Optimizer Microwave Reactor (Personal Chemistry). The resin-suspension was then filtered and transferred with methanol to 20 mL vials and concentrated down using a Savant Speed Vac. Purification was done by Agilent Mass triggered HPLC/MS using acetonitrile/H2O with 0.1% TFA as eluent on a C18 column. ¹H NMR (500 MHz, PYRIDINE-d₅) δ ppm 2.07 (m, 4 H), 2.26 (m, 2 H), 3.05 (m, 2 H), 3.58 (s, 3 H), 3.62 (s, 2 H), 3.66 (s, 3 H), 4.29 (m, 1 H), 6.64 (d,J=2.50 Hz, 1 H), 6.92 (d, J=8.73 Hz, 2 H), 6.95 (dd, J=9.05, 2.18 Hz, 1 H), 7.34 (d, J=8.74 Hz, 2 H), 7.37 (s, 1 H), 8.19 (d, J=8.74 Hz, 1 H), 9.76 (d, J=7.80 Hz, 1 H); MS (ESI) m/z 423 [M+H]⁺, 421 [M−H]⁺.

### Example 40

### 7-methoxy-N-{1-[(5-methylthien-2-yl)methyl]piperidin-4-yl}-4-oxo-4H-chromene-2-carboxamide

To a 5 mL microwave reaction vessel which contained 85.61 mg (3.0 eq.) of MP-CNBH₃ resin (subst. 2.55 mMoles/g) and a micro-Teflon-coated stir bar, was adde 5-methyl-thiophene-2-carboxaldehyde (0.0132 mmol) dissolved in dichloromethane/methanol (1:1/v:v). The core (Example 2C, 20 mg, 0.066 mmol) dissolved in dichloromethane/methanol (1:1/v:v) was added to the mixture, followed by an addition of acetic acid (3 eq.) in dichloromethane/methanol (1:1/v:v). The microwave reaction vessel was capped; and was then heated with stirring at 100 degrees Celcius for 600 seconds on an Emrys Optimizer Microwave Reactor (Personal Chemistry). The resin-suspension was then filtered and transferred with MeOH to 20 mL vials and concentrated down using a Savant Speed Vac. Purification was done by Agilent Mass triggered HPLC/MS using acetonitrile/H2O with 0.1% TFA as eluent on a C18 column. ¹H NMR (500 MHz, PYRIDINE-d₅) δ ppm 1.94 (m, J=11.85, 3.43 Hz, 2 H), 2.10 (m, 2 H), 2.18 (t, J=11.23 Hz, 2 H), 2.33 (s, 3 H), 3.04 (m, J=11.85 Hz, 2 H), 3.51 (s, 3 H), 3.72 (s, 2 H), 4.28 (m, 1 H), 6.23 (m, 1 H), 6.65 (d, J=3.12 Hz, 1 H), 6.81 (d, J=3.12 Hz, 1 H), 6.98 (dd, J=8.89, 2.34 Hz, 1 H), 7.45 (s, 1 H), 8.25 (d, J=8.73 Hz, 1 H), 9.64 (d, J=7.49 Hz, 1 H); MS (ESI) m/z 413 [M+H]⁺, 411 [M−H]⁺.

### Example 41

### N-[1-(2-chlorobenzyl)piperidin-4-yl]-7-methoxy-4-oxo-4H-chromene-2-carboxamide

To a 5 mL microwave reaction vessel which contained 85.61 mg (3.0 eq.) of MP-CNBH₃ resin (subst. 2.55 mMoles/g) and a micro-Teflon-coated stir bar, was added 2-chlorobenzaldehyde (0.0132 mmol) dissolved in dichloromethane/methanol (1:1/v:v). The core (Example 2C, 20 mg, 0.066 mmol) dissolved in dichloromethane/methanol (1:1/v:v) was then added to the mixture, followed by an addition of acetic acid (3 eq.) in dichloromethane/methanol (1:1/v:v). The microwave reaction vessel was capped; and was then heated with stirring at 100 degrees Celcius for 600 seconds on an Emrys Optimizer Microwave Reactor (Personal Chemistry). The resin suspension was then filtered and transferred with methanol to 20 mL vials and concentrated down using a Savant Speed Vac. Purification was done by Agilent Mass triggered HPLC/MS using acetonitrile/H2O with 0.1% TFA as eluent on a C18 column. ¹H NMR (500 MHz, PYRIDINE-d₅) δ ppm 1.99 (m, 2 H), 2.05 (m, 2 H), 2.19 (m, 2 H), 2.92 (d,J=1.85 Hz, 2 H), 3.59 (s, 3 H), 3.61 (s, 2 H), 4.25 (m, 1 H), 6.64 (d, J=2.18 Hz, 1 H), 6.97 (dd,J=8.89, 2.34 Hz, 1 H), 7.18 (m, J=2.18 Hz, 2 H), 7.37 (m, 1 H), 7.39 (s, 1 H), 7.49 (m, 1 H), 8.20 (d,J=8.73 Hz, 1 H), 9.70 (d, J=7.49 Hz, 1 H); MS (ESI) m/z 427 [M+H]⁺, 425 [M−H]⁺.

### Example 42

### N-[1-(2-bromobenzyl)piperidin-4-yl]-7-methoxy-4-oxo-4H-chromene-2-carboxamide

To a 5 mL microwave reaction vessel which contained 85.61 mg (3.0 eq.) of MP-CNBH₃ resin (subst. 2.55 mmoles/g) and a micro-Teflon-coated stir bar, was added 2-bromobenzaldehyde (0.0132 mmol) dissolved in dichloromethane/methanol (1:1/v:v). The core (Example 2C, 20 mg, 0.066 mmol) dissolved in dichloromethane/methanol (1:1/v:v) was then added to the reaction mixture, followed by an addition of acetic acid (3 eq.) in dichloromethane/methanol (1:1/v:v). The microwave reaction vessel was capped; and was then heated with stirring at 100 degrees Celcius for 600 seconds on an Emrys Optimizer Microwave Reactor (Personal Chemistry). The resin-suspension was then filtered and transferred with methanol to 20 mL vials and concentrated down using a Savant Speed Vac. Purification was done by Agilent Mass triggered HPLC/MS using acetonitrile/H2O with 0.1% TFA as eluent on a C18 column. ¹H NMR (500 MHz, PYRIDINE-d₅) δ ppm 1.95 (m, 2 H), 2.08 (m, 2 H), 2.19 (m, 2 H), 2.92 (m, 2 H), 3.59 (s, 2 H), 3.60 (s, 3 H), 4.29 (m, 1 H), 6.56 (d, J=2.50 Hz, 1 H), 7.01 (dd, J=8.74, 2.50 Hz, 1 H), 7.14 (m, 1 H), 7.27 (m, 1 H), 7.46 (s, 1 H), 7.50 (d,J=7.49 Hz, 1 H), 7.62 (m, 1 H), 8.26 (d, J=8.73 Hz, 1 H), 9.67 (d, J=7.80 Hz, 1 H); MS (ESI) m/z 473 [M+H]⁺, 471 [M−H]⁺.

### Example 43

### N-{1-[(4-bromothien-2-yl)methyl]piperidin-4-yl}-7-methoxy-4-oxo-4H-chromene-2-carboxamide

To a 5 mL microwave reaction vessel which contained 85.61 mg (3.0 eq.) of MP-CNBH₃ resin (subst. 2.55 mMoles/g) and a micro-Teflon-coated stir bar, was added 4-bromothiophene-2-carboxaldehyde (0.0132 mmol) dissolved in dichloromethane/methanol (1:1/v:v). The core (Example 2C, 20 mg, 0.066 mmol) dissolved in dichloromethane/methanol (1:1/v:v) was then added to the reaction mixture, followed by an addition of acetic acid (3 eq.) in dichloromethane/methanol (1:1/v:v). The microwave reaction vessel was capped; and was then heated with stirring at 100 degrees Celcius for 600 seconds on an Emrys Optimizer Microwave Reactor (Personal Chemistry). The resin-suspension was then filtered and transferred with methanol to 20 mL vials and concentrated down using a Savant Speed Vac. Purification was done by Agilent Mass triggered the HPLC/MS using acetonitrile/H₂O with 0.1% TFA as eluent on a C18 column. ¹H NMR (500 MHz, PYRIDINE-d₅) δ ppm 1.82 (m, J=11.70, 3.59 Hz, 2H), 2.05 (m, J=10.76, 10.76 Hz, 4 H), 2.87 (m, 2 H), 3.51 (s, 3 H), 3.56 (s, 2 H), 4.25 (m, 1 H), 6.27 (d, J=2.50 Hz, 1 H), 6.93 (s, 1 H), 6.99 (dd, J=8.73, 2.50 Hz, 1 H), 7.43 (d, J=1.25 Hz, 1 H), 7.45 (s, 1 H), 8.25 (d, J=9.05 Hz, 1 H), 9.54 (s, 1 H); MS (ESI) m/z 477 [M+H]⁺, 475 [M−H]⁺.

### Example 44

### N-(1-benzylpiperidin-4-yl)-7-methoxy-4-oxo-4H-chromene-2-carboxamide

To a 5 mL microwave reaction vessel which contained 85.61 mg (3.0 eq.) of MP-CNBH₃ resin (2.55 mMoles/g) and a micro-Teflon-coated stir bar, was added benzaldehyde (0.0132 mmol) in dichloromethane/methanol (1:1/v:v), Example 2C (20 mg, 0.066 mmol) in dichloromethane/methanol (1:1/v:v) followed by an addition of acetic acid (3 eq.) in dichloromethane/methanol (1:1/v:v). The vessel was capped and was heated with stirring at 100 degrees Celcius for 600 seconds on an Emrys Optimizer Microwave Reactor (Personal Chemistry). The resin-suspension was filtered and concentrated using a Savant Speed Vac. Purification was done by Agilent Mass triggered the HPLC/MS using acetonitrile/H₂O with 0.1% TFA as eluent on a C18 column. ¹H NMR (500 MHz, PYRIDINE-d₅) δ ppm 2.16 (m, 4 H), 2.39 (m, 2 H), 3.13 (m, J=12.48 Hz, 2 H), 3.65 (s, 3 H), 3.77 (s, 2 H), 4.36 (m, 1 H), 6.72 (d, J=2.50 Hz, 1 H), 7.02 (dd, J=8.89, 2.34 Hz, 1 H), 7.35 (m, 3 H), 7.43 (s, 1 H), 7.48 (d, J=6.55 Hz, 2 H), 8.25 (d, J=8.73 Hz, 1 H), 9.84 (d, J=7.49 Hz, 1 H); MS (ESI) m/z 393 [M+H]⁺, 415 [M−Na]⁺, 391 [M−H]⁺.

### Example 45

### 7-methoxy-N-[1-(3-methoxybenzyl)piperidin-4-yl]-4-oxo-4H-chromene-2-carboxamide

To a 5 mL microwave reaction vessel which contained 85.61 mg (3.0 eq.) of MP-CNBH₃ resin (subst. 2.55 mMoles/g) and a micro-Teflon-coated stir bar, was added 3-methoxybenzaldehyde (0.0132 mmol) in dichloromethane/methanol (1:1/v:v), Example 2C (20 mg, 0.066 mmol) in dichloromethane/methanol (1:1/v:v) followed by acetic acid (3 eq.) in dichloromethane/methanol (1:1/v:v). The vessel was capped and was heated with stirring at 100 degrees Celcius for 600 seconds on an Emrys Optimizer Microwave Reactor (Personal Chemistry). The resin-suspension was filtered and concentrated down using a Savant Speed Vac. Purification was done by Agilent Mass triggered the HPLC/MS using acetonitrile/H₂O with 0.1% TFA as eluent on a C18 column. ¹H NMR (500 MHz, PYRIDINE-d₅) δ ppm 2.17 (m, 4 H), 2.43 (m, 2 H), 3.17 (m, J=12.17 Hz, 2 H), 3.67 (m, 3 H), 3.74 (s, 3 H), 3.79 (s, 2 H), 4.37 (m, 1 H), 6.72 (d, J=2.50 Hz, 1 H), 6.98 (dd, J=8.27, 2.03 Hz, 1 H), 7.02 (dd, J=8.73, 2.50 Hz, 1 H), 7.09 (d, J=7.80 Hz, 1 H), 7.21 (s, 1 H), 7.32 (t,J=7.96 Hz, 1 H), 7.43 (s, 1 H), 8.26 (d, J=9.05 Hz, 1 H), 9.84 (d, J=7.80 Hz, 1 H); MS (ESI) m/z 423 [M+H]⁺, 421 [M−H]⁺.

### Example 46

### N-{1-[(4,5-dimethyl-2-furyl)methyl]piperidin-4-yl}-7-methoxy-4-oxo-4H-chromene-2-carboxamide

To a 5 mL microwave reaction vessel which contained 85.61 mg (3.0 eq.) of MP-CNBH₃ resin (subst. 2.55 mMoles/g) and a micro-Teflon-coated stir bar, was added 4,5-dimethylfuran-2-carboxaldehyde (0.0132 mmol) in dichloromethane/methanol (1:1/v:v), Example 2C (20 mg, 0.066 mmol) in dichloromethane/methanol (1:1/v:v) followed by an addition of acetic acid (3 eq.) in dichloromethane/methanol (1:1/v:v). The vessel was capped and was then heated with stirring at 100 degrees Celcius for 600 seconds on an Emrys Optimizer Microwave Reactor (Personal Chemistry). The resin-suspension was then filtered and concentrated down using a Savant Speed Vac. Purification was done by Agilent Mass triggered HPLC/MS using acetonitrile/H₂O with 0.1% TFA as eluent on a C18 column. ¹H NMR (500 MHz, PYRIDINE-d₅) δ ppm 1.84 (d, J=4.99 Hz, 3 H), 2.06 (s, 3 H), 2.10 (m, 2 H), 2.15 (m, J=2.81 Hz, 2 H), 2.48 (m, 2 H), 3.23 (m, J=12.17 Hz, 2 H), 3.50 (s, 3 H), 3.82 (s, 2 H), 4.35 (m, 1 H), 6.18 (d,J=2.50 Hz, 1 H), 6.20 (s, 1 H), 6.97 (dd, J=8.89, 2.34 Hz, 1 H), 7.43 (s, 1 H), 8.24 (d, J=8.73 Hz, 1 H), 9.83 (d, J=7.49 Hz, 1 H); MS (ESI) m/z 411 [M+H]⁺, 409 [M−H]⁺.

### Example 47

### N-[1-(3-chlorobenzyl)piperidin-4-yl]-7-methoxy-4-oxo-4H-chromene-2-carboxamide

To a 5 mL microwave reaction vessel which contained 85.61 mg (3.0 eq.) of MP-CNBH₃ resin (subst. 2.55 mMoles/g) and a micro-Teflon-coated stir bar, was added 3-chlorobenzaldehyde (0.0132 mmol) in dichloromethane/methanol (1:1/v:v), Example 2C (20 mg, 0.066 mmol) in dichloromethane/methanol (1:1/v:v) followed by an addition of acetic acid (3 eq.) in dichloromethane/methanol (1:1/v:v). The vessel was capped and was then heated with stirring at 100 degrees Celcius for 600 seconds on an Emrys Optimizer Microwave Reactor (Personal Chemistry). The resin-suspension was then filtered and concentrated down using a Savant Speed Vac. Purification was done by Agilent Mass triggered HPLC/MS using acetonitrile/H₂O with 0.1% TFA as eluent on a C18 column. ¹H NMR (500 MHz, PYRIDINE-d₅) δ ppm 1.99 (m, 4 H), 2.11 (m, 2 H), 2.88 (m, J=11.85 Hz, 2 H), 3.46 (s, 2 H), 3.58 (s, 3 H), 4.23 (m, J=7.49 Hz, 1 H), 6.64 (d, J=2.50 Hz, 1 H), 6.95 (dd, J=8.89, 2.34 Hz, 1 H), 7.22 (m, J=4.99 Hz, 2 H), 7.26 (m, J=4.52, 2.03 Hz, 1 H), 7.37 (s, 1 H), 7.42 (s, 1 H), 8.19 (d, J=9.05 Hz, 1 H), 9.69 (d, J=7.80 Hz, 1 H); MS (ESI) m/z 428 [M+H]⁺, 425 [M−H]⁺.

### Example 48

### 7-methoxy-N-[1-(1-naphthylmethyl)piperidin-4-yl]-4-oxo-4H-chromene-2-carboxamide

To a 5 mL microwave reaction vessel which contained 85.61 mg (3.0 eq.) of MP-CNBH₃ resin (subst. 2.55 mMoles/g) and a micro-Teflon-coated stir bar, was added 1-napthaldehyde (0.0132 mmol) in dichloromethane/methanol (1:1/v:v), Example 2C (20 mg, 0.066 mmol) in dichloromethane/methanol (1:1/v:v) followed by an addition of acetic acid (3 eq.) in dichloromethane/methanol (1:1/v:v). The vessel was capped; and was then heated with stirring at 100 degrees Celcius for 600 seconds on an Emrys Optimizer Microwave Reactor (Personal Chemistry). The resin-suspension was then filtered and transferred with MeOH to 20 mL vials and concentrated down using a Savant Speed Vac. Purification was done by Agilent Mass triggered HPLC/MS using acetonitrile/H₂O with 0.1% TFA as eluent on a C18 column. ¹H NMR (500 MHz, PYRIDINE-d₅) δ ppm 1.87 (m, 2 H), 2.07 (d, J=11.54 Hz, 2 H), 2.27 (t, J=11.54 Hz, 2 H), 3.05 (d, J=11.54 Hz, 2 H), 3.52 (s, 3 H), 4.00 (s, 2 H), 4.32 (m, J=7.49 Hz, 1 H), 6.29 (d, J=2.50 Hz, 1 H), 6.98 (dd, J=8.74, 2.50 Hz, 1 H), 7.46 (m, 2 H), 7.52 (m, 3 H), 7.86 (d, J=8.11 Hz, 1 H), 7.91 (m, 1 H), 8.25 (d, J=8.73 Hz, 1 H), 8.42 (d, J=7.49 Hz, 1 H), 9.53 (d, J=7.49 Hz, 1 H); MS (ESI) m/z 443 [M−H]⁺.

### Example 49

### N-[1-(1,3-benzodioxol-5-ylmethyl)piperidin-4-yl]-7-chloro-6-cyano-4-oxo-4H-chromene-2-carboxamide

### Example 49A

### 5-acetyl-2-chloro-4-hydroxy-benzonitrile

To a solution of 2-chloro-4-hydroxy-benzonitrile (5.0 g, 32.5 mmol) and triethylamine (4.52 mL, 32.5 mmol) in dichloromethane (32 mL) at room temperature was added acetyl chloride (2.54 mL, 35.8 mmol). The mixture was stirred at room temperature overnight and then concentrated to a yellow residue. The residue was diluted with diethyl ether (75 mL), and the solid NH₄Cl was filtered. The eluent was concentrated to yellow oil. The oil was dissolved in dichloromethane (23 mL) and added to a room temperature suspension of AlCl₃ (6.5 g, 48.9 mmol) in dichloromethane (10 mL). The mixture was stirred vigorously for 1 hour and then a short-path distillation head was attached to the round-bottomed flask. The dichloromethane was distilled (bath temp=70° C.) from the mixture, and the resulting slurry was heated to 170° C. for 3 hours. The reaction was cooled to room temperature and then diluted with 100 mL of 50% aqueous HCl. The solid was filtered, and air-dried. Purification of the residue by MPLC (1:1 Hexane:Ethyl acetate) gave 5-acetyl-2-chloro-4-hydroxy-benzonitrile as a solid. ¹H NMR (300 MHz, DMSO-d₆) δ ppm 2.64 (s, 3 H), 7.34 (s, 1 H), 8.39 (s, 1 H), and 12.57 (s, 1 H).

### Example 49B

### 7-chloro-6-cyano4-oxo-4H-chromene-2-carboxylic acid ethyl ester

To a suspension of 5-acetyl-2-chloro-4-hydroxy-benzonitrile (1.54 g, 8.06 mmol) in diethylglyoxalate (6 mL) at room temperature was added sodium ethoxide (12.6 mL, 32.24 mmol, 20 weight % in EtOH). The reaction was stirred at 50° C. for 0.5 hour, and was then cooled to room temperature. The mixture was diluted with diethyl ether (15 mL) and the yellow solid was filtered, washed with additional diethyl ether (10 mL) and then dried under reduced pressure. The solid was suspended in a mixture of concentrated HCl (1 mL) in acetic acid (8 mL) and heated to reflux (bath temperature=115 C) for 2 hours. The mixture was cooled to ambient temperature and diluted with H₂O (10 mL). The resulting solid was filtered and air-dried to provide 7-chloro-6-cyano-4-oxo-4H-chromene-2-carboxylic acid ethyl ester as a solid. ¹H NMR (300 MHz, DMSO-d₆) δ ppm 1.35 (t, J=7.12 Hz, 3 H), 4.40 (q, J=7.12 Hz, 2 H), 7.06 (s, 1 H), 8.38 (s, 1 H), 8.60 s, 1 H).

### Example 49C

### 7-Chloro-6-cyano-4-oxo-4H-chromene-2-carboxylic acid

A 100 mL round bottom flask was charged with 7-chloro-6-cyano-4-oxo-4H-chromene-2-carboxylic acid ethyl ester (800 mg, 2.88 mmol), 40 mL glacial acetic acid, and 10 mL 6N HCl. The solution was refluxed overnight, and then cooled to ambient temperature. The solid was filtered, washed with H₂O (5 mL), and air-dried to provide 7-chloro-6-cyano-4-oxo-4H-chromene-2-carboxylic acid as a solid. ¹H NMR (300 MHz, DMSO-d₆) δ ppm 1.90 (s, 1H), 7.00 (s, 1H), 8.30 (s, 1H), 8.60 (s, 1H); MS (ESI) m/z 248 [M−H]⁻.

### Example 49

### N-[1-(1,3-benzodioxol-5-ylmethyl)piperidin-4-yl]-7-chloro-6-cyano-4-oxo-4H-chromene-2-carboxamide

To a 4 mL vial with screw cap was added 7-chloro-6-cyano-4-oxo-4H-chromene-2-carboxylic acid (25.0 mg, 0.100 mmol), 1-benzo[1,3]dioxol-5-ylmethyl-piperidin-4ylamine dihydrochloric acid salt (46.0 mg, 0.150 mmol), EDCI (19.2 mg, 0.100 mmol), HOBT (13.6 mg, 0.100 mmol), NMM (48.0 mg, 0.475 mmol) and 0.5 mL of DMF. The vial was placed on a shaker at 40° C. for 16 hours. The solution was diluted with acetonitrile (1 mL), filtered, and purified by preparative reverse-phase HPLC to provide N-[1-(1,3-benzodioxol-5-ylmethyl)piperidin-4-yl]-7-chloro-6-cyano-4-oxo-4H-chromene-2-carboxamide. ¹H NMR (300 MHz, DMSO-d₆) δ ppm 1.80 (m, 2H), 2.10 (m, 2H), 3.10(m, 2H), 3.40 (m, 2H), 4.00 (m, 1H), 420 (s, 2H), 6.10 (s, 2H), 6.90-7.10 (m, 4H), 8.20 (s, 1H), 8.60 (s, 1H), 9.10 (d, 1H); MS (ESI) m/z 466 [M+H]⁺.

### Example 50

### N-[1-(1,3-benzothiazol-6-ylmethyl)piperidin-4-yl]-6,7-dichloro-4-oxo-4H-chromene-2-carboxamide

### Example 50A

### 2-(3,4-Dichloro-phenoxy)-but-2-enedioic acid

Benzyltrimethylammonium hydroxide (1.5 mL of a 40% weight aqueous solution, 1.2%) was added to a solution of 3,4dichlorophenol (20.0 g, 123 mmol), dimethyl acetylenedicarboxylate (16.6 mL, 135 mmol), and dioxane (230 mL). The dark, homogeneous mixture was heated at 90° C. for 1.5 hour, cooled to ambient temperature, combined with 20% aqueous NaOH (100 mL), and warmed to 90° C. After an hour, the mixture was cooled to ambient temperature and combined with 2N aqueous HCl until the pH of the solution was pH=7. White sediment was removed by filtration and the filtrate was combined with 2N aqueous HCl until acidic (pH=2). The resulting precipitate was collected by filtration, washed with water, and air-dried to provide the product as a solid. ¹H NMR (300 MHz, DMSO-d₆) δ ppm 6.64 (s, 1 H), 6.95 (dd, J=8.82, 2.71 Hz, 1 H), 7.25 (d, J=3.05 Hz, 1 H), 7.57 (d, J=8.82 Hz, 1 H); MS (APCI) m/z 275 [M−H]⁺.

### Example 50B

### 6,7-Dichloro-4-oxo-4H-chromene-2-carboxylic acid

Example 50A (17.98 g, 64.9 mmol) was combined with Eaton's Reagent (140 ml). The mixture was heated a 70° C. overnight. After 14 hours the mixture was cooled to ambient temperature and added to ice (600 g). The resulting white precipitate was collected by filtration, washed with water, and air-dried. The white solid (16.8 g) was dissolved in hot dimethyl sulfoxide and cooled slowly to ambient temperature. The supernatant was recovered and concentrated, and the process was repeated to provide the title compound. The crystalline material proved to be the undesirable 5,6-dichloro isomer. ¹H NMR (300 MHz, DMSO-d₆) δ ppm 6.96 (s, 1 H), 8.16 (s, 1 H), 8.26 (s, 1 H); MS (APCI) m/z 259 [M+H]⁺.

### Example 50C

### 4-[(6,7-Dichloro-4-oxo-4H-chromene-2-carbonyl)-amino]-piperidine

To a solution of Example 50B (6,7-dichloro-4-oxo-4H-chromene-2-carboxylic acid, 2.5 g, 9.7 mmol) in 30 mL of dimethylformamide was added 4amino-1-BOC-piperidine (1.94 g, 9.7 mmol), hydroxybenzotriazole (1.31 g, 9.7 mmol), diisopropylethylamine (1.29 g, 10 mmol), under an atmosphere of nitrogen followed by the addition of ethyldimethylaminocarbodiimide hydrochloride (1.90 g, 10 mmol). The mixture was stirred for 14 hours, diluted with ethyl acetate, washed with 1M H₂SO4, 1M K₂CO₃, brine, dried (Na₂SO₄), filtered and concentrated under reduced pressure to provide an oil. This residue was dissolved in 50 mL dichloromethane, under nitrogen, cooled to 0° C., after which 45 mL of trifluoroacetic acid in was added three portions. After 15 minutes at 0° C., the reaction was allowed to warm to room temperature, stirred for 1.5 hours and then concentrated to brown oil. This oil was dissolved in dichloromethane (300 mL) and washed with 1M K₂CO₃, aqueous extracted with 95/5 dichloromethane/methanol (3×100 mL), organic extracts combined, dried (Na₂SO₄), filtered and concentrated to provide the title compound. [M+H] 342.

### Example 50D

### benzothiazole-6-carboxylic acid methyl ester

To a 250 mL round bottom flask was added benzothiazole-6-carboxylic acid (5.0 g, 27.9 mmol), 100 mL methanol, and 10 mL thionyl chloride. The solution was refluxed 2 hours, cooled to ambient temperature, and concentrated under reduced pressure to provide the title compound. ¹H NMR (300 MHz, DMSO-d₆) δ ppm 3.91 (s, 3H), 8.10 (dd, 1 H), 8.19 (d, 1 H), 8.86 (d, 1H), 9.60 (s, 1H); MS (ESI) m/z 194 [M+H]⁺.

### Example 50E

### benzothiazole-6-methanol

To a 500 mL round bottom flask containing benzothiazole-6-carboxylic acid methyl ester (3.0 g, 15.5 mmol) and 100 mL dichloromethane at 0° C. was added diisobutylaluminum hydride (50 mL of 1.0 M solution in heptane). The solution was allowed to warm to ambient temperature and stirred for 4 hours. The mixture was diluted with ethyl acetate (100 mL), followed by stirring with saturated potassium sodium tartrate (100 mL) for 2 hours. The layers were separated, and the organic layer was washed with brine (100 mL), dried (Na₂SO₄), filtered and solvents were removed under reduced pressure. Purification by silica gel chromatography (25% Ethyl acetate/hexanes) provided the title compound as oil. MS (ESI) m/z 166 [M+H]⁺.

### Example 50F

### 6-bromomethylbenzothiazole

To a 50 mL round bottom flask was added benzothiazole-6-methanol (1.0 g, 6 mmol) and 10 mL of 30 HBr in acetic acid, 50 mmol and the solution was heated to 60° C. for 2 hours. The solution was cooled to ambient and purged with nitrogen. Toluene (30 mL) was added and the solution was concentrated under vacuum (repeat 2×). The solid obtained was dried under reduced pressure at 25° C. for 16 hours to provide the title compound. ¹H NMR (300 MHz, DMSO-D6) δ ppm 4.89 (s, 2 H), 7.62 (dd, 1 H), 8.08 (d, 1 H), 8.27 (d, 1 H), 9.43 (s, 1 H); MS (ESI) 229 (M+H)⁺.

### Example 50

### N-[1-(1,3-benzothiazol-6-ylmethyl)piperidin-4-yl]-6,7-dichloro-4-oxo-4H-chromene-2-carboxamide

Example 50F and Example 50C were processed according to the procedure described in Example 3 to prepare the title compound. ¹H NMR (300 MHz, DMSO-D6) δ ppm 1.64 (m, 2 H), 1.81 (m, 2 H), 2.10 (m, 2 H), 2.87 (m, 2 H), 3.65 (s, 2 H), 3.80 (m, 1 H), 6.85 (s, 1 H), 7.51 (dd, 1 H), 8.05 (d, 1 H), 8.08 (d, 1 H), 8.13 (s, 1 H), 8.16 (s, 1 H), 8.83 (d, 1 H), 9.35 (s, 1 H); MS (ESI) 488 (M+H)⁺.

### Example 51

### N-[1-(1,3-benzoxazol-5-ylmethyl)piperidin-4-yl]-6,7-dichloro-4-oxo-4H-chromene-2-carboxamide

### Example 51A

### 5-bromomethylbenzoxazole

A mixture of 5-methyl-benzoxazole (3 g, 22 mmol), N-bromosuccinimide (4 g, 22 mmol), and Benzoyl peroxide (5 mg, 0.02 mmol) was heated to reflux for 5 hours in CCl₄ (100 mL). The mixture was cooled to room temperature, and resulting precipitate was removed by passing through a plug of silica gel. Filtrate was concentrated under reduced pressure and the residue was crystalized from ethyl acetate and hexane (1/1) to provide a pale yellow solid. MS (ESI) 213 (M+H)⁺.

### Example 51

### N-[1-(1,3-benzoxazol-5-ylmethyl)piperidin-4-yl]-6,7-dichloro-4-oxo-4H-chromene-2-carboxamide

Example 51A and Example 50C were processed according to the procedure described in Example 3 to provide the title compound. ¹H NMR (300 MHz, DMSO-D6) δ ppm 1.64 (m, 2 H), 1.82 (m, 2 H), 2.08 (m, 2 H), 2.87 (m, 2 H), 3.62 (s, 2 H), 3.81 (m, 1 H), 6.85 (s, 1 H), 7.40(dd, 1 H), 7.71 (m, 2 H), 8.13 (s, 1 H), 8.16 (s, 1 H), 8.72 (s, 1 H), 8.83 (d, 1 H); MS (ESI) 473 (M+H)⁺.

### Example 52

### N-[1-(1,3-benzodioxol-5-ylmethyl)piperidin-4-yl]-6-chloro-7-methoxy-4-oxo-4H-chromene-2-carboxamide

### Example 52A

### 2-Hydroxy-3-iodo-4-methoxyacetophenone

To a stirred solution of 2-hydroxy-4-methoxyacetophenone (2.0 g, 12.1 mmol) in ethanol (40 mL) was added iodine (1.22 g, 4.82 mmol) followed by a solution of HIO₃ (0.42 g, 2.41 mmol) in H₂O (11 mL). The mixture was stirred vigorously for 2 hours and was then diluted with H₂O (10 mL). The solid was filtered, air-dried, and crystallized from ethanol to provide the title compound. ¹H NMR (300 MHz, DMSO-d₆) δ ppm 2.63 (s, 3 H), 3.94 (s, 3 H), 6.70 (d, J=8.82 Hz, 1 H), 8.01 (d, J=8.82 Hz, 1 H), 13.49 (s, 1 H); MS (ESI) m/z 413 [M+H]⁺.

### Example 52B

### 2-Hydroxy-3-iodo-4-methoxy-5-chloro-acetophenone

To a stirred solution of 2-hydroxy-3-iodo-4-methoxyacetophenone (1.50 g, 5.14 mmol in 1:1 ethyl acetate/acetic acid (20 mL) was added N-chlorosuccinimide (0.717 g, 5.39 mmol). The mixture was heated to 45° C. for 16 hours, and concentrated under reduced pressure to a volume of ˜10 mL. The mixture was diluted with H₂O (20 mL) and diethyl ether (15 mL). The layers were separated, and the aqueous was extracted with additional diethyl ether (3×15 mL). The combined organic layers were dried with anhydrous Na₂SO₄, filtered, and concentrated under reduced pressure to provide 2-hydroxy-3-iodo-4-methoxy-5-chloro-acetophenone. ¹H NMR (300 MHz, DMSO-d₆) δ ppm 2.68 (m, 3 H), 2.68 (s, 3 H), 8.16 (s, 1 H), 13.25 (s, 1 H), MS (ESI) m/z 325 [M−H]⁻.

### Example 52C

### 2-Hydroxy-4-methoxy-5-chloro-acetophenone

To a stirred solution of 2-hydroxy-3-iodo-4-methoxy-5-chloro-acetophenone (1.67 g, 5.14 mmol) in DMF (20 mL) under an atmosphere of N₂ was added sodium formate (1.74 g, 25.7 mmol), and Pd(Ph₃)₄ (0.178 g, 0.153 mmol), and the mixture was heated to 120° C. for 0.5 hour. The mixture was cooled to room temperature and diluted with H₂O (20 mL). The solid was filtered and dried under reduced pressure. Purification of the residue was done by MPLC in 95:5 dichloromethane/methanol to provide 2-hydroxy-4-methoxy-5-chloro-acetophenone as a solid. ¹H NMR (300 MHz, DMSO-d₆) δ ppm 2.59 (s, 3 H), 3.91 (s, 3 H), 6.70 (s, 1 H), 7.95 (s, 1 H), 12.53 (s, 1 H); MS (ESI) m/z 413 [M+H]⁺.

### Example 52D

### 6-Chloro-7-methoxy-4-oxo-4H-chromene-2-carboxylic acid

To a solution of 2-hydroxy-4-methoxy-5-chloro-acetophenone (440 mg, 2.20 mmol) in diethylglyoxalate (1.7 mL) was added NaOEt (3.44 mL, 8.80 mmol, 20 weight % in EtOH), and the mixture was heated to 50° C. for 0.5 hour. The mixture was cooled to ambient temperature, diluted with diethyl ether (5 mL), and filtered. The yellow solid was suspended in a solution of concentrated in HCl (12 M, 0.30 mL) in acetic acid (2.20 mL), and heated to reflux (bath temperature=115° C.) for 1.5 hours. 6 N HCl (0.70 mL) was added to the reaction, and it was heated to reflux for an additional 16 hours. The mixture was cooled to ambient temperature, diluted with H₂O (5 mL), and filtered. The solid was air-dried to provide the title compound as a solid. ¹H NMR (300 MHz, DMSO-d₆) δ ppm 4.03 (s, 3 H), 6.89 (s, 1 H), 7.48 (s, 1 H), 7.99 (s, 1 H); MS (ESI) m/z 255 [M+H]⁺.

### Example 52

### N-[1-(1,3-benzodioxol-5-ylmethyl)piperidin-4-yl]-6-chloro-7-methoxy-4-oxo-4H-chromene-2-carboxamide

To a stirred solution of 6-chloro-7-methoxy-4-oxo-4H-chromene-2-carboxylic acid (20 mg, 0.078 mmol), 1-benzo[1,3]dioxol-5-ylmethyl-piperidin-4-ylamine bis-hydrochloride salt (24 mg, 0.078 mmol), NMM (0.041 mL, 0.38 mmol), and HOBt (13 mg, 0.094 mmol) in DMF (1 mL) was added EDCI (18 mg, 0.094 mmol). The mixture was heated to 55° C. for 12 hours, and concentrated under reduced pressure. Purification of the residue by RP-HPLC gave the titled compound has yellow solid. ¹H NMR (300 MHz, DMSO-d₆) δ ppm 1.65 (m, 2 H), 1.78 (s, 2 H), 2.01 (m, 2 H), 2.84 (d, J=11.87 Hz, 2 H), 3.38 (d, J=7.80 Hz, 2 H), 3.79 (m, 1 H), 4.02 (m, 3 H), 5.99 (s, 2 H), 6.78 (m, 4 H), 7.43 (s, 1 H), 7.98 (s, 1 H), 8.83 (d, J=8.14 Hz, 1 H); MS (ESI) m/z 471 [M+H]⁺.

### Example 53

### 6-chloro-N-{1-[(2,2-difluoro-1,3-benzodioxol-5-yl)methyl]piperidin-4-yl}-7-methoxy-4-oxo-4H-chromene-2-carboxamide

Example 53 was prepared according to the procedure outlined in Example 52, substituting 1-[(2,2-difluoro-1,3-benzodioxol-5-yl)methyl]piperidin-4-ylamine bis-hydrochloride salt for 1-benzo[1,3]dioxol-5-ylmethyl-piperidin-4-ylamine bis-hydrochloride salt. ¹H NMR (300 MHz, DMSO-d₆) δ ppm 1.66 (m, 2 H), 1.80 (m, 2 H), 2.06 (m, 2 H), 2.84 (d, J=11.53 Hz, 2 H), 3.50 (s, 2 H), 3.80 (m, 1 H), 4.03 (d, J=6.78 Hz, 3 H), 6.79 (s, 1 H), 7.14 (d, J=8.14 Hz, 1 H), 7.35 (m, 2 H, 7.44 (m, 1 H), 7.98 (s, 1 H), 8.84 (d, J=8.14 Hz, 1 H).

### Example 54

### N-[1-(1,3-benzodioxol-5-ylmethyl)piperidin-4-yl]-7-chloro-6-fluoro-4-oxo-4H-chromene-2-carboxamide

### Example 54A

### Acetic acid 3-chloro-4-fluoro-phenyl ester

To a 100 mL round bottom flask was added 3-chloro-4-fluoro-phenol (5 g, 34.1 mmol), pyridine (8.3 mL, 102.6 mmol), dichloromethane (10 mL), and acetic anhydride (3.54 mL, 37.4 mmol). The mixture was stirred at room temperature for 16 hours. The mixture was washed with 10% acetic acid/water. The organic layer was concentrated to dryness to provide acetic acid 3-chloro-4-fluoro-phenyl ester as a white solid. ¹H NMR (300 MHz, DMSO-d₆) δ ppm 2.25 (s, 3H), 7.20 (m, 1H), 7.50 (m, 2H).

### Example 54B

### 1-(4-Chloro-5-fluoro-2-hydroxy-phenyl)-ethanone

To a 100 mL round bottom flask was added acetic acid 3-chloro-4-fluoro-phenyl ester (2 g, 10.6 mmol), aluminum chloride (4 g, 30 mmol), and dichloromethane (10 mL). The mixture was stirred at room temperature for 1 hour after which the dichloromethane was then distilled off using a short-path distillation (oil bath temperature=70° C.). The mixture was slowly heated to 120° C. and HCl gas evolved. After 10 minutes, the bath temperature was increased to 140° C. and the mixture was stirred for 2 hours. The mixture was allowed to cool to room temperature and then diluted with 50% HCl and water. Solid was filtered and washed with water to provide 1-(4-Chloro-5-fluoro-2-hydroxy-phenyl)-ethanone as a solid. ¹H NMR (300 MHz, DMSO-d₆) δ ppm 2.60 (s, 3H), 7.2 (d, 1H), 7.85 (d, 1H), 11.70 (s, 1H).

### Example 54C

### 7-Chloro-6-fluoro-4-oxo-4H-chromene-2-carboxylic acid

To a solution of 1-(4-chloro-5-fluoro-2-hydroxy-phenyl)-ethanone (1.25 g, 6.63 mmol) in diethyl oxalate (5.4 mL) was added NaOEt (9.0 mL, 23.0 mmol, 20 weight % in EtOH), and the mixture heated to 50° C. for 0.5 hour. The mixture was cooled to ambient temperature, diluted with diethyl ether (25 mL), and filtered. The yellow solid was suspended in a solution of concentrated HCl (1 mL) in acetic acid (7 mL), and heated to reflux for 1.5 hour. 6 N HCl (4 mL) was added to the mixture, and it was heated to reflux for an additional 16 hour. The mixture was cooled to ambient temperature, diluted with H₂O (25 mL), and filtered. The solid was air-dried to provide the title compound as a solid. ¹H NMR (300 MHz, DMSO-d₆) δ ppm 3.5 (s, 1 H), 6.9 (s, 1 H), 7.90 (d, 1 H), 8.25 (d, 1 H); MS (ESI) m/z 241 [M−H]⁻.

### Example 54

### N-[1-(1,3-benzodioxol-5-ylmethyl)piperidin-4-yl]-7-chloro-6-fluoro-4-oxo-4H-chromene-2-carboxamide

To a 4 mL vial with screw cap was added 7-chloro-6-fluoro-4-oxo-4H-chromene-2-carboxylic acid (306 mg, 1.26 mmol), 1-benzo[1,3]dioxol-5-ylmethyl-piperidin-4ylamine dihydrochloric acid salt (407 mg, 1.32 mmol), EDCI (242 mg, 1.26 mmol), HOBT (170 mg, 1.26 mmol), NMM (509 mg, 5.04 mmol) and 1.5 mL of DMF. The mixture was placed on a shaker at 55° C. for 16 hours. The mixture was diluted with water (1 mL); extracted 3 times dichloromethane (5 mL); and, the combined organics were concentrated to dryness. The residue was purified on a FlashMaster II silica column using gradient conditions from 100% dichloromethane to 5% methanol/dichloromethane. Product fractions were combined and concentrated to dryness to provide 7-Chloro-6-fluoro-4-oxo-4H-chromene-2-carboxylic acid (1-benzol[1,3]dioxol-5ylmethyl-piperidin-4-yl)-amide. ¹H NMR (300 MHz, DMSO-d₆) δ ppm 1.60 (m, 2H), 1.80 (m, 2H), 2.00 (m, 2H), 2.80(m, 2H), 3.40 (s, 2H), 3.80 (m, 1H), 600 (s, 2H), 6.70-6.90 (m, 4H), 7.95 (d, 1H), 8.10 (d, 1H), 8.80 (d, 1H); MS (ESI) m/z 459[M+H]⁺.

1. A compound of formula (I), 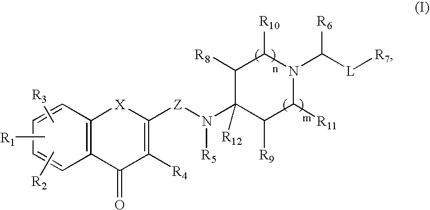
or a therapeutically suitable salt or prodrug thereof, wherein
L is a member selected from the group consisting of a bond, alkyl, alkenyl, alkynyl, —CH₂—O—, —S(O)₂—NH—, —C(O)—NH—, —NH—C(O)—, —NH—S(O)₂—, —C(O)—, —S(O)— and —S(O)₂—;
X is a member selected from the group consisting of —O— and —N(R₁₃)—;
Z is a member selected from the group consisting of —CH₂—, —C(N—R_{c})—, —C(O)— and —C(S)—;
m is 1 or 2;
n is 0, 1, or 2
R₁, R₂ and R₃ are each independently a member selected from the group consisting of hydrogen, halogen, alkenyl, alkoxy, alkyl, alkyl-C(O)—, alkyl-C(O)—NH—, alkyl-NH—C(O)—, alkyl-S(O)₂—NH—, alkyl-NH—S(O)₂—, alkyl-S(O)₂—, alkyl-S(O)—, alkyl-S—, alkynyl, cyano, haloalkyl, haloalkoxy, haloalkyl-S—, RₐR_{b}N—, and R₁ and R₂ taken together with any intervening atoms form a heterocycle;
R₄ is a member selected from the group consisting of hydrogen, alkyl, alkyl-C(O)—NH—, alkyl-S(O)₂—NH—, aryl and halogen;
R₅ is a member selected from the group consisting of hydrogen and alkyl;
R₆ is a member selected from the group consisting of hydrogen, alkyl, aryl, cycloalkyl and heterocycle;
R₇ is a member selected from the group consisting of aryl, arylalkyl, heterocycle and heterocyclealkyl;
R₈ is a member selected from the group consisting of hydrogen, alkyl and alkoxy;
R₉ is a member selected from the group consisting of hydrogen and alkyl;
R₁₀ and R₁₁ are independently selected from the group consisting of hydrogen, alkyl, alkoxylalkyl, and R₁₀ and R₁₁ taken together with any intervening atoms form a 5, 6, or 7-membered ring;
R₁₂ is a member selected from the group consisting of hydrogen and alkyl;
R₁₃ is a member selected from the group consisting of hydrogen, alkyl, aryl, cycloalkyl and heterocycle;
Rₐ and R_{b} are each individually a member selected from the group consisting of hydrogen, alkoxycarbonyl, alkyl, alkylcarbonyl, alkylNHC(O)—, alkylS(O)₂— and Rₐ and R_{b} taken together with the nitrogen to which they are attacked form a heterocycle; and
R_{c} is a member selected from the group consisting of hydrogen and alkyl;
provided that at least one of R₁, R₂ or R₃ are not hydrogen.

2. A compound of formula (II), 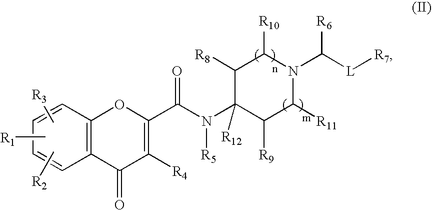
or a therapeutically suitable salt or prodrug thereof, wherein
L is a member selected from the group consisting of a bond, alkyl, alkenyl, alkynyl, —CH₂—O—, —S(O)₂—NH—, —C(O)—NH—, —NH—C(O)—, —NH—S(O)₂—, —C(O)—, —S(O)— and —S(O)₂—;
m is 1 or 2;
n is 0, 1, or 2;
R₁, R₂ and R₃ are each independently a member selected from the group consisting of hydrogen, halogen, alkenyl, alkoxy, alkyl, alkyl-C(O)—, alkyl-C(O)—NH—, alkyl-NH—C(O)—, alkyl-S(O)₂—NH—, alkyl-NH—S(O)₂—, alkyl-S(O)₂—, alkyl-S(O)—, alkyl-S—, alkynyl, cyano, haloalkyl, haloalkoxy, haloalkyl-S—, RₐR_{b}N—, and R₁ and R₂ taken together with any intervening atoms form a heterocycle;
R₄ is a member selected from the group consisting of hydrogen, alkyl, alkyl-C(O)—NH—, alkyl-S(O)₂—NH—, aryl and halogen;
R₅ is a member selected from the group consisting of hydrogen and alkyl;
R₆ is a member selected from the group consisting of hydrogen, alkyl, aryl, cycloalkyl and heterocycle;
R₇ is a member selected from the group consisting of aryl, arylalkyl, heterocycle and heterocyclealkyl;
R₈ is a member selected from the group consisting of hydrogen, alkyl and alkoxy;
R₉ is a member selected from the group consisting of hydrogen and alkyl;
R₁₀ and R₁₁ are each independently selected from the group consisting of hydrogen, alkyl, alkoxylalkyl, and R₁₀ and R₁₁ taken together with any intervening atoms form a 5, 6, or 7-membered ring;
R₁₂ is a member selected from the group consisting of hydrogen and alkyl; and
Rₐ and R_{b} are each individually a member selected from the group consisting of hydrogen, alkoxycarbonyl, alkyl, alkylcarbonyl, alkylNHC(O)—, alkylS(O)₂— and Rₐ and R_{b} taken together with the nitrogen to which they are attacked form a heterocycle;
provided that at least one of R₁, R₂ or R₃ are not hydrogen.

3. A compound of formula (IIa), 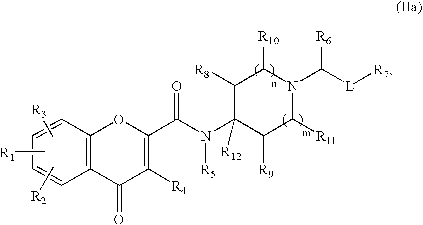
or a therapeutically suitable salt or prodrug thereof, wherein
L is a member selected from the group consisting of a bond, alkyl, alkenyl, alkynyl, —CH₂—O—, —S(O)₂—NH—, —C(O)—NH—, —NH—C(O)—, —NH—S(O)₂—, —C(O)—, —S(O)— and —S(O)₂—;
m is 1;
n is 1;
R₁, R₂ and R₃ are each independently a member selected from the group consisting of hydrogen, halogen, alkoxy, alkyl, alkyl-C(O)—, alkyl—C(O)—NH—, alkyl-NH—C(O)—, alkyl-S(O)₂—NH—, alkyl-NH—S(O)₂—, alkyl-S(O)₂—, alkyl-S(O)—, alkyl-S—, alkynyl, cyano, haloalkyl, haloalkoxy, haloalkyl-S—, RₐR_{b}N—, and R₁ and R₂ taken together with any intervening atoms form a heterocycle;
R₄ is a member selected from the group consisting of hydrogen, alkyl, alkyl-C(O)—NH—, alkyl-S(O)₂—NH—, aryl and halogen;
R₅ is a member selected from the group consisting of hydrogen and alkyl;
R₆ is a member selected from the group consisting of hydrogen and alkyl;
R₇ is a member selected from the group consisting of aryl, arylalkyl, heterocycle and heterocyclealkyl;
R₈ is a member selected from the group consisting of hydrogen, alkyl and alkoxy;
R₉ is a member selected from the group consisting of hydrogen and alkyl;
R₁₀ and R₁₁ are each independently selected from the group consisting of hydrogen, alkyl, alkoxylalkyl, and R₁₀ and R₁₁ taken together with any intervening atoms form a 5, 6, or 7-membered ring;
R₁₂ is hydrogen; and
Rₐ and R_{b} are each individually a member selected from the group consisting of hydrogen, alkoxycarbonyl, alkyl, alkylcarbonyl, alkylNHC(O)—, alkylS(O)₂— and Rₐ and R_{b} taken together with the nitrogen to which they are attacked form a heterocycle;
provided that at least one of R₁, R₂ or R₃ are not hydrogen.

4. A compound of formula (IIb), 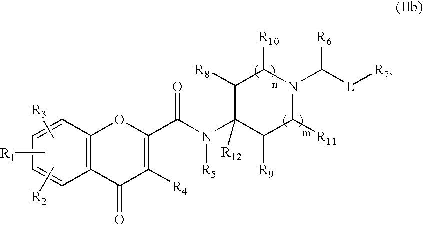
or a therapeutically suitable salt or prodrug thereof, wherein
L is a bond;
m is 1;
n is 1;
R₁, R₂ and R₃ are each independently a member selected from the group consisting of hydrogen, halogen, alkoxy, alkyl, cyano, haloalkyl, haloalkoxy and RₐR_{b}N—;
R₄ is a member selected from the group consisting of hydrogen, alkyl, alkyl-C(O)—NH—, alkyl-S(O)₂—NH—, aryl and halogen;
R₅ is hydrogen;
R₆ is a member selected from the group consisting of hydrogen and alkyl;
R₇ is a member selected from the group consisting of aryl and heterocycle;
R₈ is hydrogen;
R₉ is hydrogen;
R₁₀ and R₁₁ are hydrogen;
R₁₂ is hydrogen; and
Rₐ and R_{b} are each individually a member selected from the group consisting of hydrogen, alkoxycarbonyl, alkyl, alkylcarbonyl, alkylNHC(O)—, alkylS(O)₂— and Rₐ and
R_{b} taken together with the nitrogen to which they are attacked form a heterocycle;
provided that at least one of R₁, R₂ or R₃ are not hydrogen.

5. The compound according to claim 4, that is selected from the group consisting of 1-31, 39-54
N-[1-(1,3-benzodioxol-5-ylmethyl)piperidin-4-yl]-7-chloro-4-oxo-4H-chromene-2-carboxamide;
N-[1-(1,3-benzodioxol-5-ylmethyl)piperidin-4-yl]-7-methoxy-4-oxo-4H-chromene-2-carboxamide;
7-methoxy-4-oxo-N-[1-(1-quinolin-6-ylethyl)piperidin-4-yl]-4H-chromene-2-carboxamide;
7-chloro-N-[1-(2,3-dihydro-1,4-benzodioxin-6-ylmethyl)piperidin-4-yl]-4-oxo-4H-chromene-2-carboxamide;
7-methoxy-N-[1-(2-naphthylmethyl)piperidin-4-yl]-4-oxo-4H-chromene-2-carboxamide;
N-[1-(1,3-benzodioxol-5-ylmethyl)piperidin-4-yl]-6-fluoro-4-oxo-4H-chromene-2-carboxamide;
7-chloro-N-{1-[(1-methyl-1H-indol-5-yl)methyl]piperidin-4-yl}-4-oxo-4H-chromene-2-carboxamide;
N-[1-(1,3-benzodioxol-5-ylmethyl)piperidin-4-yl]-6-chloro-7-methyl-4-oxo-4H-chromene-2-carboxamide;
N-[1-(1,3-benzodioxol-5-ylmethyl)piperidin-4-yl]-7-(difluoromethoxy)-4-oxo-4H-chromene-2-carboxamide;
N-[1-(1,3-benzodioxol-5-ylmethyl)piperidin-4-yl]-7-chloro-3-methyl-4-oxo-4H-chromene-2-carboxamide;
7-chloro-4-oxo-N-[1-(1-quinolin-6-ylethyl)piperidin-4-yl]-4H-chromene-2-carboxamide;
N-[1-(1H-indol-5-ylmethyl)piperidin-4-yl]-7-methoxy-4-oxo-4H-chromene-2-carboxamide;
N-[1-(2,3-dihydro-1,4-benzodioxin-6-ylmethyl)piperidin-4-yl]-7-methoxy-4-oxo-4H-chromene-2-carboxamide;
N-{1-[(2,2-difluoro-1,3-benzodioxol-5-yl)methyl]piperidin-4-yl}-7-methoxy-4-carboxamide;
7-methoxy-N-{1-[(5-methylthien-2-yl)methyl]piperidin-4-yl}-4-oxo-4H-chromene-2-carboxamide;
N-[1-(2-chlorobenzyl)piperidin-4-yl]-7-methoxy-4-oxo-4H-chromene-2-carboxamide;
N-[1-(2-bromobenzyl)piperidin-4-yl]-7-methoxy-4-oxo-4H-chromene-2-carboxamide;
N-{1-[(4-bromothien-2-yl)methyl]piperidin-4-yl}-7-methoxy-4-oxo-4H-chromene-2-carboxamide;
N-(1-benzylpiperidin-4-yl)-7-methoxy-4-oxo-4H-chromene-2-carboxamide;
7-methoxy-N-[1-(3-methoxybenzyl)piperidin-4-yl]-4-oxo-4H-chromene-2-carboxamide;
N-{1-[(4,5-dimethyl-2-furyl)methyl]piperidin-4-yl}-7-methoxy-4-oxo-4H-chromene-2-carboxamide;
N-[1-(3-chlorobenzyl)piperidin-4-yl]-7-methoxy-4-oxo-4H-chromene-2-carboxamide;
7-methoxy-N-[1-(1-naphthylmethyl)piperidin-4-yl]-4-oxo-4H-chromene-2-carboxamide;
N-[1-(1,3-benzodioxol-5-ylmethyl)piperidin-4-yl]-7-chloro-6-cyano-4-oxo-4H-chromene-2-carboxamide;
N-[1-(1,3-benzothiazol-6-ylmethyl)piperidin-4-yl]-6,7-dichloro-4-oxo-4H-chromene-2-carboxamide;
N-[1-(1,3-benzoxazol-5-ylmethyl)piperidin-4-yl]-6,7-dichloro-4-oxo-4H-chromene-2-carboxamide;
N-[1-(1,3-benzodioxol-5-ylmethyl)piperidin-4-yl]-6-chloro-7-methoxy-4-oxo-4H-chromene-2-carboxamide;
6-chloro-N-{1-[(2,2-difluoro-1,3-benzodioxol-5-yl)methyl]piperidin-4-yl}-7-methoxy-4-oxo-4H-chromene-2-carboxamide; and
N-[1-(1,3-benzodioxol-5-ylmethyl)piperidin-4-yl]-7-chloro-6-fluoro-4-oxo-4H-chromene-2-carboxamide.

6. A compound of formula (III), 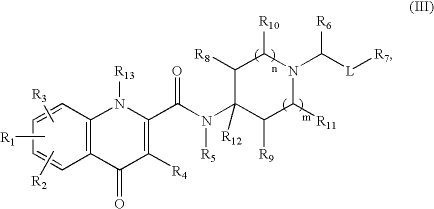
or a therapeutically suitable salt or prodrug thereof, wherein
L is a member selected from the group consisting of a bond, alkyl, alkenyl, alkynyl, —CH₂—O—, —S(O)₂—NH—, —C(O)—NH—, —NH—C(O)—, —NH—S(O)₂—, —C(O)—, —S(O)— and —S(O)₂—;
m is 1 or 2;
n is 0, 1, or 2
R₁, R₂ and R₃ are each independently a member selected from the group consisting of hydrogen, halogen, alkenyl, alkoxy, alkyl, alkyl-C(O)—, alkyl-C(O)—NH—, alkyl-NH—C(O)—, alkyl-S(O)₂—NH—, alkyl-NH—S(O)₂—, alkyl-S(O)₂—, alkyl-S(O)—, alkyl-S—, alkynyl, cyano, haloalkyl, haloalkoxy, haloalkyl-S—, RₐR_{b}N—, and R₁ and R₂ taken together with any intervening atoms form a heterocycle;
R₄ is a member selected from the group consisting of hydrogen, alkyl, alkyl-C(O)—NH—, alkyl-S(O)₂—NH—, aryl and halogen;
R₅ is a member selected from the group consisting of hydrogen and alkyl;
R₆ is a member selected from the group consisting of hydrogen, alkyl, aryl, cycloalkyl and heterocycle;
R₇ is a member selected from the group consisting of aryl, arylalkyl, heterocycle and heterocyclealkyl;
R₈ is a member selected from the group consisting of hydrogen, alkyl and alkoxy;
R₉ is a member selected from the group consisting of hydrogen and alkyl;
R₁₀ and R₁₁ are each independently selected from the group consisting of hydrogen, alkyl, alkoxylalkyl, and R₁₀ and R₁₁ taken together with any intervening atoms form a 5, 6, or 7-membered ring;
R₁₂ is a member selected from the group consisting of hydrogen and alkyl;
R₁₃ is a member selected from the group consisting of hydrogen, alkyl, aryl, cycloalkyl and heterocycle; and
Rₐ and R_{b} are each individually a member selected from the group consisting of hydrogen, alkoxycarbonyl, alkyl, alkylcarbonyl, alkylNHC(O)—, alkylS(O)₂— and Rₐ and R_{b} taken together with the nitrogen to which they are attacked form a heterocycle;
provided that at least one of R₁, R₂ or R₃ are not hydrogen.

7. A compound of formula (IIIa), 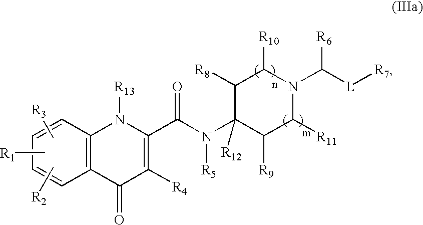
or a therapeutically suitable salt or prodrug thereof, wherein
L is a member selected from the group consisting of a bond, alkyl, alkenyl, alkynyl, —CH₂—O—, —S(O)₂—NH—, —C(O)—NH—, —NH—C(O)—, —NH—S(O)₂—, —C(O)—, —S(O)— and —S(O)₂—;
m is 1;
n is 1;
R₁, R₂ and R₃ are each independently a member selected from the group consisting of hydrogen, halogen, alkoxy, alkyl, alkyl-C(O)—, alkyl-C(O)—NH—, alkyl-NH—C(O)—, alkyl-S(O)₂—NH—, alkyl-NH—S(O)₂—, alkyl-S(O)₂—, alkyl-S(O)—, alkyl-S—, alkynyl, cyano, haloalkyl, haloalkoxy, haloalkyl-S—, RₐR_{b}N—, and R₁ and R₂ taken together with any intervening atoms form a heterocycle;
R₄ is a member selected from the group consisting of hydrogen, alkyl, alkyl-C(O)—NH—, alkyl-S(O)₂—NH—, aryl and halogen;
R₅ is a member selected from the group consisting of hydrogen and alkyl;
R₆ is a member selected from the group consisting of hydrogen and alkyl;
R₇ is a member selected from the group consisting of aryl, arylalkyl, heterocycle and heterocyclealkyl;
R₈ is a member selected from the group consisting of hydrogen, alkyl and alkoxy;
R₉ is a member selected from the group consisting of hydrogen and alkyl;
R₁₀ and R₁₁ are each independently selected from the group consisting of hydrogen, alkyl, alkoxylalkyl, and R₁₀ and R₁₁ taken together with any intervening atoms form a 5, 6, or 7-membered ring;
R₁₂ is hydrogen; and
Rₐ and R_{b} are each individually a member selected from the group consisting of hydrogen, alkoxycarbonyl, alkyl, alkylcarbonyl, alkylNHC(O)—, alkylS(O)₂— and Rₐ and R_{b} taken together with the nitrogen to which they are attacked form a heterocycle;
provided that at least one of R₁, R₂ or R₃ are not hydrogen.

8. A compound of formula (IIIb), 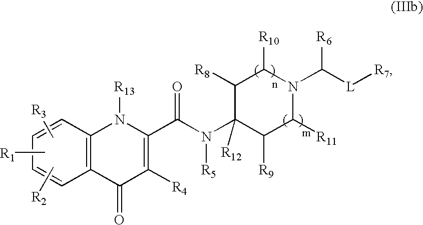
or a therapeutically suitable salt or prodrug thereof, wherein
L is a bond;
m is 1;
n is 1;
R₁, R₂ and R₃ are each independently a member selected from the group consisting of hydrogen, halogen, alkoxy, alkyl, cyano, haloalkyl, haloalkoxy and RₐR_{b}N—;
R₄ is a member selected from the group consisting of hydrogen, alkyl, alkyl-C(O)—NH—, alkyl-S(O)₂—NH—, aryl and halogen;
R₅ is hydrogen;
R₆ is a member selected from the group consisting of hydrogen and alkyl;
R₇ is a member selected from the group consisting of aryl and heterocycle;
R₈ is hydrogen;
R₉ is hydrogen;
R₁₀ and R₁₁ are hydrogen;
R₁₂ is hydrogen; and
Rₐ and R_{b} are each individually a member selected from the group consisting of hydrogen, alkoxycarbonyl, alkyl, alkylcarbonyl, alkylNHC(O)—, alkylS(O)₂— and Rₐ and R_{b} taken together with the nitrogen to which they are attacked form a heterocycle;
provided that at least one of R₁, R₂ or R₃ are not hydrogen.

9. The compound according to claim 8 that is selected from the group consisting of
N-[1-(1,3-benzodioxol-5-ylmethyl)piperidin-4-yl]-7-chloro-6-fluoro-4-oxo-1,4-dihydroquinoline-2-carboxamide;
7-chloro-6-fluoro-N-[1-(2-fluoro-4-methoxybenzyl)piperidin-4-yl]-4-oxo-1,4-dihydroquinoline-2-carboxamide;
N-[1-(1,3-benzodioxol-5-ylmethyl)piperidin-4-yl]-7-methoxy-4-oxo-1,4-dihydroquinoline-2-carboxamide;
N-[1-(1,3-benzodioxol-5-ylmethyl)piperidin-4-yl]-7-chloro-4-oxo-1,4-dihydroquinoline-2-carboxamide;
N-[1-(2-fluoro-4-methoxybenzyl)piperidin-4-yl]-4-oxo-7-(trifluoromethoxy)-1,4-dihydroquinoline-2-carboxamide;
N-[1-(1,3-benzodioxol-5-ylmethyl)piperidin-4-yl]-4-oxo-7-(trifluoromethoxy)-1,4-dihydroquinoline-2-carboxamide; and
N-[1-(2-fluoro-4-methoxybenzyl)piperidin-4-yl]-7-methoxy-4-oxo-1,4-dihydroquinoline-2-carboxamide.

10. A method of treating disorders by inhibiting the effects of melanin concentrating hormone (MCH) through the melanin concentrating hormone receptor, comprising administrering a therapeutically effective amount of a compound of formula (I).

11. A method of treating disorders by inhibiting the effects of melanin concentrating hormone (MCH) through the melanin concentrating hormone receptor, comprising administrering a therapeutically effective amount of a compound of formula (II).

12. A method of treating disorders by inhibiting the effects of melanin concentrating hormone (MCH) through the melanin concentrating hormone receptor, comprising administrering a therapeutically effective amount of a compound of formula (III).

13. A method of treating obesity by inhibiting the effects of melanin concentrating hormone (MCH) through the melanin concentrating hormone receptor, comprising administrering a therapeutically effective amount of a compound of formula (I).

14. A method of treating obesity by inhibiting the effects of melanin concentrating hormone (MCH) through the melanin concentrating hormone receptor, comprising administrering a therapeutically effective amount of a compound of formula (II).

15. A method of treating obesity by inhibiting the effects of melanin concentrating hormone (MCH) through the melanin concentrating hormone receptor, comprising administrering a therapeutically effective amount of a compound of formula (III).

16. A method of treating abnormalities in reproduction and sexual behavior, thyroid hormone secretion, diuresis and water/electrolyte homeostasis, sensory processing, memory, sleeping and arousal, anxiety and depression, seizure and in treatment of neurodegeneration or psychiatric disorders by inhibiting the effects of melanin concentrating hormone (MCH) through the melanin concentrating hormone receptor, comprising administrering a therapeutically effective amount of a compound of formula (I).

17. A method of treating abnormalities in reproduction and sexual behavior, thyroid hormone secretion, diuresis and water/electrolyte homeostasis, sensory processing memory, sleeping and arousal, anxiety and depression, seizure and in treatment of neurodegeneration or psychiatric disorders by inhibiting the effects of melanin concentrating hormone (MCH) through the melanin concentrating hormone receptor, comprising administrering a therapeutically effective amount of a compound of formula (II).

18. A method of treating abnormalities in reproduction and sexual behavior, thyroid hormone secretion, diuresis and water/electrolyte homeostasis, sensory processing memory, sleeping and arousal, anxiety and depression, seizure and in treatment of neurodegeneration or psychiatric disorders by inhibiting the effects of melanin concentrating hormone (MCH) through the melanin concentrating hormone receptor, comprising administrering a therapeutically effective amount of a compound of formula (III).

19. A pharmaceutical composition comprising a therapeutically effective amount of a compound of formula (I) in combination with a pharmaceutically suitable carrier.

20. A pharmaceutical composition comprising a therapeutically effective amount of a compound of formula (II) in combination with a pharmaceutically suitable carrier.

21. A pharmaceutical composition comprising a therapeutically effective amount of a compound of formula (III) in combination with a pharmaceutically suitable carrier.
